(19) United States
(12) Patent Application Publication
(10) Pub. No.: US 2007/0259271 A1
(43) Pub. Date: Nov. 8, 2007

(54) Laminate Including Active Material Layer and Solid Electrolyte Layer, and All Solid Lithium Secondary Battery Using the Same

(76) Inventors: Tetsuo Nanno, Osaka (JP); Hidekazu Tamai, Kyoto (JP); Shinji Nakanishi, Osaka (JP); Tatsuya Inoue, Osaka (JP); Keiji Kobayashi, Osaka (JP)

Correspondence Address: MCDERMOTT WILL & EMERY LLP, 600 13TH STREET, NW, WASHINGTON, DC, 20005-3096, US

(21) Appl. No.: 11/792,959

(22) PCT Filed: Dec. 12, 2005
(86) PCT No.: PCT/JP05/22807

§ 371 Date: Jun. 13, 2007

(30) Foreign Application Priority Data
Dec. 13, 2004 (JP) 2004-360083
Dec. 17, 2004 (JP) 2004-366094
Jan. 7, 2005 (JP) 2005-002658
May 17, 2005 (JP) 2005-144435
May 27, 2005 (JP) 2005-155248

(51) Int. Cl. H01M 10/36

(52) U.S. Cl. 429/318; 264/614

(57) ABSTRACT

A laminate includes an active material layer and a solid electrolyte layer bonded to the active material layer by sintering. The active material layer includes a crystalline first substance capable of absorbing and desorbing lithium ions, and the solid electrolyte layer includes a crystalline second substance with lithium ion conductivity. An X-ray diffraction analysis of the laminate shows that there is no component other than constituent components of the active material layer and constituent components of the solid electrolyte layer. Also, an all solid lithium secondary battery includes such a laminate and a negative electrode active material layer.

### TECHNICAL FIELD

The present invention relates to a laminate including a positive electrode active material layer and a solid electrolyte layer and to an all solid lithium secondary battery using the same.

### BACKGROUND ART

Electronic devices are becoming increasingly smaller, and there is accordingly a demand for batteries having high energy density as the main power source or back-up power source for such devices. Lithium ion secondary batteries, in particular, are receiving attention since they have higher voltage and higher energy density than conventional aqueous solution type batteries.

In lithium ion secondary batteries, an oxide such as LiCoO₂, LiMn₂O₄, or LiNiO₂ is used as a positive electrode active material, and carbon, an alloy containing, for example, Si, or an oxide such as Li₄Ti₅O₁₂ is used as a negative electrode active material. Also, a liquid electrolyte comprises a Li salt dissolved in a carbonic acid ester or an ether type organic solvent.

However, such a liquid electrolyte may leak. Further, since a liquid electrolyte contains an inflammable, it is necessary to heighten battery safety in the event of misuse. To heighten the safety and reliability of lithium ion secondary batteries, extensive studies are being conducted on all solid lithium secondary batteries that use a solid electrolyte instead of a liquid electrolyte.

However, a solid electrolyte has problems in that it has lower conductivity and lower power density than a liquid electrolyte.

Meanwhile, to heighten energy density, there has been proposed a layered-type battery including a laminate of at least one integrated combination of a positive electrode, a separator containing a solid electrolyte or an electrolyte, and a negative electrode (Patent Document 1). A terminal electrode connected to the positive electrode(s) and a terminal electrode connected to the negative electrode(s) are provided on at least one end face of the side faces and upper and lower faces of the laminate.

To increase conductivity, it is also possible to provide a gelled electrolyte containing a liquid electrolyte between the positive electrode active material layer and the negative electrode active material layer.

In Patent Document 1, combinations each composed of the positive electrode, solid electrolyte and negative electrode are connected in parallel or series by the terminal electrodes. The terminal electrodes are formed by plating, baking, or deposition, sputtering, etc. However, it is difficult to apply such a method, for example, to layered-type batteries including a gelled electrolyte containing a liquid electrolyte. Plating is not applicable to systems including a non-aqueous electrolyte since water contained in a plating solution enters a battery. Baking is difficult to apply since a liquid electrolyte boils and evaporates. In the case of deposition and sputtering, these methods need to be performed in a reduced pressure atmosphere and are difficult to apply since a liquid electrolyte boils and evaporates also in this case.

Perovskite-type Li_{0.33}La_{0.56}TiO₃ and NASICON-type LiTi₂(PO₄)₃ are Li ion conductors capable of conducting Li ions at high speeds. Recently, all solid batteries using such solid electrolytes have been studied.

A solid battery using an inorganic solid electrolyte, a positive electrode active material and a negative electrode active material is produced by sequentially laminating a positive electrode active material layer, a solid electrolyte layer, and a negative electrode active material layer to form a laminate and sintering it by heat treatment. This method can bond the interface between the positive electrode active material layer and the solid electrolyte layer and the interface between the solid electrolyte layer and the negative electrode active material layer. However, the use of this method has suffered from large disadvantages for various reasons.

For example, Non-Patent Document 1 reports that when positive electrode active material LiCoO₂ and solid electrolyte LiTi₂(PO₄)₃ are sintered, they react with each other in the sintering process, thereby producing compounds that do not contribute to charge/discharge reactions, such as CoTiO₃, CO₂TiO₄, and LiCoPO₄.

In this case, due to the production of the substances that are neither the active material nor the solid electrolyte at the sintered interface between the active material and the solid electrolyte, a problem may occur in that the sintered interface becomes electrochemical inactive.

To solve such problems, for example, the following production method has been proposed. First, a three-layer pellet with a structure of LiMn₂O₄/Li_{1.3}Al_{0.3}Ti_{1.7}(PO₄)₃/Li₄Ti₅O₁₂ is prepared. This pellet is then sintered at 75° C. for 12 hours to obtain an electrode. Subsequently, this electrode is polished to a thickness of 10 to 100 μmm to obtain an all solid battery (see Non-Patent Document 2). The respective layers contain 15 wt % of 0.44LiBO₂-0.56LiF as a sintering aid.

However, in the production method of Non-Patent Document 2, the sintering does not proceed sufficiently at such a low temperature of 750° C., so that the solid electrolyte and the active material are not sufficiently bonded at the interface thereof. Thus, the charge/discharge curve at 10 μA/cm² is shown in Non-Patent Document 2, which is a significantly small current value. That is, it is believed that the solid battery as disclosed in Non-Patent Document 2 has a significant large internal resistance.

In this case, the internal resistance of the solid battery can be reduced by heightening the sintering temperature to promote the sintering. However, due to diffusion of elements, an inactive phase is formed, for example, between the active material layer and the solid electrolyte layer, thereby resulting in a problem of difficult charge/discharge.

Also, it has been proposed to produce a solid battery by laminating a molded body of positive electrode materials, a molded body of solid electrolyte materials, and a molded body of negative electrode materials, each molded body containing a binder, and sintering them by microwave heating (see Patent Document 2). In Patent Document 2, a molded body is produced by sheet formation or by screen-printing a raw material paste on a substrate, drying it, and removing the substrate.

It is believed that the production method of Patent Document 2 makes it possible to prevent the respective powders in the electrode and the solid electrolyte layer from reacting with one another while improving the packing rate. However, in the case of such active material/solid electrolyte combination as described in Examples of Patent Document 2, the active material and the solid electrolyte inherently react with each other at high temperatures, thereby producing a phase that does not conduct Li ions at the interface thereof. Thus, even if the baking time is reduced by employing microwave heating, it is difficult to completely suppress production of an inactive phase at the interface between the active material and the solid electrolyte. That is, according to the production method of Patent Document 2, it is difficult to suppress an increase in resistance at the sintered interface between the active material and the solid electrolyte, capacity loss due to deterioration of the active material, etc.

Further, when a positive electrode comprising a positive electrode active material and a positive electrode current collector, a solid electrolyte, and a negative electrode comprising a negative electrode active material and a negative electrode current collector are laminated to produce a battery, the expansion and contraction of the active material during charge/discharge may cause delamination at the interface between the active material and the electrolyte and the interface between the active material and the current collector or may cause cracking of the battery. This tendency increases particularly when an inorganic oxide is used as the solid electrolyte, due to the absence of a stress-relieving layer.

Also, when LiTi₂(PO₄)₃ is used singly, it has a poor sintering property, and even if it is sintered at 1200° C., the resulting lithium ion conductivity is as low as approximately 10⁻⁶ S/cm. Thus, it has been reported that when LiTi₂(PO₄)₃ is mixed with a sintering aid such as Li₃PO₄ or Li₃BO₃, LiTi₂(PO₄)₃ can be sintered at 800 to 900° C. and the lithium ion conductivity is improved (see Non-Patent Document 3).

Further, there has also been proposed a thin film battery including lithium phosphorus oxynitride (Li_{X}PO_{Y}N_{Z} where X=2.8 and 3Z+2Y=7.8) as a solid electrolyte (see Patent Document 3).

When a thin film of an active material and a thin film of a solid electrolyte are formed on a substrate by such a method as sputtering to produce a battery, the resulting thin film is amorphous. Commonly used active materials, such as LiCoO₂, LiNiO₂, LiMn₂O₄, and Li₄Ti₅O₁₂, are unable to charge or discharge in an amorphous state. Thus, they need to be crystallized after they are formed into a thin film, by applying a heat treatment of approximately 400 to 700° C.

However, since the lithium phosphorus oxynitride used in Patent Document 3 decomposes at approximately 300° C., it is impossible to crystallize the active material by applying a heat treatment after laminating the positive electrode, the solid electrolyte, and the negative electrode continuously.

Also, in the case of using a heat-resistant solid electrolyte such as Perovskite-type Li_{0.33}La_{0.56}TiO₃ or NASICON-type LiTi₂(PO₄)₃, if it is heat-treated together with a common active material, impurities are produced at the interface between the active material and the solid electrolyte, so that charge/discharge is difficult.

As described above, since a side reaction occurs to produce substances that do not contribute to charge/discharge at the interface between an active material and a solid electrolyte, it has been difficult, by applying a heat treatment, to form a good interface between the active material and the solid electrolyte while densifying or crystallizing the active material layer and the solid electrolyte layer.

Further, it has been proposed to use LiCoPO₄ which charges and discharges at 4.8 V versus lithium metal as a positive electrode active material (see Non-Patent Document 4).

However, the liquid electrolyte decomposes due to the high operating potential of 4.8 V. Thus, there is a problem in that batteries using such an active material have short life characteristics.

Moreover, it has been difficult to stably use such an active material with high operating voltage as LiCoPO₄.

Patent Document 1: Japanese Laid-Open Patent Publication No. Hei 6-231796

Patent Document 2: Japanese Laid-Open Patent Publication No. 2001-210360

Patent Document 3: Specification of U.S. Pat. No. 5,597,660

Non-Patent Document 1: J. Power Sources, 81-82, (1999), 853

Non-Patent Document 2: Solid State Ionics 118 (1999), 149

Non-Patent Document 3: Solid State Ionics, 47 (1991), 257-264

Non-Patent Document 4: Electrochemical and Solid-State Letters, 3(4), 178 (2000)

### DISCLOSURE OF INVENTION

### Problem That the Invention Is to Solve

It is therefore an object of the present invention to provide a laminate in which a solid electrolyte layer and an active material layer are densified and crystallized due to heat treatment and the interface between the active material and the solid electrolyte is electrochemically active, and to provide an all solid lithium secondary battery with low internal resistance and large capacity. It is another object to provide an all solid lithium secondary battery in which the bonding strength of the interface between the active material layer and the solid electrolyte layer is improved by suppressing warpage and embrittlement due to sintering. It is a further object to provide a highly reliable all solid lithium secondary battery by suppressing delamination, cracking, etc.

### MEANS FOR SOLVING THE PROBLEM

The present invention relates to a laminate comprising an active material layer and a solid electrolyte layer bonded to the active material layer. The active material layer comprises a crystalline first substance capable of absorbing and desorbing lithium ions, and the solid electrolyte layer comprises a crystalline second substance with lithium ion conductivity. An X-ray diffraction analysis of the laminate shows that there is no component other than constituent components of the active material layer and constituent components of the solid electrolyte layer.

In the laminate, the first substance preferably comprises a crystalline first phosphoric acid compound capable of absorbing and desorbing lithium ions, and the second substance preferably comprises a crystalline second phosphoric acid compound with lithium ion conductivity.

In the laminate, at least the solid electrolyte layer preferably has a packing rate of more than 70%. As used herein, the packing rate refers to the ratio of the apparent density of each layer to the true density of the material(s) constituting each layer which is expressed as a percentage. Alternatively, the packing rate of each layer can also be defined as (100−X)% when the porosity of each layer is defined as X %.

In the laminate, at least one layer selected from the group consisting of the active material layer and the solid electrolyte layer preferably contains an amorphous oxide. In the layer containing the amorphous oxide, the amorphous oxide preferably constitutes 0.1 to 10% by weight of each layer. Also, the amorphous oxide preferably has a softening point of 700° C. or more and 950° C. or less.

In the laminate, the first phosphoric acid compound is preferably represented by the following general formula:
LiMPO₄
where M is at least one selected from the group consisting of Mn, Fe, Co, and Ni. The second phosphoric acid compound is preferably represented by the following general formula:
Li_{1+X}M^{III}_{X}Ti^{IV}_{2-X}(PO₄)₃
where M^{III} is at least one metal ion selected from the group consisting of Al, Y, Ga, In, and La and 0≦X≦0.6.

The present invention also relates to an all solid lithium secondary battery having a laminate that includes at least one combination comprising a positive electrode active material layer and a solid electrolyte layer bonded to the positive electrode active material layer. The positive electrode active material layer comprises a crystalline first substance capable of absorbing and desorbing lithium ions, and the solid electrolyte layer comprises a crystalline second substance with lithium ion conductivity. An X-ray diffraction analysis of the laminate shows that there is no component other than constituent components of the active material layer and constituent components of the solid electrolyte layer. Also, the first substance is preferably a crystalline first phosphoric acid compound capable of absorbing and desorbing lithium ions. The second substance is preferably a crystalline second phosphoric acid compound with lithium ion conductivity.

In the all solid lithium secondary battery, it is preferable that the at least one combination have a negative electrode active material layer that faces the positive electrode active material layer with the solid electrolyte layer interposed therebetween, that the solid electrolyte layer be bonded to the negative electrode active material layer, and that the negative electrode active material layer comprise a crystalline third phosphoric acid compound capable of absorbing and desorbing lithium ions or a Ti-containing oxide.

In the all solid lithium secondary battery, at least the solid electrolyte layer preferably has a packing rate of more than 70%.

In the all solid lithium secondary battery, the first phosphoric acid compound is preferably represented by the following general formula:
LiMPO₄
where M is at least one selected from the group consisting of Mn, Fe, Co, and Ni. The second phosphoric acid compound is preferably represented by the following general formula:
Li_{1+X}M^{III}_{X}Ti^{IV}_{2-X}(PO₄)₃
where M^{III} is at least one metal ion selected from the group consisting of Al, Y, Ga, In, and La, and 0≦X≦0.6.

In the all solid lithium secondary battery, it is more preferable that the third phosphoric acid compound be at least one selected from the group consisting of FePO₄, Li₃Fe₂(PO₄)₃, and LiFeP₂O₇, and that at least the solid electrolyte layer have a packing rate of more than 70%.

In the all solid lithium secondary battery, it is preferable that the solid electrolyte comprise Li_{1+X}M^{III}_{X}Ti^{IV}_{2-X}(PO₄)₃ where M^{III} is at least one metal ion selected from the group consisting of Al, Y, Ga, In, and La and 0≦X≦0.6, and that the solid electrolyte layer serve as a negative electrode active material layer.

In the all solid lithium secondary battery, at least one layer selected from the group consisting of the active material layer and the solid electrolyte layer preferably contains an amorphous oxide. In the layer containing the amorphous oxide, the amorphous oxide preferably constitutes 0.1 to 10% by weight of each layer. Also, the amorphous oxide preferably has a softening point of 700° C. or more and 950° C. or less.

In another aspect of the present invention, at least one layer selected from the group consisting of the active material layer and the solid electrolyte layer preferably contains Li₄P₂O₇.

In the all solid lithium secondary battery, the face of the solid electrolyte layer not bonded to the positive electrode active material layer may be bonded to lithium metal or a current collector, with a reduction-resistant electrolyte layer interposed therebetween.

In the all solid lithium secondary battery, the at least one combination is preferably sandwiched between a positive electrode current collector and a negative electrode current collector.

In the all solid lithium secondary battery, the positive electrode active material layer preferably has a positive electrode current collector, and the negative electrode active material layer preferably has a negative electrode current collector. Also, in another aspect of the present invention, a thin-film current collector is preferably provided in at least one of the positive electrode active material layer and the negative electrode active material layer.

In the all solid lithium secondary battery, at least one current collector selected from the group consisting of the positive electrode current collector and the negative electrode current collector preferably has a porosity of 20% or more and 60% or less.

Also, at least one of the thin-film positive electrode current collector and the thin-film negative electrode current collector is preferably provided in the active material layer in a central part of the thickness direction thereof.

In another aspect of the present invention, it is preferably provided in the form of a three-dimensional network throughout the current collector in at least one of the positive electrode active material layer and the negative electrode active material layer.

In the all solid lithium secondary battery, the current collector is preferably provided on at least one of the face of the positive electrode active material layer opposite to the face in contact with the solid electrolyte layer and the face of the negative electrode active material layer opposite to the face in contact with the solid electrolyte.

In the all solid lithium secondary battery, it is preferable that the at least one combination comprise two or more combinations, and that the positive electrode current collectors and the negative electrode current collectors be connected in parallel by a positive electrode external current collector and a negative electrode external current collector, respectively. More preferably, the positive electrode external current collector and the negative electrode external current collector comprise a mixture of metal and glass frit.

In the all solid lithium secondary battery, the positive electrode current collector and the negative electrode current collector preferably comprise a conductive material. More preferably, the conductive material includes at least one selected from the group consisting of stainless steel, silver, copper, nickel, cobalt, palladium, gold, and platinum.

In the all solid lithium secondary battery, the laminate is preferably housed in a metal case, and the metal case is preferably sealed.

The all solid lithium secondary battery is preferably covered with resin. Also, in another aspect of the present invention, the surface of the all solid lithium secondary battery is preferably subjected to a water-repellency treatment. In still another aspect of the present invention, the all solid lithium secondary battery is preferably subjected to a water-repellency treatment and then covered with resin.

In still further aspect of the present invention, the all solid lithium secondary battery is preferably covered with a low melting-point glass.

Also, the present invention pertains to a method for producing a laminate comprising an active material layer and a solid electrolyte layer. The method includes the steps of: dispersing an active material in a solvent containing a binder and a plasticizer to form a slurry 1 for forming the active material layer; dispersing a solid electrolyte in a solvent containing a binder and a plasticizer to form a slurry 2 for forming the solid electrolyte layer; making an active material green sheet by using the slurry 1; making a solid electrolyte green sheet by using the slurry 2; and laminating the active material green sheet and the solid electrolyte green sheet and heat-treating them at a predetermined temperature to form a laminate. The active material comprises a first phosphoric acid compound capable of absorbing and desorbing lithium ions, and the solid electrolyte comprises a second phosphoric acid compound with lithium ion conductivity.

In the production method of a laminate, it is preferable that at least one slurry selected from the group consisting of the slurry 1 and the slurry 2 contain an amorphous oxide, and that the predetermined temperature of heat treatment be 700° C. or more and 1000° C. or less. More preferably, the at least one slurry is such that the ratio of the amorphous oxide to the total of the amorphous oxide and the active material or the solid electrolyte is 0.1% by weight to 10% by weight. The amorphous oxide preferably has a softening point of 700° C. or more and 950° C. or less.

Further, the present invention relates to a method for producing a laminate comprising an active material layer and a solid electrolyte layer. The method includes the steps of: depositing an active material on a substrate to form the active material layer; depositing a solid electrolyte on the active material layer to form the solid electrolyte layer; and heat-treating the active material layer and the solid electrolyte layer at a predetermined temperature for crystallization. The active material comprises a crystalline first phosphoric acid compound capable of absorbing and desorbing lithium ions, and the solid electrolyte comprises a crystalline second phosphoric acid compound with lithium ion conductivity. The active material and the solid electrolyte are preferably deposited on the substrate by sputtering.

Furthermore, the present invention is directed to a method for producing an all solid lithium secondary battery. The method includes the steps of: (a) dispersing a positive electrode active material in a solvent containing a binder and a plasticizer to form a slurry 1 for forming a positive electrode active material layer; (b) dispersing a solid electrolyte in a solvent containing a binder and a plasticizer to form a slurry 2 for forming a solid electrolyte layer; (c) dispersing a negative electrode active material in a solvent containing a binder and a plasticizer to form a slurry 3 for forming a negative electrode active material layer; (d) making a positive electrode active material green sheet by using the slurry 1; (e) making a solid electrolyte green sheet by using the slurry 2; (f) making a negative electrode active material green sheet by using the slurry 3; (g) forming a first green sheet group that includes at least one combination including: the solid electrolyte sheet; and the positive electrode active material green sheet and the negative electrode active material green sheet sandwiching the solid electrolyte sheet; and (h) heat-treating the first green sheet group at a predetermined temperature to form a laminate including at least one integrated combination of the positive electrode active material layer, the solid electrolyte layer, and the negative electrode active material layer. The positive electrode active material comprises a crystalline first phosphoric acid compound capable of absorbing and desorbing lithium ions, the solid electrolyte comprises a second phosphoric acid compound with lithium ion conductivity, and the negative electrode active material comprises a third phosphoric acid compound capable of absorbing and desorbing lithium ions or a Ti-containing oxide.

In the method for producing an all solid lithium secondary battery, at least one slurry selected from the group consisting of the slurry 1, the slurry 2, and the slurry 3 preferably contains an amorphous oxide. More preferably, the at least one slurry is such that the ratio of the amorphous oxide to the total of the amorphous oxide and the active material or the solid electrolyte is 0.1% by weight to 10% by weight. The amorphous oxide preferably has a softening point of 700° C. or more and 950° C. or less. Also, in this case, the predetermined temperature of heat treatment is preferably 700° C. or more and 1000° C. or less.

In another aspect of the present invention, it is preferable that Li₄P₂O₇ be added to at least one slurry selected from the group consisting of the slurry 1, the slurry 2, and the slurry 3, and that the heat treatment be performed at 700° C. or more and 1000° C. or less.

In the step (g) of the method for producing an all solid lithium secondary battery, the combination is preferably produced such that at least one selected from the group consisting of the positive electrode active material green sheet and the negative electrode active material green sheet is integrated with a current collector.

In another aspect of the present invention, in the step (g), the combination includes at least two positive electrode active material green sheets prepared in the above manner, at least two negative electrode active material green sheets prepared in the above manner, and the solid electrolyte green sheet. At this time, it is preferable that a positive electrode current collector be interposed between the at least two positive electrode active material green sheets, that a negative electrode current collector be interposed between the at least two negative electrode active material green sheets, and that one end of the positive electrode current collector and one end of the negative electrode current collector be exposed at different surface regions of the laminate.

In still another aspect of the present invention, in the step (a) and the step (c), a positive electrode current collector material and a negative electrode current collector material are preferably further mixed into the slurry 1 and the slurry 3, respectively, and one end of the positive electrode active material layer and one end of the negative electrode active material layer are preferably exposed at different surface regions of the laminate.

Also, the present invention relates to a method for producing an all solid lithium secondary battery, including the steps of: (A) forming a first group that includes a combination comprising a positive electrode active material layer, a negative electrode active material layer, and a solid electrolyte layer interposed between the positive electrode active material layer and the negative electrode active material layer; and (B) heat-treating the first group at a predetermined temperature to integrate and crystallize the positive electrode active material layer, the solid electrolyte layer, and the negative electrode active material layer. The step (A) includes the steps of: (i) depositing a positive electrode active material or a negative electrode active material on a predetermined substrate to form a first active material layer; (ii) depositing a solid electrolyte on the first active material layer to form a solid electrolyte layer; and (iii) laminating a second active material layer, which is different from the first active material layer, on the solid electrolyte layer to form a first group including a combination comprising the first active material layer, the solid electrolyte layer, and the second active material layer. The positive electrode active material comprises a crystalline first phosphoric acid compound capable of absorbing and desorbing lithium ions, the solid electrolyte comprises a second phosphoric acid compound with lithium ion conductivity, and the negative electrode active material comprises a third phosphoric acid compound capable of absorbing and desorbing lithium ions or a Ti-containing oxide. The active material and the solid electrolyte are preferably deposited on the substrate by sputtering or heat vapor deposition.

Also, in the method for producing an all solid lithium secondary battery, preferably, the step (iii) further includes, prior to the step (B), the step of laminating at least two combinations prepared in the above manner with a solid electrolyte layer interposed therebetween to form a laminate.

Further, the present invention relates to a method for producing an all solid lithium secondary battery, including the steps of: (a) dispersing a positive electrode active material in a solvent containing a binder and a plasticizer to form a slurry 1 for forming a positive electrode active material layer; (b) dispersing a solid electrolyte in a solvent containing a binder and a plasticizer to form a slurry 2 for forming a solid electrolyte layer; (c) making a positive electrode active material green sheet by using the slurry 1; (d) making a solid electrolyte green sheet by using the slurry 2; (e) forming a second green sheet group that includes at least one combination comprising the positive electrode active material green sheet and the solid electrolyte green sheet; and (f) heat-treating the second green sheet group at a predetermined temperature to form a laminate including at least one integrated combination of the positive electrode active material layer and the solid electrolyte layer. In the step (e), the combination includes at least two positive electrode active material green sheets prepared in the above manner and at least two solid electrolyte green sheets prepared in the above manner. A positive electrode current collector is interposed between the at least two positive electrode active material green sheets while a negative electrode current collector is interposed between the at least two solid electrolyte green sheets. The positive electrode active material comprises a first phosphoric acid compound capable of absorbing and desorbing lithium ions. The solid electrolyte comprises a second phosphoric acid compound with lithium ion conductivity, the solid electrolyte serving as a negative electrode active material. At least one of the positive electrode current collector and the negative electrode current collector is selected from the group consisting of silver, copper, and nickel. The heat treatment is performed in an atmospheric gas comprising steam and a gas with a low oxygen partial pressure.

In the method for producing an all solid lithium secondary battery, it is more preferable that the second phosphoric acid compound and the third phosphoric acid compound comprise Li_{1+X}M^{III}_{X}Ti^{IV}_{2-X}(PO₄)₃ where M^{III} is at least one metal ion selected from the group consisting of Al, Y, Ga, In, and La and 0≦X≦0.6, that the heat treatment be performed in an atmospheric gas comprising steam and a gas with a low oxygen partial pressure, that the steam constitute 5 to 90% by volume of the atmospheric gas, and that the highest temperature of the heat treatment be 700° C. or more and 1000° C. or less.

In the methods for producing a laminate and an all solid lithium secondary battery, it is more preferable that the first phosphoric acid compound be represented by the following general formula:
LiMPO₄
where M is at least one selected from the group consisting of Mn, Fe, Co, and Ni, that the first phosphoric acid compound contain Fe, that the heat treatment be performed in an atmospheric gas comprising steam and a gas with a low oxygen partial pressure, that the steam constitute 5 to 90% by volume of the atmospheric gas, and that the highest temperature of the heat treatment be 700° C. or more and 1000° C. or less.

In the methods for producing a laminate and an all solid lithium secondary battery, when the heat treatment is maintained at a constant temperature of T° C., the equilibrium partial pressure PO₂ (atmospheres) of oxygen gas contained in the atmospheric gas more preferably satisfies the following formula:
−0.0310T+33.5≦−log₁₀PO₂≦−0.0300T+38.1.
In performing the heat treatment (sintering), the green chip is heated at a predetermined heating rate, and the green chip is then maintained at a predetermined constant temperature for a predetermined time to remove the binder and the like, before it is sintered. In the present invention, this predetermined constant temperature is the constant temperature at which the heat treatment is maintained.

In the methods for producing a laminate and an all solid lithium secondary battery, the gas with a low oxygen partial pressure more preferably comprises a mixture of a gas capable of releasing oxygen and a gas that reacts with oxygen.

In the method for producing an all solid lithium secondary battery, it is more preferred that at least one of the positive electrode current collector and the negative electrode current collector comprise one selected from the group consisting of silver, copper, and nickel, that the heat treatment be performed in an atmospheric gas having a lower oxygen partial pressure than an oxidation-reduction equilibrium oxygen partial pressure of an electrode, and that the highest temperature of the heat treatment be 700° C. or more and 1000° C. or less. At this time, the atmospheric gas contains carbon dioxide gas and hydrogen gas, and the oxygen partial pressure of the atmospheric gas is adjusted by changing the mixing ratio between the carbon dioxide gas and the hydrogen gas.

In the method for producing an all solid lithium secondary battery, it is preferable that at least one of the positive electrode current collector and the negative electrode current collector include at least one selected from the group consisting of silver, copper, and nickel, that the heat treatment be performed in an atmospheric gas comprising steam and a gas with a low oxygen partial pressure, that the steam constitute 5 to 90% by volume of the atmospheric gas, and that the highest temperature of the heat treatment be 700° C. or more and 1000° C. or less.

### EFFECTS OF THE INVENTION

According to the present invention, it is possible to form an electrochemically active interface between an active material and a solid electrolyte while densifying a solid electrolyte layer and an active material layer by heat treatment. It is also possible to improve the life characteristics of active materials with high operating voltage. Also, by using at least one combination of the above-mentioned laminate and a negative electrode, it is possible to provide an all solid lithium secondary battery with small internal resistance and high capacity. Further, by applying a water-repellency treatment, it is possible to provide an all solid lithium secondary battery having high reliability even when it is stored in a hot and humid atmosphere.

### BRIEF DESCRIPTION OF DRAWINGS

FIG. 1 is a graph showing X-ray diffraction patterns of a powder mixture of LiCoPO₄ and Li_{1.3}Al_{0.3}Ti_{1.7}(PO₄)₃ before and after heat treatment;

FIG. 2 is a graph showing X-ray diffraction patterns of a powder mixture of LiNiPO₄ and Li_{1.3}Al_{0.3}Ti_{1.7}(PO₄)₃ before and after heat treatment;

FIG. 3 is a graph showing X-ray diffraction patterns of a powder mixture of LiCoO₂ and Li_{1.3}Al_{0.3}Ti_{1.7}(PO₄)₃ before and after heat treatment;

FIG. 4 is a graph showing X-ray diffraction patterns of a powder mixture of LiMn₂O₄ and Li_{1.3}Al_{0.3}Ti_{1.7}(PO₄)₃ before and after heat treatment;

FIG. 5 is a graph showing X-ray diffraction patterns of a powder mixture of LiCoPO₄ and Li_{0.33}La_{0.56}TiO₃ before and after heat treatment;

FIG. 6 is a graph showing X-ray diffraction patterns of a powder mixture of LiNiPO₄ and Li_{0.33}La_{0.56}TiO₃ before and after heat treatment;

FIG. 7 is a graph showing X-ray diffraction patterns of a powder mixture of LiCoO₂ and Li_{0.33}La_{0.56}TiO₃ before and after heat treatment;

FIG. 8 is a graph showing X-ray diffraction patterns of a powder mixture of LiMn₂O₄ and Li_{0.33}La_{0.56}TiO₃ before and after heat treatment;

FIG. 9 is a graph showing X-ray diffraction patterns of a powder mixture of LiCo_{0.5}Ni_{0.5}PO₄ and Li_{1.3}Al_{0.3}Ti_{1.7}(PO₄)₃ before and after heat treatment;

FIG. 10 is a graph showing X-ray diffraction patterns of a powder mixture of FePO₄ and Li_{1.3}Al_{0.3}Ti_{1.7}(PO₄)₃ before and after heat treatment;

FIG. 11 is a graph showing X-ray diffraction patterns of a powder mixture of Li₃Fe₂(PO₄)₃ and Li_{1.3}Al_{0.3}Ti_{1.7}(PO₄)₃ before and after heat treatment;

FIG. 12 is a graph showing X-ray diffraction patterns of a powder mixture of LiFeP₂O₇ and Li_{1.3}Al_{0.3}Ti_{1.7}(PO₄)₃ before and after heat treatment;

FIG. 13 is a graph showing X-ray diffraction patterns of a powder mixture of Li₄Ti₅O₁₂ and Li_{1.3}Al_{0.3}Ti_{1.7}(PO₄)₃ before and after heat treatment;

FIG. 14 is a graph showing X-ray diffraction patterns of a powder mixture of Nb₂O₅ and Li_{1.3}Al_{0.3}Ti_{1.7}(PO₄)₃ before and after heat treatment;

FIG. 15 is a graph showing X-ray diffraction patterns of a powder mixture of FePO₄ and Li_{0.33}La_{0.56}TiO₃ before and after heat treatment;

FIG. 16 is a graph showing X-ray patterns of a powder mixture of Li₃Fe₂(PO₄)₃ and Li_{0.33}La_{0.56}TiO₃ before and after heat treatment;

FIG. 17 is a graph showing X-ray diffraction patterns of a powder mixture of LiFeP₂O₇ and Li_{0.33}La_{0.56}TiO₃ before and after heat treatment;

FIG. 18 is a graph showing X-ray diffraction patterns of a powder mixture of Li₄Ti₅O₁₂ and Li_{0.33}La_{0.56}TiO₃ before and after heat treatment;

FIG. 19 is a graph showing X-ray diffraction patterns of a powder mixture of Nb₂O₅ and Li_{0.33}La_{0.56}TiO₃ before and after heat treatment;

FIG. 20 is a schematic perspective view of a solid electrolyte green sheet formed on a carrier film;

FIG. 21 is a schematic perspective view of an active material green sheet formed on a carrier film;

FIG. 22 is a schematic longitudinal sectional view of the solid electrolyte green sheet and the carrier film, which are placed on a support with a polyester film;

FIG. 23 is a schematic longitudinal sectional view of the solid electrolyte green sheet from which the carrier film has been removed;

FIG. 24 is a schematic longitudinal sectional view of 20 solid electrolyte green sheets and 1 active material green sheet, which are placed on the support with the polyester film;

FIG. 25 is a schematic longitudinal sectional view of two laminated green chips sandwiched between ceramic plates;

FIG. 26 is a schematic longitudinal sectional view of a sintered green chip (i.e., a laminate of the present invention) and a gold thin film formed thereon;

FIG. 27 is a schematic longitudinal sectional view of a battery 1;

FIG. 28 is a schematic longitudinal sectional view of an all solid lithium secondary battery in another embodiment of the present invention;

FIG. 29 is a schematic perspective view of a solid electrolyte green sheet formed on a carrier film;

FIG. 30 is a schematic perspective view of a positive electrode active material green sheet formed on a carrier film;

FIG. 31 is a schematic perspective view of a negative electrode active material green sheet formed on a carrier film;

FIG. 32 is a schematic longitudinal sectional view of the negative electrode active material green sheet and the carrier film, which are placed on a support with a polyester film;

FIG. 33 is a schematic longitudinal sectional view of the negative electrode active material green sheet from which the carrier film has been removed;

FIG. 34 is a schematic longitudinal sectional view of the negative electrode active material green sheet, 20 solid electrolyte green sheets, and the positive electrode active material green sheet, which are laminated on a support with a polyester film;

FIG. 35 is a schematic longitudinal sectional view of two laminated green chips sandwiched between ceramic plates;

FIG. 36 is a schematic longitudinal sectional view of a sintered laminate and a gold thin film formed thereon (battery 7);

FIG. 37 is a schematic longitudinal sectional view of a battery 11 produced in Example 4;

FIG. 38 is a schematic longitudinal sectional view of a battery 18 produced in Example 6;

FIG. 39 is a schematic longitudinal sectional view of a battery 19 produced in Example 6;

FIG. 40 is a schematic perspective view of a solid electrolyte green sheet formed on a carrier film;

FIG. 41 is a schematic top view of a plurality of positive electrode active material green sheets arranged on a carrier film in a predetermined pattern;

FIG. 42 is a schematic top view of a plurality of positive electrode current collector green sheets arranged on a carrier film in a predetermined pattern;

FIG. 43 is a schematic top view of a plurality of negative electrode active material green sheets arranged on a carrier film in a predetermined pattern;

FIG. 44 is a schematic top view of a plurality of negative electrode current collector green sheets arranged on a carrier film in a predetermined pattern;

FIG. 45 is a schematic longitudinal sectional view of the solid electrolyte green sheet and the carrier film, which are placed on a support with a polyester film;

FIG. 46 is a schematic longitudinal sectional view of the solid electrolyte green sheet from which the carrier film has been removed;

FIG. 47 is a schematic longitudinal sectional view of 20 solid electrolyte green sheets laminated on the support with the polyester film;

FIG. 48 is a schematic longitudinal sectional view of the plurality of negative electrode active material green sheets carried on the surface of the carrier film, which are being laminated on the solid electrolyte green sheet formed on the carrier film;

FIG. 49 is a schematic longitudinal sectional view of the negative electrode active material green sheets, the negative electrode current collector green sheets, and the negative electrode active material green sheets, which are laminated on the solid electrolyte green sheet;

FIG. 50 is a schematic longitudinal sectional view of the plurality of positive electrode active material green sheets carried on the surface of the carrier film, which are being laminated on the solid electrolyte green sheet formed on the carrier film;

FIG. 51 is a schematic longitudinal sectional view of the positive electrode active material green sheets, the positive electrode current collector green sheets, and the positive electrode active material green sheets, which are laminated on the solid electrolyte green sheet;

FIG. 52 is a schematic longitudinal sectional view of the laminate of the negative electrode active material green sheets, the negative electrode current collector green sheets, and the negative electrode active material green sheets carried on the surface of the solid electrolyte green sheet, the laminate being laminated on the solid electrolyte green sheet laminate;

FIG. 53 is a schematic longitudinal sectional view of five negative electrode laminates and four positive electrode laminates, which are alternately laminated on the solid electrolyte green sheet laminate;

FIG. 54 is a top view of a green chip obtained by cutting the laminate sheet;

FIG. 55 is a schematic longitudinal sectional view of the green chip of FIG. 54 taken along the line X-X;

FIG. 56 is a schematic longitudinal sectional view of the green chip of FIG. 54 taken along the line Y-Y;

FIG. 57 is a schematic longitudinal sectional view of a sintered body having a positive electrode external current collector and a negative electrode external current collector at an end face at which positive electrode current collectors are exposed and an end face at which negative electrode current collectors are exposed, respectively;

FIG. 58 is a schematic top view of positive electrode active material green sheets that are arranged in a predetermined pattern on a solid electrolyte green sheet on a carrier film;

FIG. 59 is a schematic top view of negative electrode active material green sheets that are arranged in a predetermined pattern on a solid electrolyte green sheet on a carrier film;

FIG. 60 is a schematic longitudinal sectional view of the negative electrode active material green sheets carried on the surface of the solid electrolyte green sheet, which are laminated on a solid electrolyte green sheet laminate.

FIG. 61 is a schematic longitudinal sectional view of five negative electrode sheets and four positive electrode sheets, which are laminated on the solid electrolyte green sheet laminate;

FIG. 62 is a top view of a green chip obtained by cutting the laminate sheet;

FIG. 63 is a schematic longitudinal sectional view of the green chip of FIG. 62 taken along the line X-X;

FIG. 64 is a schematic longitudinal sectional view of the green chip of FIG. 62 taken along the line Y-Y;

FIG. 65 is a schematic longitudinal sectional view of a sintered body having a positive electrode external current collector and a negative electrode external current collector at an end face at which positive electrode active material layers are exposed and an end face at which negative electrode active material layers are exposed, respectively;

FIG. 66 is a schematic longitudinal sectional view of the sintered body in which the parts other than the parts covered with the positive electrode external current collector and the negative electrode external current collector are covered with a glass layer;

FIG. 67 is a schematic perspective view of a solid electrolyte green sheet formed on a carrier film;

FIG. 68 is a schematic top view of a plurality of positive electrode active material green sheets arranged on a carrier film in a predetermined pattern;

FIG. 69 is a schematic top view of a plurality of positive electrode current collector green sheets arranged on a carrier film in a predetermined pattern;

FIG. 70 is a schematic top view of a plurality of negative electrode current collector green sheets arranged on a carrier film in a predetermined pattern;

FIG. 71 is a schematic longitudinal sectional view of the solid electrolyte green sheet and the carrier film, which are placed on a support with a polyester film;

FIG. 72 is a schematic longitudinal sectional view of the solid electrolyte green sheet from which the carrier film has been removed;

FIG. 73 is a schematic longitudinal sectional view of 20 solid electrolyte green sheets laminated on the support with the polyester film;

FIG. 74 is a schematic longitudinal sectional view of the plurality of negative electrode current collector green sheets carried on the surface of the carrier film, which are being laminated on the solid electrolyte green sheet formed on the carrier film;

FIG. 75 is a schematic longitudinal sectional view of the negative electrode active material green sheets and the negative electrode current collector green sheets, which are laminated on the solid electrolyte green sheet;

FIG. 76 is a schematic longitudinal sectional view of the plurality of positive electrode active material green sheets carried on the surface of the carrier film, which are being laminated on the solid electrolyte green sheet formed on the carrier film;

FIG. 77 is a schematic longitudinal sectional view of the positive electrode active material green sheets, the positive electrode current collector green sheets, and the positive electrode active material green sheets, which are laminated on the solid electrolyte green sheet;

FIG. 78 is a schematic longitudinal sectional view of the negative electrode current collector green sheets carried on the surface of the solid electrolyte green sheet, which are laminated on the solid electrolyte green sheet laminate;

FIG. 79 is a schematic longitudinal sectional view of five negative electrode-solid electrolyte sheets and four positive electrode laminates, which are alternately laminated on the solid electrolyte green sheet laminate;

FIG. 80 is a top view of a green chip obtained by cutting the laminate sheet;

FIG. 81 is a schematic longitudinal sectional view of the green chip of FIG. 80 taken along the line X-X;

FIG. 82 is a schematic longitudinal sectional view of the green chip of FIG. 80 taken along the line Y-Y;

FIG. 83 is a schematic longitudinal sectional view of a sintered body having a positive electrode external current collector and a negative electrode external current collector at an end face at which positive electrode current collectors are exposed and an end face at which negative electrode current collectors are exposed, respectively;

### BEST MODE FOR CARRYING OUT THE INVENTION

A laminate of the present invention (hereinafter also referred to as a first laminate) includes an active material layer and a solid electrolyte layer bonded to the active material layer.

The active material layer contains a crystalline first substance capable of absorbing and desorbing lithium ions, and the solid electrolyte layer contains a crystalline second substance with lithium ion conductivity. An X-ray diffraction analysis of the laminate shows that there is no component other than constituent components of the active material layer and constituent components of the solid electrolyte layer.

Also, the active material layer and the solid electrolyte are preferably crystalline.

In a battery made with the laminate, the positive electrode includes the active material layer.

The first substance contained in the active material layer can be, for example, a crystalline first phosphoric acid compound capable of absorbing and desorbing lithium ions. The first phosphoric acid compound is preferably a material represented by the following general formula:
LiMPO₄
where M is at least one selected from the group consisting of Mn, Fe, Co, and Ni.

Also, the second substance contained in the solid electrolyte layer can be a crystalline second phosphoric acid compound with lithium ion conductivity. The second phosphoric acid compound is preferably a material represented by the following general formula:
Li_{1+X}M^{III}_{X}Ti^{IV}_{2-X}(PO₄)₃
where M^{III} is at least one metal ion selected from the group consisting of Al, Y, Ga, In, and La, and 0≦X≦−0.6.

When the active material layer containing such an active material and the solid electrolyte layer containing such a solid electrolyte are used, even if a heat treatment is applied in the production of the laminate, it is possible to suppress the occurrence of an impurity phase, which is neither the active material nor the solid electrolyte and does not contribute to charge/discharge reaction, at the bonding interface between the first substance and the second substance (i.e., the bonding interface between the active material and the solid electrolyte).

In order for an all solid battery to be capable of charge/discharge, it is necessary to maintain lithium ion conductivity at the bonding interface between the active material layer and the solid electrolyte layer and to firmly bond the active material layer and the solid electrolyte layer together over a large area. The combination of the active material layer and the solid electrolyte layer according to the present invention enables such interfacial bonding.

The active material layer and the solid electrolyte layer preferably have lithium ion conductivity. Also, it is preferred that at least the solid electrolyte layer have a packing rate of solid electrolyte of more than 70%. Likewise, it is preferred that the active material layer have a packing rate of active material of more than 70%. If the packing rate is less than 70%, for example, a battery made with such a laminate of the present invention may have poor high-rate charge/discharge characteristics.

Preferably, the active material layer and the solid electrolyte layer do not contain organic matter such as an organic binder, since organic matter impairs the electronic conductivity or ionic conductivity of the active material layer and the solid electrolyte layer. That is, they are preferably deposited films or sintered films.

In the first laminate, the thickness x₁ of the active material layer is preferably 0.1 to 10 μm. If the thickness x₁ of the active material layer is less than 0.1 μm, a battery having a sufficient capacity cannot be obtained. If the thickness x₁ of the active material layer is more than 10 μm, it is difficult for such a battery to charge and discharge.

Also, the thickness y of the solid electrolyte layer may be in a relatively wide range. The thickness y of the solid electrolyte layer is preferably approximately 1 μm to 1 cm, and more preferably 10 to 500 μm. This is because the solid electrolyte layer needs to have mechanical strength, although the solid electrolyte layer is desirably thin in terms of energy density.

In the laminate of the present invention, at least one layer selected from the group consisting of the active material layer and the solid electrolyte layer preferably contains an amorphous oxide.

Generally speaking, different ceramics materials (e.g., first phosphoric acid compounds and second phosphoric acid compounds) are sintered at different temperatures. Thus, when a laminate of a plurality of different ceramics materials is subjected to a heat treatment for sintering, the sintering of the materials starts at different temperatures or proceeds at different speeds. When the sintering of the respective layers starts at different temperatures or proceeds at different speeds, warpage may occur during the sintering or the laminate may become brittle due to thermal strain. Further, the interface between the active material layer and the solid electrolyte layer may become separated. Thus, it is preferable to add an amorphous oxide as a sintering aid to either the active material layer or the solid electrolyte layer whose sintering should be promoted. As a result, for example, the sintering-start temperatures and sintering speeds of the respective layers can be made the same. It thus becomes possible to reduce the warpage or embrittlement of the laminate, interfacial separation of the active material layer and the solid electrolyte layer, etc., which occur when the laminate is sintered. By changing the kind (softening point) of the amorphous oxide, the sintering-start temperature and the like can be adjusted, and by changing the amount added, the sintering speed and the like can be adjusted.

Further, in producing an all solid battery by using the above-mentioned laminate, when an amorphous oxide is added to at least one of the active material layer and the solid electrolyte layer, the impedance of the all solid battery can be lowered. Such a battery with low impedance has excellent high-rate characteristics.

Examples of such amorphous oxides include those containing SiO₂, Al₂O₃, Na₂O, MgO, and CaO, 72 wt % SiO₂-1 wt % Al₂O₃-20 wt % Na₂O-3 wt % MgO-4 wt % CaO, 72 wt % SiO₂-1 wt % Al₂O₃-14 wt % Na₂O-3 wt % MgO-10 wt % CaO, and 62 wt % SiO₂-15 wt % Al₂O₃-8 wt % CaO-15 wt % BaO.

The softening temperature of an amorphous oxide can be changed by adding an oxide of an alkali metal, an alkaline earth metal, or a rare-earth element to the amorphous oxide, or by changing the content thereof.

Also, in the layer to which an amorphous oxide is added, the amount of the amorphous oxide is desirably 0.1% by weight or more and 10% by weight or less of the layer. If the amount of the amorphous oxide is less than 0.1% by weight, the amorphous oxide may not produce the effect of promoting the sintering. If the amount of the amorphous oxide exceeds 10% by weight, the amount of the amorphous oxide in the layer is excessive, so that the electrochemical characteristics of the battery may degrade.

Next, an all solid lithium secondary battery of the present invention is described.

An all solid lithium secondary battery of the present invention has a laminate (hereinafter also referred to as a second laminate) including at least one combination comprising a positive electrode active material layer, a negative electrode active material layer, and a solid electrolyte layer interposed between the positive electrode active material layer and the negative electrode active material layer. In the all solid lithium secondary battery of the present invention, at least the positive electrode active material layer and the solid electrolyte layer are bonded together (integrated). That is, in the second laminate, the above-mentioned first laminate serves as the positive electrode active material layer and the solid electrolyte layer.

In this case, it is also preferable that at least the solid electrolyte layer have a packing rate of more than 70%. Likewise, the positive electrode active material layer preferably has a packing rate of more than 70%.

In the same manner as in the first laminate, the positive electrode active material layer contains, for example, a first substance such as the above-mentioned first phosphoric acid compound, and the solid electrolyte layer contains, for example, a second substance such as the above-mentioned second phosphoric acid compound. The negative electrode active material may be composed of, for example, a material that can be used in the form of a plate. Examples of such materials include lithium metal, Al, Sn, and In.

The thickness of the negative electrode active material layer is preferably 500 μm or less.

Also, among the first phosphoric acid compounds, the compounds represented by the general formula: LiMPO₄ where M is at least one selected from the group consisting of Mn, Fe, Co, and Ni usually have high operating potential. Hence, by using, for example, a first phosphoric acid compound represented by the above-mentioned general formula as the positive electrode active material and using lithium metal as the negative electrode active material, it is possible to obtain a battery with high operating voltage.

Also, among the second phosphoric acid compounds used as the solid electrolyte, it is known that the compounds represented by Li_{1+X}M^{III}_{X}Ti^{IV}_{2-X}(PO₄)₃ where M_{III} is at least one metal ion selected from the group consisting of Al, Y, Ga, In, and La and 0≦X≦0.6 are electrochemically reduced at about 2.5 V versus Li/Li⁺ electrode. Thus, in the case of using an active material whose operating voltage is 2.5 V or less versus Li/Li⁺ electrode, in order to prevent it from being reduced, it is preferable to provide a layer comprising a reduction-resistant electrolyte between the solid electrolyte layer and the negative electrode. In this case, a solid battery with excellent reversibility can be obtained.

The reduction-resistant electrolyte may be a conventional polymer electrolyte in the related art. Examples of such polymer electrolytes include: a gelled electrolyte comprising a polymer host, such as polyacrylonitrile, polyvinylidene fluoride, polymethyl methacrylate, or polyether, impregnated and swollen with an electrolyte; and a dry polymer obtained by copolymerizing polyethylene oxide-based polyether with siloxane, an acrylic acid-type compound, or polyhydric alcohol serving as branch chains, and dissolving a Li salt such as LiPF₆, LiClO₄, LiBF₄, or LiN(SO₂CF₃)₂ in the copolymer.

An example of the electrolyte used to prepare the gelled electrolyte is one in which a Li salt such as LiPF₆, LiClO₄, LiBF₄, or LiN(SO₂CF₃)₂ is dissolved in a solvent mixture containing two or more of solvents such as ethylene carbonate, propylene carbonate, dimethoxyethane, dimethyl carbonate, ethyl methyl carbonate, and diethyl carbonate.

A layer comprising such a gelled electrolyte can be formed on the surface of the solid electrolyte layer, for example, as follows.

A polymer host is singly dissolved in an organic solvent such as acetonitrile, 2-methyl-pyrrolidinone, 1,2-dimethoxyethane, or dimethyl formamide in advance. This solution is applied onto the surface of the solid electrolyte layer by a method such as casting or spin coating and dried to form a thin film. Subsequently, a liquid electrolyte containing a Li salt as described above is added to this thin film to cause gelation of the film. In this way, a gelled electrolyte layer can be formed on the surface of the solid electrolyte layer.

Also, a layer comprising a dry polymer can be formed in the same manner as the gelled electrolyte. Specifically, a copolymer containing the above-mentioned polyether with a Li salt dissolved therein is dissolved in an organic solvent such as acetonitrile, 2-methyl-pyrrolidinone, 1,2-dimethoxyethane, or dimethyl formamide. The resulting solution is applied onto the surface of the solid electrolyte layer by a method such as casting or spin coating, followed by drying. In this way, a dry polymer layer can be formed on the surface of the solid electrolyte layer.

The battery of the present invention may be structured such that a negative electrode current collector is provided directly on the reduction-resistant electrolyte layer without providing a negative electrode between the reduction-resistant electrolyte layer and the negative electrode current collector. When this battery is charged, the lithium ions contained in the positive electrode active material are deposited on the negative electrode current collector as lithium metal, and the lithium metal can serve as the negative electrode.

Also, in the all solid lithium secondary battery of the present invention, the positive electrode active material layer, the solid electrolyte layer, and the negative electrode active material layer are preferably integrated. When the positive electrode active material layer, the solid electrolyte layer, and the negative electrode active material layer are integrated, the negative electrode active material preferably contains a third phosphoric acid compound capable of absorbing and desorbing lithium ions. The third phosphoric acid compound is preferably at least one selected from the group consisting of FePO₄, Li₃Fe₂(PO₄)₃, and LiFeP₂O₇.

Also, the negative electrode active material layer may contain, for example, Li₄Ti₅O₁₂ as the active material. In this case, for example, Li_{0.33}La_{0.56}TiO₃ may be used as the solid electrolyte.

Also, the positive electrode active material layer, the solid electrolyte layer, and the negative electrode active material layer are preferably crystalline.

The use of such a negative electrode active material makes it possible to suppress the occurrence of an impurity phase that does not contribute to charge/discharge reaction not only at the interface between the positive electrode active material and the solid electrolyte but also at the interface between the negative electrode electrolyte and the solid electrolyte. Also, at these interfaces, lithium ion conductivity can be maintained and the active material layer and the solid electrolyte layer can be firmly bonded together in a large area. That is, it is possible to lower the internal resistance of the all solid lithium secondary battery and improve reliability.

In this case, the thickness x₃ of the negative electrode active material layer is preferably 0.1 to 10 μm. If the thickness x₃ of the active material layer is less than 0.1 μm, a battery having a sufficient capacity cannot be obtained. If the thickness x₃ of the active material layer is more than 10 μm, it is difficult for such a battery to charge and discharge.

The thickness x₁ of the positive electrode active material is preferably 0.1 to 10 μm. The thickness y of the solid electrolyte layer is preferably approximately 1 μm to 1 cm, and 10 to 500 μm is preferable. The reason for this is the same as that as described above.

In addition, in the second laminate including one or more above-mentioned combinations, the respective combinations are preferably bonded together. Since one or more above-mentioned combinations are included, the battery capacity can be enlarged. Also, since the respective combinations are integrated, the internal resistance of the all solid lithium secondary battery can be lowered.

In this case, it is also preferable that the positive electrode active material layer, the solid electrolyte layer, and the negative electrode active material layer each have a packing rate of more than 70%.

Also, the all solid lithium secondary battery of the present invention may include a positive electrode current collector and a negative electrode current collector.

For example, the positive electrode current collector may be provided on the face of the positive electrode active material layer opposite to the face in contact with the solid electrolyte layer, and the negative electrode current collector may be provided on the face of the negative electrode active material layer opposite to the face in contact with the solid electrolyte layer. In this case, the positive electrode current collector and the negative electrode current collector are provided, for example, after the laminate is formed.

Also, when the positive electrode current collector and the negative electrode current collector are formed after the above-mentioned combination is formed, the positive electrode current collector and/or negative electrode current collector may be composed of a conductive material known in the related art (e.g., a predetermined metal thin film).

Also, in the all solid lithium secondary battery of the present invention, when two or more above-mentioned combinations are laminated, the positive electrode active material layers and negative electrode active material layers included in the all solid lithium secondary battery may contain a positive electrode current collector and a negative electrode current collector, respectively. At this time, the positive electrode current collector may be in the form of a thin film or a three-dimensional network.

When two or more combinations are laminated as described above, the positive electrode current collectors in the respective positive electrode active material layers and the negative electrode current collectors in the respective negative electrode active material layers may be connected in parallel by a positive electrode external current collector and a negative electrode external current collector, respectively. At this time, one end of the positive electrode current collectors and one end of the negative electrode current collectors are preferably exposed at different faces of the laminate of two or more combinations. For example, the second laminate of two or more combinations is hexahedral, one end of the positive electrode current collectors may be exposed at a predetermined face of the laminate, and one end of the negative electrode current collectors may exposed at the face opposite to the face at which one end of the positive electrode current collectors is exposed.

The parts of surface of the second laminate excluding the parts covered with the positive electrode external current collector and the negative electrode external current collector are preferably covered with the solid electrolyte layer. In this case, the positive electrode external current collector, the negative electrode external current collector, and the solid electrolyte layer serve as an outer jacket.

The positive electrode external current collector and the negative electrode external current collector may comprise a mixture of a metal material, which has electronic conductivity, and glass frit, which can be fused due to heat. While copper is usually used as the metal material, other metal may also be used. A low melting point glass frit with a softening point of approximately 400 to 700° C. is used.

When the positive electrode current collector and the negative electrode current collector are provided during the production of the above-mentioned combination, it is preferable that the positive electrode current collector and the negative electrode current collector be heat-treatable in the same atmosphere as that for the positive electrode active material layer, the solid electrolyte layer, and the negative electrode active material layer, and not react with the positive electrode active material and the negative electrode active material, respectively.

The material of the positive electrode current collector and the negative electrode current collector is preferably at least one selected from the group consisting of silver, copper, nickel, palladium, gold, and platinum. When a heat treatment is performed in the atmosphere (the air), palladium, gold, and platinum are more preferable since silver, copper, and nickel may react with the active material.

Also, when two or more above-mentioned combinations are used, the active material layers of the same kind are laminated with a current collector interposed therebetween. In this way, the all solid lithium secondary battery can be provided with a positive electrode current collector and a negative electrode current collector. For example, when three combinations of a first combination, a second combination, and a third combination are laminated, the positive electrode active material layer of the first combination and the positive electrode active material layer of the second combination are carried on both sides of a positive electrode current collector, and the negative electrode active material layer of the second combination and the negative electrode active material layer of the third combination are carried on both sides of a negative electrode current collector. In this way, the all solid lithium secondary battery can be provided with the positive electrode current collector and the negative electrode current collector.

Also, in the case of using a solid electrolyte layer containing Li_{1+X}M^{III}_{X}Ti^{IV}_{2-X}(PO₄)₃ where M^{III} is at least one metal ion selected from Al, Y, Ga, In, and La and 0≦X≦0.6, this solid electrolyte can serve as the negative electrode active material. This solid electrolyte is capable of absorbing and desorbing Li at approximately 2.5 V versus Li/Li⁺.

Also, in the all solid lithium secondary battery, particularly in the all solid lithium secondary battery including a laminate of a plurality of above-mentioned combinations, at least one current collector of the positive electrode current collector and the negative electrode current collector preferably has a porosity of 20% or more and 60% or less.

The volume of an active material usually increases and decreases when lithium is inserted and released upon charge/discharge. Even when the volume of the active material changes, if the current collector has pores, the pores can serve as a buffer layer. It is thus possible to suppress delamination at the interface between the current collector and the active material, cracking, etc. of the all solid battery.

If the porosity of the current collector is less than 20%, it becomes difficult to ease the volume change of the active material, so that the battery may be susceptible to breakage. If the porosity of the current collector is more than 60%, the ability of the current collector to collect current degrades, so the battery capacity may decrease.

Further, the positive electrode current collector preferably does not react with the positive electrode active material, and the negative electrode current collector preferably does not react with the negative electrode active material. Also, the positive electrode current collector and the negative electrode current collector are desirably heat-treatable at same time and in the same atmosphere as that for the positive electrode active material, the solid electrolyte, and the negative electrode active material.

The material of the positive electrode current collector and the negative electrode current collector is, for example, platinum, gold, palladium, silver, copper, nickel, cobalt or stainless steel.

However, since silver, copper, nickel, cobalt, and stainless steel are highly reactive to the active material, it is essential to control the atmosphere in the baking step of the laminate. It is thus preferable to use a current collector made of platinum, gold, or palladium.

Also, it is preferable to insert the positive electrode current collector in the form of a layer in a central part of the positive electrode active material layer and the negative electrode current collector in the form of a layer in a central part of the negative electrode active material layer.

In the all solid lithium secondary battery of the present invention, at least one layer selected from the group consisting of the positive electrode active material layer, the solid electrolyte layer, and the negative electrode active material layer may contain an amorphous oxide, as in the first laminate. Also, in the layer containing the amorphous oxide, the amount of the amorphous oxide is preferably 0.1% by weight or more and 10% by weight of the layer. The reason for this is the same as the above.

As described above, the inclusion of an amorphous oxide in at least one layer selected from the group consisting of the positive electrode active material layer, the solid electrolyte layer, and the negative electrode active material layer can reduce the impedance of the all solid battery, thereby resulting in an improvement in high-rate characteristics.

Also, Li₄P₂O₇ can be sintered with a first phosphoric acid compound, a second phosphoric acid compound, or a third phosphoric acid compound. Thus, at least one layer selected from the group consisting of the positive electrode active material layer, the solid electrolyte layer, and the negative electrode active material layer may contain Li₄P₂O₇. Li₄P₂O₇, which has a melting point of 876° C., functions as a sintering aid at 700° C. or more. Thus, the inclusion of Li₄P₂O₇ in at least one selected from the group consisting of the positive electrode active material layer, the negative electrode active material layer, and the solid electrolyte layer allows the layer to be sintered in an improved manner. As described above, since Li₄P₂O₇ has essentially the same effect as an amorphous oxide, it can be handled in the same manner as an amorphous oxide.

Next, the method for producing the first laminate is described.

The first laminate can be produced, for example, as follows.

First, an active material is dispersed in a solvent containing a binder and a plasticizer to form a slurry 1 for forming an active material layer. Likewise, a solid electrolyte is dispersed in a solvent containing a binder and a plasticizer to form a slurry 2 for forming a solid electrolyte layer (step (1)). The active material contains, for example, the first phosphoric acid compound, and the solid electrolyte contains, for example, the second phosphoric acid compound.

The binder and the plasticizer may be dispersed or dissolved in the solvent.

Next, the slurry 1 is applied onto, for example, a predetermined substrate (e.g., sheet or film) with a release agent layer and dried to obtain an active material green sheet. Likewise, the slurry 2 is applied onto a predetermined substrate and dried to obtain a solid electrolyte green sheet (step (2)).

Subsequently, the active material green sheet and the solid electrolyte green sheet thus obtained are laminated and heat-treated (sintered) to obtain a first laminate comprising an active material layer and a solid electrolyte layer (step (3)).

Since organic matter contained in the active material green sheet and the solid electrolyte green sheet, such as the binder and the plasticizer, is decomposed during the sintering, no organic matter is contained in the active material layer and the solid electrolyte layer of the resultant laminate.

Also, the packing rate of the active material layer and the solid electrolyte layer can be adjusted by adjusting the highest sintering temperature, the heating rate, or the like. The highest sintering temperature is preferably in the range of 700° C. to 1000° C. If the highest sintering temperature is lower than 700° C., sintering may not proceed. If the highest sintering temperature is higher than 1000° C., Li may volatilize from the Li-containing compound to cause a change in the composition of the Li-containing composition, or mutual diffusion of the active material and the solid electrolyte may occur, thereby resulting in failure of charge/discharge. Also, the heating rate is preferably 400° C./hour or more. If the heating rate is less than 400° C./hour, mutual diffusion of the active material and the solid electrolyte may occur, thereby resulting in failure of charge/discharge.

Also, in the step (1), the above-mentioned amorphous oxide may be added to at least one selected from the group consisting of the slurry 1 and the slurry 2.

The softening point of the amorphous oxide added is desirably almost the same as the sintering-start temperature of either the active material layer or the solid electrolyte layer, whichever is easiest to sinter. For example, when the active material layer contains LiCoPO₄, this positive electrode active material layer is easiest to sinter, and it is thus preferable that the softening point of the amorphous oxide be almost the same as the sintering-start temperature of the active material layer. Also, the softening temperature of the amorphous oxide may be adjusted such that it is almost the same as the highest sintering temperature.

In the present invention, the softening point of the amorphous oxide is desirably 700° C. or more and 950° C. or less.

Further, the first laminate can also be produced in the following manner.

First, an active material is deposited on a predetermined substrate to form an active material layer, and a solid electrolyte is deposited on the active material layer to form a solid electrolyte layer (step (1′)). The deposition of the active material and the solid electrolyte can be performed by sputtering.

Next, the active material layer and the solid electrolyte layer are heat-treated at a predetermined temperature for crystallization to obtain a first laminate (step (2′)).

In the step (2′), the temperature at which the active material layer and the solid electrolyte layer are heat-treated for crystallization is preferably 500° C. to 900° C. If this temperature is lower than 500° C., crystallization may be difficult. If it is higher than 900° C., mutual diffusion of the active material and the solid electrolyte may intensify.

The laminate thus obtained does not have a third layer that interferes with the movement of lithium ions between the active material layer and the solid electrolyte layer.

In the production method of the laminate, the active material may be, for example, a first substance such as the first phosphoric acid compound. The solid electrolyte may be a second substance such as the second phosphoric acid compound.

Next, the production method of the all solid lithium secondary battery of the present invention is described.

An all solid lithium secondary battery having a second laminate that includes at least one combination comprising a first laminate and a negative electrode active material layer can be produced by forming a negative electrode active material layer on a first laminate, which is prepared in the above manner, such that it faces the positive electrode active material layer with the solid electrolyte layer interposed therebetween. When an all solid lithium secondary battery includes a plurality of above-mentioned combinations, the respective combinations are laminated, for example, with a solid electrolyte layer interposed therebetween.

Also, as described above, when a reduction-resistant electrolyte layer is provided between the solid electrolyte layer and the negative electrode active material layer, the reduction-resistant electrolyte layer is formed on the solid electrolyte layer before the negative electrode active material layer is formed. This layer may be formed by various methods without any particular limitation.

Next, the production method of an all solid lithium secondary battery including a second laminate in which a positive electrode active material layer, a solid electrolyte layer and a negative electrode active material layer are integrated is described. Such an all solid lithium secondary battery can be produced, for example, as follows.

First, a positive electrode active material is dispersed in a solvent containing a binder and a plasticizer to form a slurry 1 for forming a positive electrode active material layer. Likewise, a solid electrolyte is dispersed in a solvent containing a binder and a plasticizer to form a slurry 2 for forming a solid electrolyte layer, and a negative electrode active material is dispersed in a solvent containing a binder and a plasticizer to form a slurry 3 for forming a negative electrode active material layer (step (a)). The positive electrode active material comprises, for example, the above-mentioned first phosphoric acid compound, the solid electrolyte comprises, for example, the above-mentioned second phosphoric acid compound, and the negative electrode active material comprises, for example, the above-mentioned third phosphoric acid compound or Ti-containing oxide.

Subsequently, the slurry 1 is applied onto, for example, a predetermined substrate (e.g., sheet or film) with a release agent layer and dried to form a positive electrode active material green sheet. Also, a negative electrode active material green sheet and a solid electrolyte green sheet are formed in the same manner (step (b)).

Then, a first green sheet group, which includes at least one combination including: the solid electrolyte green sheet; and the positive electrode active material green sheet and the negative electrode active material green sheet sandwiching the solid electrolyte green sheet, is formed (step (c)). When a plurality of above-mentioned combinations are used, these combinations are laminated, for example, with a solid electrolyte green sheet interposed therebetween.

Thereafter, the first green sheet group is sintered at a predetermined temperature to form a second laminate including at lest one combination comprising a positive electrode active material layer, a solid electrolyte layer, and a negative electrode active material layer (step (d)). The first phosphoric acid compound, the second phosphoric acid compound, and the third phosphoric acid compound are crystalline and, thus, when they are sintered, the respective layers become crystalline.

It should be noted that since organic matter contained in the active material green sheet and the solid electrolyte green sheet, such as the binder and the plasticizer, is decomposed during the sintering, no organic matter is contained in the active material layer and the solid electrolyte layer of the resultant laminate.

Also, the packing rate of the active material layer and the solid electrolyte layer can be adjusted by adjusting the highest sintering temperature, the heating rate, etc., in the same manner as the above. The highest sintering temperature is preferably in the range of 700° C. to 1000° C., and the heating rate is preferably 400° C./hour or more. The reason for this is the same as described above.

Also, in the step (a), the above-mentioned amorphous oxide may be added to at least one slurry selected from the group consisting of the slurry 1, the slurry 2, and the slurry 3. For example, when the positive electrode active material green sheet, the negative electrode active material green sheet, and the solid electrolyte green sheet have different sintering speeds, the amorphous oxide may be added to the slurries for forming two green sheets with slower sintering speeds. Also, when the difference in sintering speed among the respective green sheets is small, the amorphous oxide may be added to the slurry for forming a green sheet with the slowest sintering speed.

When the positive electrode active material, the solid electrolyte, and the negative electrode active material are the above-mentioned phosphoric acid compounds and their particle sizes are almost the same, the sintering-start temperature of the solid electrolyte green sheet tends to be higher than those of the positive electrode active material green sheet and the negative electrode active material green sheet. In this case, it is therefore preferable to add the amorphous oxide to the slurry for forming the solid electrolyte layer.

In the slurry containing the amorphous oxide, the amount of the amorphous oxide is preferably 0.1 to 10% by weight of the slurry. The reason for this is the same as described above.

In the step (d), it is preferable to heat-treat a laminate of the positive electrode active material green sheet, the solid electrolyte green sheet, and the negative electrode active material green sheet in order to obtain a laminate comprising a positive electrode active material layer, a solid electrolyte layer, and a negative electrode active material layer. The reason for this is as follows. For example, a laminate of the positive electrode active material green sheet and the solid electrolyte green sheet is heat-treated, and then the negative electrode active material green sheet is formed on the face of the solid electrolyte layer opposite to the face in contact with the positive electrode active material layer. The resulting laminate is further heat-treated for bonding. In this case, the solid electrolyte layer has been sufficiently sintered, but the negative electrode active material green sheet shrinks due to sintering, so that the solid electrolyte layer and the negative electrode active material layer may not be bonded together and may become separated at the interface thereof.

A positive electrode current collector and a negative electrode current collector may be disposed so as to sandwich the second laminate. Alternatively, each positive electrode active material layer and/or each negative electrode active material layer may have a current collector.

When a positive electrode current collector and a negative electrode current collector are disposed so as to sandwich the second laminate, the positive electrode current collector and the negative electrode current collector are disposed on both end faces of the second laminate in the laminating direction.

In this case, the current collector can be formed as follows.

For example, a paste containing the above-mentioned conductive material is applied onto the active material layer and dried to form a conductive layer, and this layer can be used as the current collector. Also, a metal layer comprising the above-mentioned conductive material is formed on the active material layer by a method such as sputtering or vapor deposition and can be used as the current collector.

By providing such a conductive layer or a metal layer, it is possible to efficiently collect current from the active material layer.

As described above, in the laminate thus obtained, the positive electrode current collector and the negative electrode current collector preferably have a porosity of 20 to 60%. The porosity of the current collector can be controlled, for example, by adjusting the amount of the conductive material contained in the conductive material paste, the highest sintering temperature and/or the heating rate of sintering as appropriate. The highest sintering temperature, and the heating rate of sintering is preferably 700 to 1000° C. as described above. The heating rate of sintering is preferably 400° C./hour or more.

Next, a description is given of the case where each positive electrode active material layer and/or each negative electrode active material layer have/has a current collector.

For example, when a thin-film current collector is provided in a positive electrode active material layer, two green sheets are used, and for example, a metal thin film or a conductive material layer is disposed as a current collector between the two green sheets. After being sintered, the two green sheets having the current collector therebetween serve as one positive electrode active material layer in the above-mentioned combination. In this way, the positive electrode active material layer including the thin-film current collector can be obtained. Although two green sheets are used in the above description, three or more green sheets may be used.

A thin-film current collector may be formed in a negative electrode active material layer in the same manner as the above-mentioned thin-film current collector formed in the positive electrode active material layer.

When a metal thin film is used as the current collector, the material of the current collector may be gold, platinum, palladium, silver, copper, nickel, cobalt, or stainless steel, as described above. Likewise, when a conductive material layer is used as the current collector, the conductive material may be a metal material as described above.

When a current collector is provided in the form of a three-dimensional network by dispersing particles of a current collector material throughout a positive electrode active material layer and/or a negative electrode active material layer, first, a positive electrode current collector material or a negative electrode current collector material is mixed in the slurry for forming the positive electrode active material layer and/or the slurry for forming the negative electrode active material layer.

Using such a slurry, a positive electrode active material green sheet or a negative electrode active material green sheet is produced. In the resultant positive electrode active material green sheet and negative electrode active material green sheet, the current collector has a three-dimensional network structure.

The current collector material contained in the slurry may be gold, platinum, palladium, silver, copper, nickel, cobalt, or stainless steel in the same manner. Also, the amount of the particles of the current collector material contained in the slurry is preferably 50 to 300 parts by weight per 100 parts by weight of the active material.

A second laminate is produced by using the thus obtained positive electrode active material green sheet and negative electrode active material green sheet with the thin-film current collector or three-dimensional network current collector, and the solid electrolyte green sheet. At this time, it is preferable that one end of the positive electrode active material layer and one end of the negative electrode active material layer be exposed at different surface regions of the second laminate.

Such exposure at different surface regions of the second laminate may be done, for example, as follows.

In the process of laminating the positive electrode active material green sheet, the solid electrolyte green sheet, and the negative electrode active material green sheet, one end of the positive electrode active material green sheet and one end of the negative electrode active material green sheet are exposed at different surface regions of the laminate. By sintering such a laminate, one end of the positive electrode active material layer and one end of the negative electrode active material layer may be exposed at different surface regions of the second laminate.

Also, laminates each including the positive electrode active material green sheet, the solid electrolyte green sheet, and the negative electrode active material green sheet are disposed and/or laminated in a predetermined pattern, and the resultant laminate is cut as appropriate and sintered. As a result, one end of the positive electrode active material layers and one end of the negative electrode active material layers can be exposed at different surface regions of the second laminate.

In this way, even in the case of using two or more positive electrode active material layers and/or negative electrode active material layers, when the current collectors of the respective active material layers are exposed at different surface regions of the second laminate, for example, an external current collector that connects the current collectors of the respective positive electrode active material layers in parallel can be easily formed.

A positive electrode external current collector and a negative electrode external current collector can be formed, for example, by applying a paste containing a metal material, which has electronic conductivity, and glass frit, which can be fused due to heat, onto the region at which the positive electrode current collectors are exposed and the region at which the negative electrode current collectors are exposed, and applying a heat treatment thereto.

Also, the parts of surface of the second laminate excluding the parts covered with the positive electrode external current collector and the negative electrode external current collector are preferably covered with the solid electrolyte layer. To do this, for example, before the laminate is sintered to obtain the second laminate, the parts of the laminate excluding the parts that are to be covered by the external current collectors can be covered with the solid electrolyte green sheet.

Also, the second laminate of the all solid lithium secondary battery of the present invention can also be produced as follows.

A first group that includes a combination comprising a positive electrode active material layer, a negative electrode active material layer, and a solid electrolyte layer interposed between the positive electrode active material layer and the negative electrode active material layer is produced (step (A)). Next, the first group is heat-treated at a predetermined temperature to integrate and crystallize the positive electrode active material layer, the solid electrolyte layer, and the negative electrode active material layer, thereby obtaining a laminate (step (B)).

In the step (A), the first group can be prepared as follows.

First, a positive electrode active material or a negative electrode active material is deposited on a predetermined substrate to form a first active material layer. Subsequently, a solid electrolyte is deposited on the first active material layer to form a solid electrolyte layer. Thereafter, a second active material layer that is different from the first active material layer (i.e., if the first active material layer is a positive electrode active material layer, the second active material layer is a negative electrode active material layer) is deposited on the solid electrolyte layer. In this way, the first group including a combination comprising the first active material layer, the solid electrolyte layer, and the second active material layer is formed. At this time, the first laminate preferably comprises one combination or two or more combinations that are laminated. When two or more combinations are included, these combinations are preferably laminated with a solid electrolyte layer interposed therebetween.

The deposition of the active material and the solid electrolyte may be performed by sputtering.

In the step (B), the solid electrolyte layer and the two active material layers are preferably heat-treated for crystallization at a temperature of 500° C. to 900° C. If this temperature is lower than 500° C., crystallization may become difficult. If it is higher than 900° C., mutual diffusion of the active material and the solid electrolyte may intensify.

Also, the all solid lithium secondary battery of the present invention may be housed in a sealable metal case. In this case, the metal case can be sealed, for example, by sealing the opening with a sealing plate and a gasket.

Also, the all solid lithium secondary battery of the present invention may be covered with resin. Resin molding may be applied to cover the entire battery with resin.

Further, the surface of the all solid lithium secondary battery may be subjected to a water-repellency treatment. This water-repellency treatment can be applied, for example, by immersing the above-mentioned laminate in a dispersion of a water-repellent material such as silane or fluorocarbon resin.

The water-repellency treatment may be applied to the surface of the all solid lithium secondary battery of the present invention before it is covered with resin.

Also, the surface of the all solid lithium secondary battery of the present invention may be provided with a glass layer such as glaze. For example, the all solid lithium secondary battery of the present invention can be sealed with a glass layer by applying a slurry containing a low melting-point glass and heat-treating it at a predetermined temperature.

As described above, by preventing the all solid lithium secondary battery from coming into contact with the ambient air, it becomes possible to eliminate effects of moisture contained in the ambient air, for example, an internal short-circuit caused by reaction between current collector metal and water.

In the production method of the all solid lithium secondary battery, for example, due to the heat treatment (sintering) in air (oxidizing atmosphere), the binder and the plasticizer are readily removed by oxidative decomposition. In this case, however, only expensive noble metal, such as palladium, gold, or platinum, can be used as the material of the current collector.

In the present invention, at least one of the positive electrode current collector contained in the positive electrode and the negative electrode current collector contained in the negative electrode may be composed of a relatively inexpensive metal material, such as silver, copper, or nickel. In this case, the second phosphoric acid compound of the solid electrolyte layer is preferably a phosphoric acid compound represented by Li_{1+X}M^{III}_{X}Ti^{IV}_{2-X}(PO₄)₃ where M^{III} is at least one metal ion selected from the group consisting of Al, Y, Ga, In, and La and 0≦X≦0.6, and the second phosphoric acid compound preferably serves as the negative electrode active material.

In the case of using a readily oxidized metal material such as silver, copper, or nickel, the heat treatment (sintering) needs to be performed in an atmosphere with a low oxygen partial pressure. On the other hand, the third phosphoric acid compound (negative electrode active material) such as FePO₄, Li₃Fe₂(PO₄)₃, or LiFeP₂O₇ contains Fe(III), and stable sintering of Fe(III) requires a relatively high oxygen partial pressure (e.g., 10⁻¹¹ atmospheres (700° C.)). That is, when a metal material such as copper, silver, or nickel is used as the current collector material, a negative electrode active material containing Fe(III) can not be used in some cases. In this case, by using a phosphoric acid compound that does not contain Fe(III) such as a solid electrolyte as the negative electrode active material, a current collector made of a metal material such as silver, copper, or nickel can be used.

However, in such a low oxygen partial pressure condition, the carbonization of the binder and the plasticizer usually proceeds, thereby interfering with the sintering and densification of the active material, the solid electrolyte and the current collector material. Further, if the produced carbon has conductivity, the self-discharge characteristics of the obtained battery may degrade. Also, an internal short-circuit may occur.

Also, when the first phosphoric acid compound represented by the formula LiMPO₄, which forms the positive electrode active material layer, contains at least Fe, sintering in an oxidizing atmosphere such as air results in production of an Fe(III) compound such as Li₃Fe₂(PO₄)₃ in the positive electrode active material layer, so that the charge/discharge capacity and internal resistance of the battery may increase. If sintering is performed in a non-oxidizing atmosphere such as Ar or N₂ to prevent the production of Fe(III), the above-mentioned carbonization of the binder and the plasticizer proceeds, which may have various adverse effects on the battery.

When the current collector is made of a metal material such as copper, silver, or nickel, it is preferable to perform sintering in an atmospheric gas comprising steam and a gas with a low oxygen partial pressure in order to avoid carbonization. In such an atmosphere, since thermal decomposition of organic matter is promoted, it is possible to remove the binder and the plasticizer while suppressing the production of carbon. As a result, the positive electrode active material, the negative electrode active material, and the solid electrolyte can be sintered densely. Hence, the charge/discharge characteristics and reliability of the battery can be improved.

Also, when the positive electrode active material contains Fe, it is possible to remove the binder and the plasticizer while suppressing the production of Fe(III) and the production of carbon.

An example of the production method of an all solid lithium secondary battery is described below. In this production method, a positive electrode active material green sheet is produced by using the slurry 1, and a solid electrolyte green sheet is produced by using the slurry 2. Next, a second green sheet group that includes at least one combination comprising the positive electrode active material green sheet and the solid electrolyte green sheet is formed. Subsequently, the second green sheet group is heat-treated to obtain a laminate including at least one integrated combination of a positive electrode active material layer and a solid electrolyte layer. In producing the second green sheet group, the combination is prepared by using at least two positive electrode active material green sheets and at least two solid electrolyte green sheets. A positive electrode current collector is interposed between the at least two positive electrode active material green sheets while a negative electrode current collector is interposed between the at least two solid electrolyte green sheets. The solid electrolyte serves as the negative electrode active material, and at least one of the positive electrode current collector and the negative electrode current collector is selected from the group consisting of silver, copper, and nickel. Also, the heat treatment is performed in an atmospheric gas comprising steam and a gas with a low oxygen partial pressure.

Further, when LiMPO₄ containing at least Fe (e.g, LiFePO₄) is used as the positive electrode active material, the oxidation number of Fe contained in the positive electrode active material is divalent. It is preferable to perform sintering in a condition where the divalent Fe is stable. Thus, the equilibrium partial pressure PO₂ Of oxygen contained in the sintering (heat treatment) atmosphere is desirably in the range represented by the following formula (1):
−0.0310T+33.5≦−log₁₀PO₂≦−0.0300T+38.1.
If the oxygen partial pressure is greater than the range represented by the formula (1), Fe may be oxidized or the current collector may be oxidized. On the other hand, if the oxygen partial pressure is less than the range represented by the formula (1), it may become difficult to suppress the production of carbon.

Also, in order to stably keep the oxygen partial pressure in the above-mentioned range, the sintering atmosphere preferably comprises a mixed gas containing at least a gas capable of releasing oxygen gas and a gas that reacts with oxygen gas. An example of such a mixed gas is a mixed gas comprising carbon dioxide gas, hydrogen gas, and nitrogen gas. For example, carbon dioxide gas may be used as the gas capable of releasing oxygen gas, and hydrogen gas may be used as the gas that reacts with oxygen gas. When the mixed gas contains hydrogen gas, the volume of the hydrogen gas contained therein is desirably not more than 4%, which is below the explosion limit of hydrogen, for the sake of safety.

When the gas composed of such gases is used, the oxygen partial pressure of the sintering atmosphere can be stably maintained constant during the sintering (heat treatment) due to equilibrium reaction.

In the production of the first laminate, when the active material contains Fe or the like, it is also preferable to adjust the oxygen partial pressure of the atmospheric gas as described above.

Also, in the case of sintering a laminate including a current collector made of a metal material such as silver, copper, nickel, or cobalt, or in the case of sintering a laminate including an active material that contains Fe or the like, the atmospheric gas preferably has a lower oxygen partial pressure than the oxidation-reduction equilibrium oxygen partial pressure of such material. Such an atmospheric gas may be a mixed gas containing carbon dioxide gas (CO₂) and hydrogen gas (H₂). When the mixed gas containing CO₂ and H₂ is used, the oxygen partial pressure of the mixed gas can be maintained low.

The mixing ratio between CO₂ and H₂ containd in the mixed gas is changed, as appropriate, according to the metal material of the current collector. For example, the volume ratio between CO₂ and H₂ in the mixed gas is preferably 10 to 8×10³:1. If the volume ratio of the carbon dioxide gas to the hydrogen gas is less than 10, it may become difficult to decompose the binder. If the volume ratio of the carbon dioxide gas to the hydrogen gas is greater than 8×10³, the current collector may become oxidized.

When the current collector is composed of copper, the volume ratio between CO₂ and H₂ in the atmospheric gas may be, for example, 10³:1.

When the current collector is composed of cobalt, the volume ratio between CO₂ and H₂ in the atmospheric gas may be, for example, 10:1.

When the current collector is composed of nickel, the volume ratio between CO₂ and H₂ in the atmospheric gas may be, for example, 40:1. When the current collector is composed of nickel, the volume ratio between CO₂ and H₂ is preferably 10 to 50:1.

The volume of the hydrogen gas contained in the mixed gas is preferably 4% or less. The reason for this is the same as described above.

As described above, for example, when the positive electrode active material layer comprises a first phosphoric acid compound represented by the formula LiMPO₄ and the first phosphoric acid compound contains at least Fe, it is also preferable to use a mixed gas containing CO₂ and H₂ as the atmospheric gas for baking. The volume ratio between CO₂ and H₂ is preferably 10 to 10⁴:1. If the ratio of the carbon dioxide gas to hydrogen gas is less than 10, it may become difficult to decompose the binder. If the ratio of the carbon dioxide gas to the hydrogen gas is greater than 10⁴, the positive electrode active material may be decomposed.

### EXAMPLES

### Example 1-1

When a sintering process is used to produce a first laminate or a second laminate having an electrochemically active interface between an active material and a solid electrolyte as described above, it is necessary that side reactions other than sintering not occur during the sintering at the sintered interface between the active material and the solid electrolyte. Thus, the reactivity between active materials and solid electrolytes upon heating at 800% was examined.

First, the reactivity between a positive electrode active material and a solid electrolyte is described.

(Sintered Body 1)

LiCoPO₄ was used as the positive electrode active material, and Li_{1.3}Al_{0.3}Ti_{1.7}(PO₄)₃ was used as the solid electrolyte. The positive electrode active material and the solid electrolyte were separately crushed in a ball mill to make the particle size approximately 1 μm. These powders were mixed in a ball mill in a weight ratio of 1:1 and shaped into a pellet of 18 mm in diameter by powder forming. The pellet was sintered at 800° C. in the air for 5 hours. The sintered body was crushed with an agate mortar. The crushed sintered body was designated as a sintered body 1.

(Sintered Body 2)

A sintered body 2 was prepared in the same manner as the sintered body 1, except for the use of LiNiPO₄ as the positive electrode active material.

(Comparative Sintered Body 1)

A comparative sintered body 1 was prepared in the same manner as the sintered body 1, except for the use of LiCoO₂ as the positive electrode active material.

(Comparative Sintered Body 2)

A comparative sintered body 2 was prepared in the same manner as the sintered body 1, except for the use of LiMn₂O₄ as the positive electrode active material.

(Comparative Sintered Body 3)

A comparative sintered body 3 was prepared in the same manner as the sintered body 1, except for the use of Li_{0.33}La_{0.56}TiO₃ as the solid electrolyte.

(Comparative Sintered Body 4)

A comparative sintered body 4 was prepared in the same manner as in the sintered body 1, except for the use of LiNiPO₄ as the positive electrode active material and the use of Li_{0.33}La_{0.56}TiO₃ as the solid electrolyte.

(Comparative Sintered Body 5)

A comparative sintered body 5 was prepared in the same manner as the sintered body 1, except for the use of LiCoO₂ as the positive electrode active material and the use of Li_{0.33}La_{0.56}TiO₃ as the solid electrolyte.

(Comparative Sintered Body 6)

A comparative sintered body 6 was prepared in the same manner as the sintered body 1, except for the use of LiMn₂O₄ as the positive electrode active material and the use of Li_{0.33}La_{0.56}TiO₃ as the solid electrolyte.

(Sintered Body 3)

A sintered body 3 was prepared in the same manner as the sintered body 1, except for the use of LiCo_{0.5}Ni_{0.5}PO₄ as the positive electrode active material.

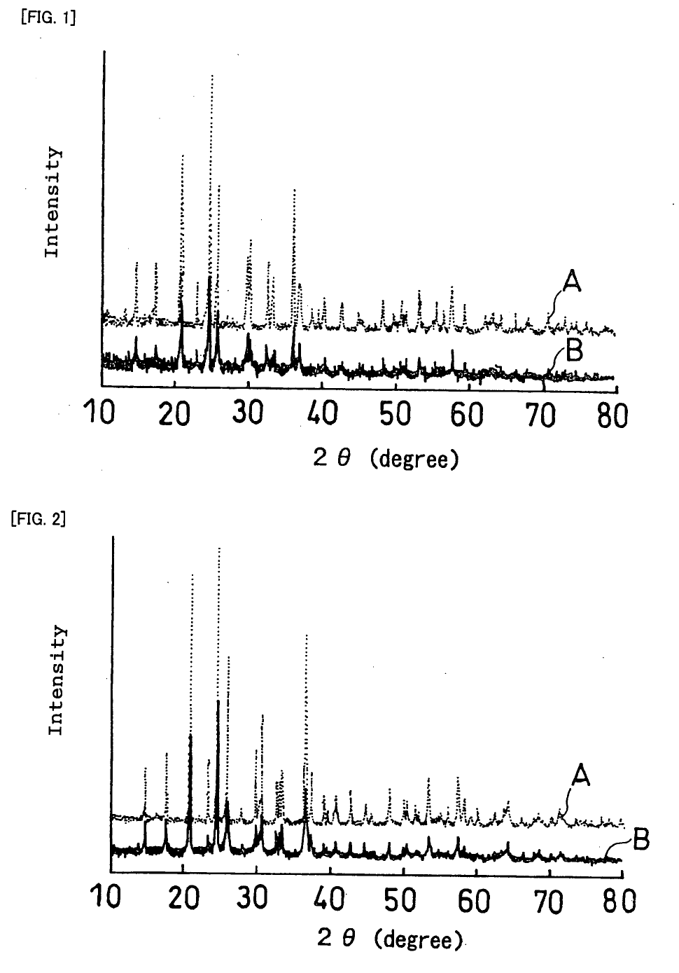

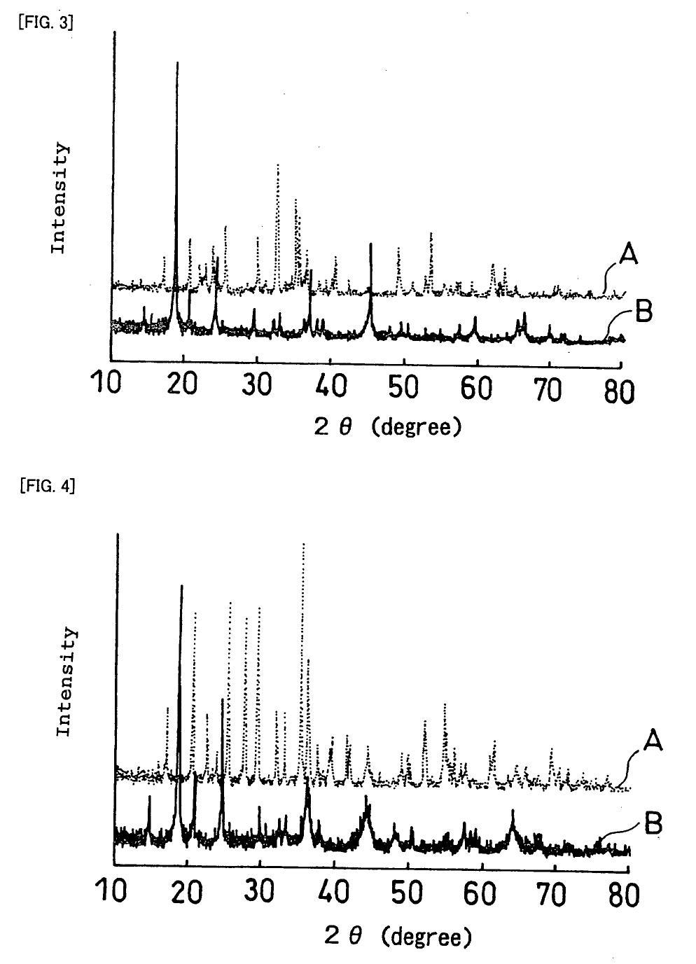

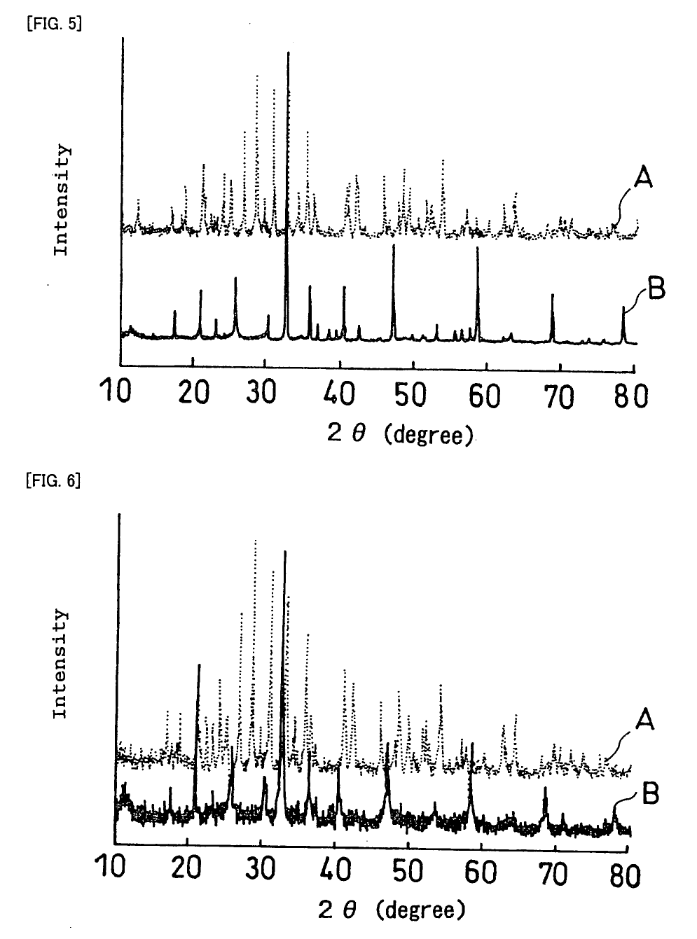

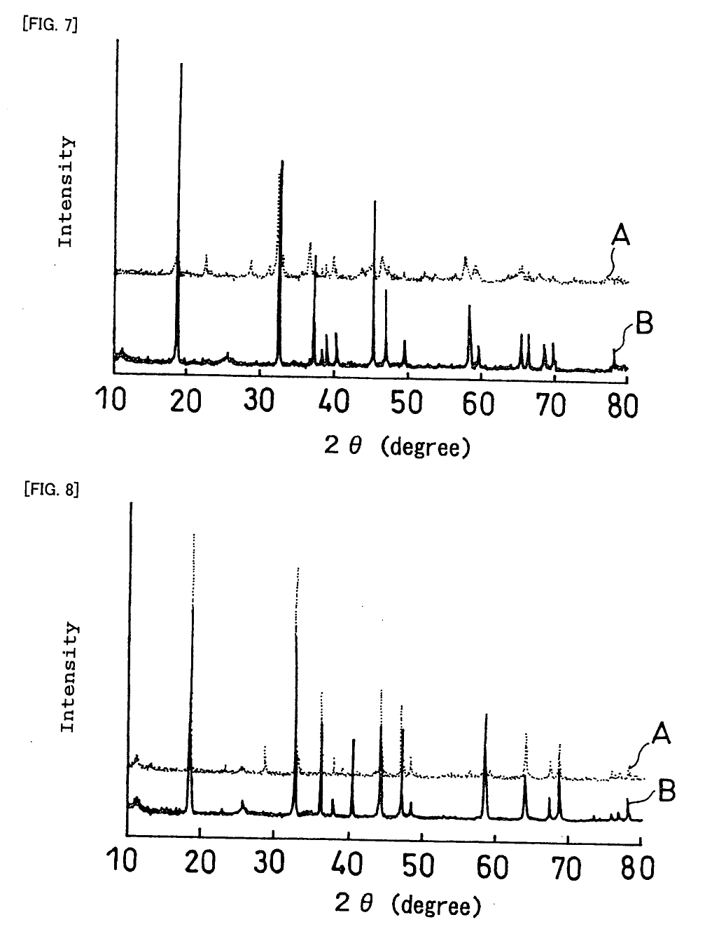

Using the sintered bodies 1 to 3 and the comparative sintered bodies 1 to 6, their X-ray diffraction patterns before and after the sintering were examined by X-ray diffraction analysis using Cu Kα rays. The X-ray diffraction patterns of the respective sintered bodies are shown in FIGS. 1 to 9. In FIGS. 1 to 9, the X-ray diffraction pattern after the sintering is represented by A, and the X-ray diffraction pattern before the sintering is represented by B.

In FIG. 1 (sintered body 1), FIG. 2 (sintered body 2), and FIG. 9 (sintered body 3), the position and pattern of the respective peaks were maintained well before and after the heat treatment. On the other hand, in FIGS. 3 to 8 (comparative sintered bodies 1 to 6), new peaks appeared after the heat treatment.

The above results clearly indicate that in the sintered bodies 1 to 3, a third phase due to solid phase reaction does not occur at the sintered interface between the positive electrode active material and the solid electrolyte, but that in the comparative sintered bodies 1 to 6, a third phase, which is neither the positive electrode active material nor the solid electrolyte, appears.

Therefore, when such a first phosphoric acid compound (positive electrode active material) and such a second phosphoric acid compound (solid electrolyte) are used to produce a laminate, the positive electrode active material and the solid electrolyte can be bonded together by sintering, without producing a third phase that is neither the positive electrode active material nor the solid electrolyte at the interface between the positive electrode active material and the solid electrolyte.

Next, the reactivity between a negative electrode active material and a solid electrolyte is described.

(Sintered Body 4)

A trigonal FePO₄ was used as the negative electrode active material, and Li_{1.3}Al_{0.3}Ti_{1.7}(PO₄)₃ was used as the solid electrolyte. The negative electrode active material and the solid electrolyte were separately crushed in a ball mill to make the particle size approximately 1 μm. These powders were mixed in a ball mill in a weight ratio of 1:1 and shaped into a pellet of 18 mm in diameter by powder forming. The pellet was sintered at 800° C. in the air for 5 hours. The sintered body was crushed with an agate mortar. The crushed sintered body was designated as a sintered body 4.

(Sintered Body 5)

A sintered body 5 was prepared in the same manner as the sintered body 4, except for the use of Li₃Fe₂(PO₄)₃ as the negative electrode active material.

(Sintered Body 6)

A sintered body 6 was prepared in the same manner as the sintered body 4, except for the use of LiFeP₂O₇ as the negative electrode active material.

(Comparative Sintered Body 7)

A comparative sintered body 7 was prepared in the same manner as the sintered body 4, except for the use of Li₄Ti₅O₁₂ as the negative electrode active material.

(Comparative Sintered Body 8)

A comparative sintered body 8 was prepared in the same manner as the sintered body 4, except for the use of Nb₂O₅ as the negative electrode active material.

(Comparative Sintered Body 9)

A comparative sintered body 9 was prepared in the same manner as the sintered body 4, except for the use of Li_{0.33}La_{0.56}TiO₃ as the solid electrolyte.

(Comparative Sintered Body 10)

A comparative sintered body 10 was prepared in the same manner as the sintered body 4, except for the use of trigonal Li₃Fe₂(PO₄)₃ as the negative electrode active material and the use of Li_{0.33}La_{0.56}TiO₃ as the solid electrolyte.

(Comparative Sintered Body 11)

A comparative sintered body 11 was prepared in the same manner as the sintered body 4, except for the use of LiFeP₂O₇ as the negative electrode active material and the use of Li_{0.33}La_{0.56}TiO₃ as the solid electrolyte.

(Sintered Body 12)

A sintered body 12 was prepared in the same manner as the sintered body 4, except for the use of Li₄Ti₅O₁₂ as the negative electrode active material and the use of Li_{0.33}La_{0.56}TiO₃ as the solid electrolyte.

(Comparative Sintered Body 13)

A comparative sintered body 13 was prepared in the same manner as the sintered body 4, except for the use of Nb₂O₅ as the negative electrode active material and the use of Li_{0.33}La_{0.56}TiO₃ as the solid electrolyte.

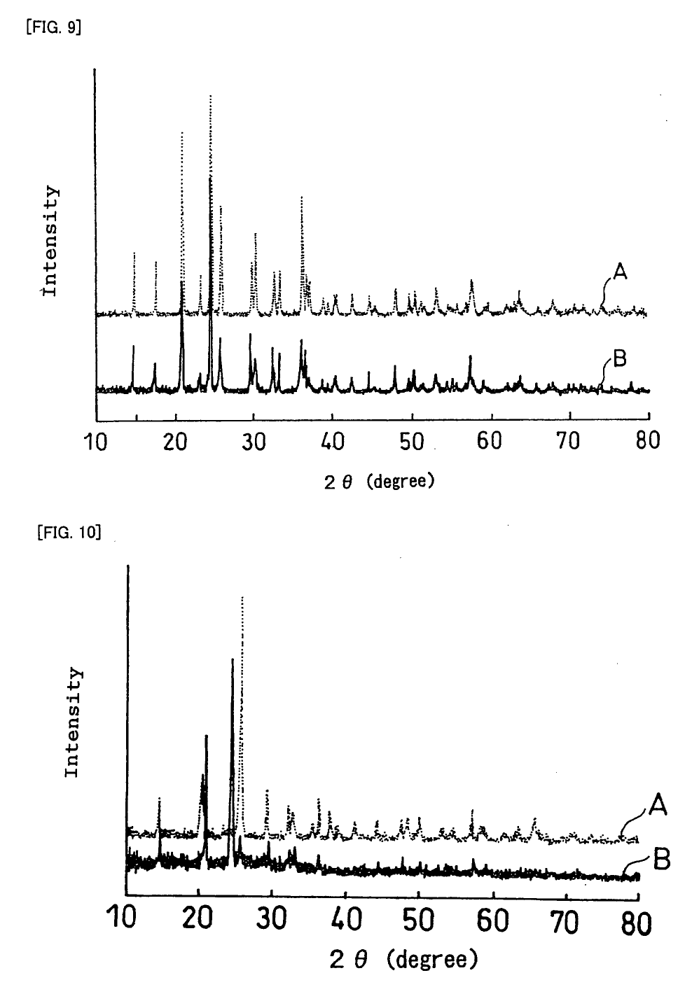

In the same manner as the above, using the sintered bodies 4 to 6 and 12 and the comparative sintered bodies 7 to 11 and 13, their X-ray diffraction patterns before and after the sintering were examined. The X-ray diffraction patterns of the respective sintered bodies are shown in FIGS. 10 to 19. In FIGS. 10 to 19, the X-ray diffraction pattern after the sintering is represented by A, while the X-ray diffraction pattern before the sintering is represented by B.

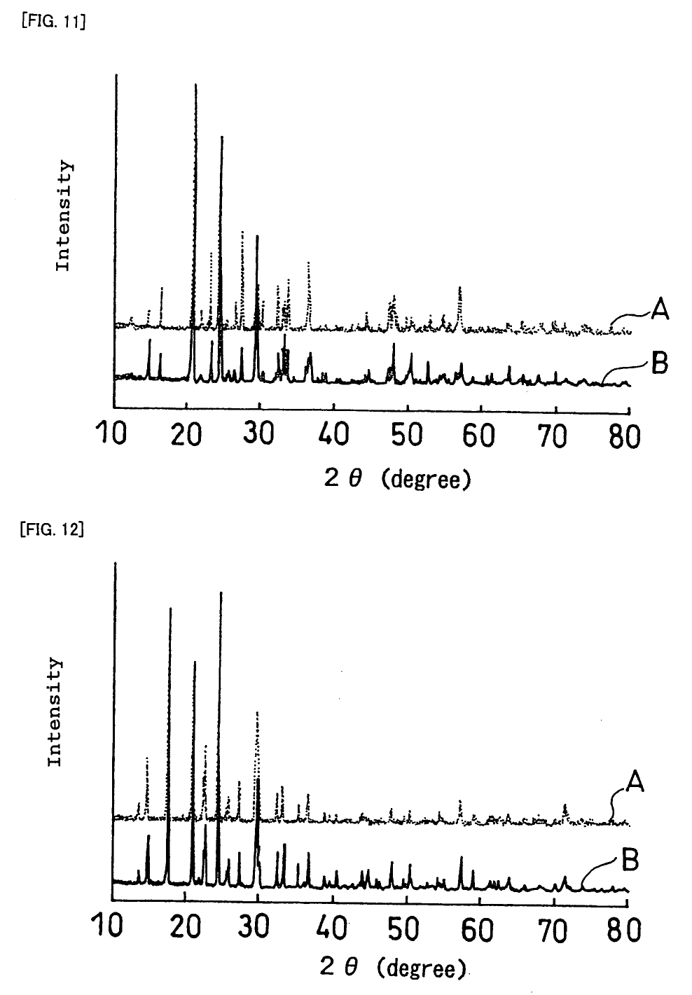

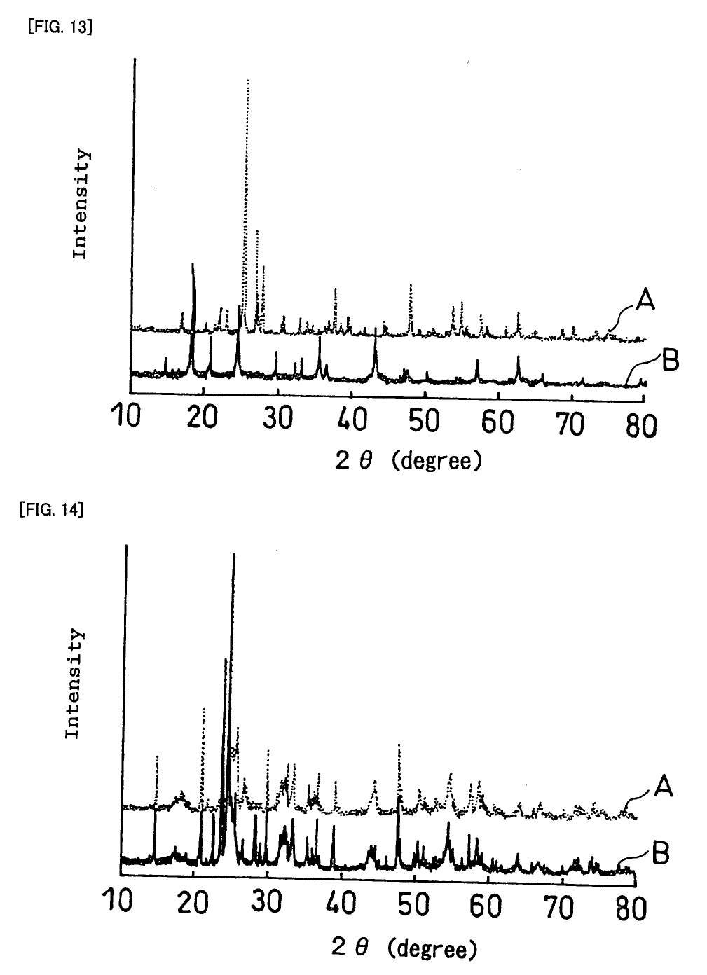

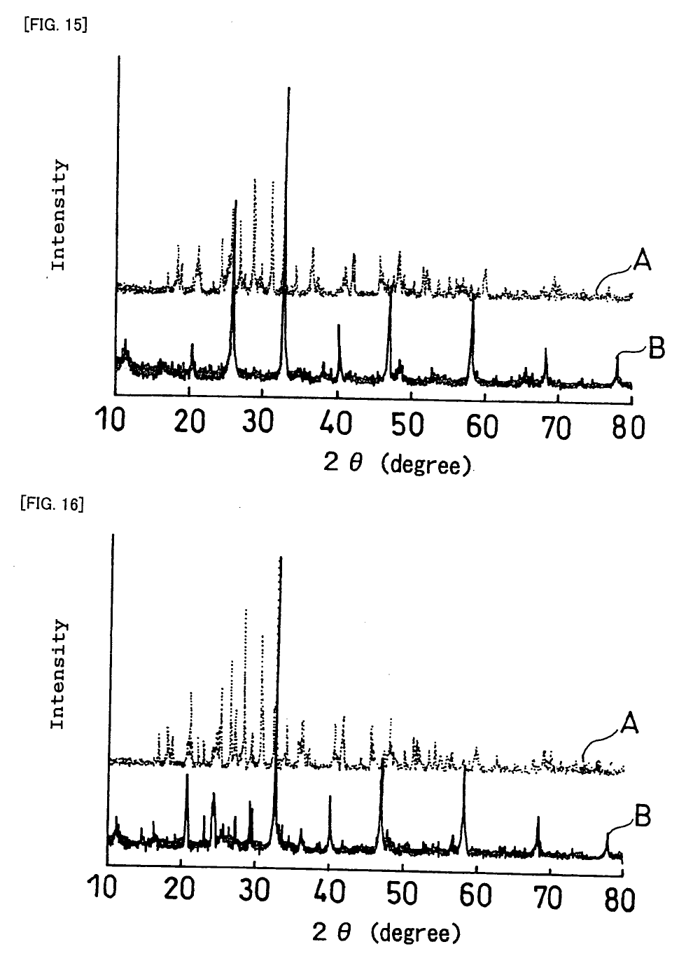

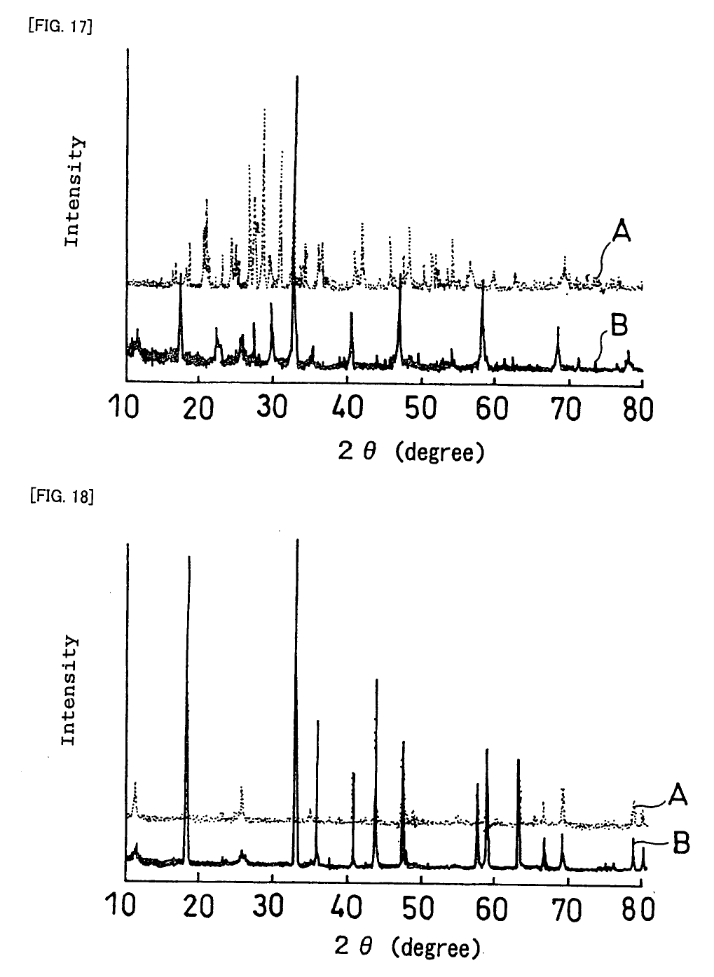

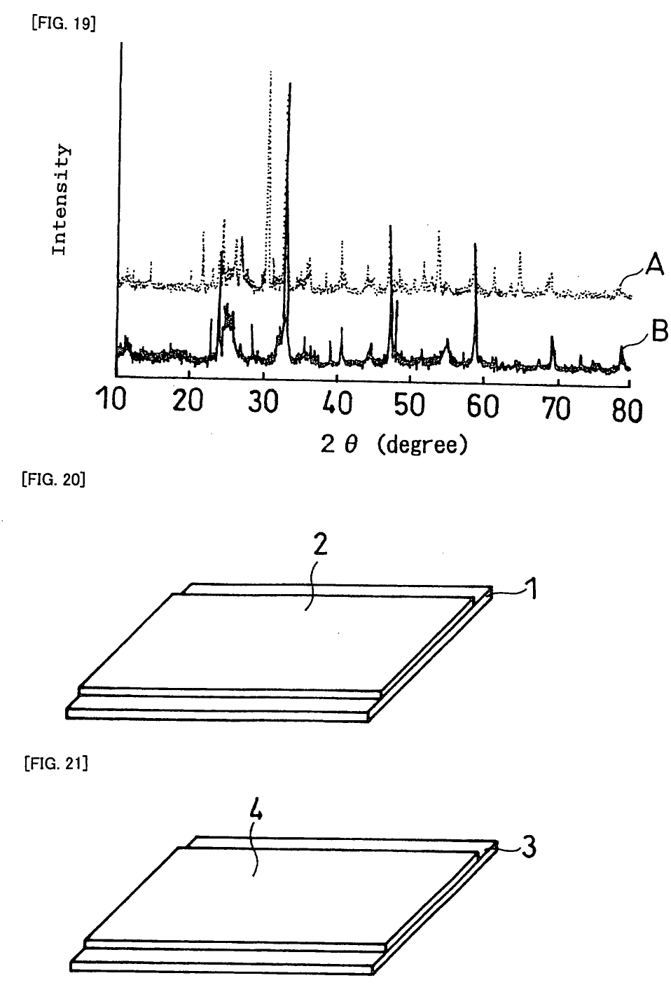

In FIG. 10 (sintered body 4), FIG. 11 (sintered body 5), FIG. 12 (sintered body 6), and FIG. 18 (sintered body 12), the position and pattern of the respective peaks were maintained well before and after the heat treatment. On the other hand, in FIGS. 13 to 17 (comparative sintered bodies 7 to 11) and FIG. 19 (comparative sintered body 13), due to the heat treatment, the peak intensity decreased sharply or new peaks appeared. This clearly indicates that in the sintered bodies 4 to 6 and the sintered body 12, a third phase due to solid phase reaction does not occur at the sintered interface between the negative electrode active material and the solid electrolyte, but that in the comparative sintered bodies 7 to 11 and the comparative sintered body 13, a third phase, which is neither the active material nor the solid electrolyte, appears.

Hence, when such a second phosphoric acid compound (solid electrolyte) and such a third phosphoric acid compound (negative electrode active material) are used and when a titanium-containing oxide such as Li₄Ti₅O₁₂ (negative electrode active material) and a titanium-containing oxide such as Li_{0.33}La_{0.56}TiO₃ (solid electrolyte) are used, the negative electrode active material and the solid electrolyte can be bonded together by sintering to form a laminate, without producing a third phase that is neither the negative electrode active material nor the solid electrolyte at the interface between the negative electrode active material and the solid electrolyte.

Therefore, the results of the sintered bodies 1 to 3 demonstrate that a positive electrode active material layer containing a first phosphorus compound and a solid electrolyte layer containing a second phosphoric acid compound can be bonded together without producing an impurity phase that does not contribute to the charge/discharge of the battery at the interface between the positive electrode active material layer and the solid electrolyte layer. Also, the results of the sintered bodies 4 to 6 and 12 indicate that a solid electrolyte layer containing a second phosphoric acid compound and a negative electrode active material layer containing a third phosphoric acid compound, and a solid electrolyte layer comprising a titanium-containing oxide and a negative electrode active material layer comprising a titanium-containing oxide, can be bonded together without producing an impurity phase that does not contribute to the charge/discharge of the battery at the interface between the negative electrode active material layer and the solid electrolyte layer.

### Example 1-2

The following batteries and comparative batteries were produced, and charged and discharged under predetermined conditions to obtain their discharge capacities.

(Battery 1)

First, a solid electrolyte powder represented by Li_{1.3}Al_{0.3}Ti_{1.7}(PO₄)₃ and a positive electrode active material powder represented by LiCoPO₄ were prepared. The solid electrolyte powder was mixed with polyvinyl butyral resin serving as a binder, n-butyl acetate as a solvent, and dibutyl phthalate as a plasticizer, and the mixture was mixed together with zirconia balls in a ball mill for 24 hours, to prepare a slurry for forming a solid electrolyte layer.

A slurry for forming a positive electrode active material layer was also prepared in the same manner as the solid electrolyte layer slurry.

Subsequently, the solid electrolyte layer slurry was applied onto a carrier film 1 composed mainly of polyester resin by using a doctor blade. The applied slurry was then dried to obtain a solid electrolyte green sheet 2 (thickness: 25 μm) as illustrated in FIG. 20. It should be noted that the surface of the carrier film 1 has a release agent layer composed mainly of Si.

Also, in the same manner as the preparation of the solid electrolyte green sheet, a positive electrode active material green sheet 4 (thickness: 4 μm) was formed on a carrier film 3 as illustrated in FIG. 21.

Next, a polyester film 6 with adhesive applied to both sides thereof was affixed to a support 5. Then, as illustrated in FIG. 22, the face of the solid electrolyte green sheet 2 not in contact with the carrier film 1 was placed on the polyester film 6.

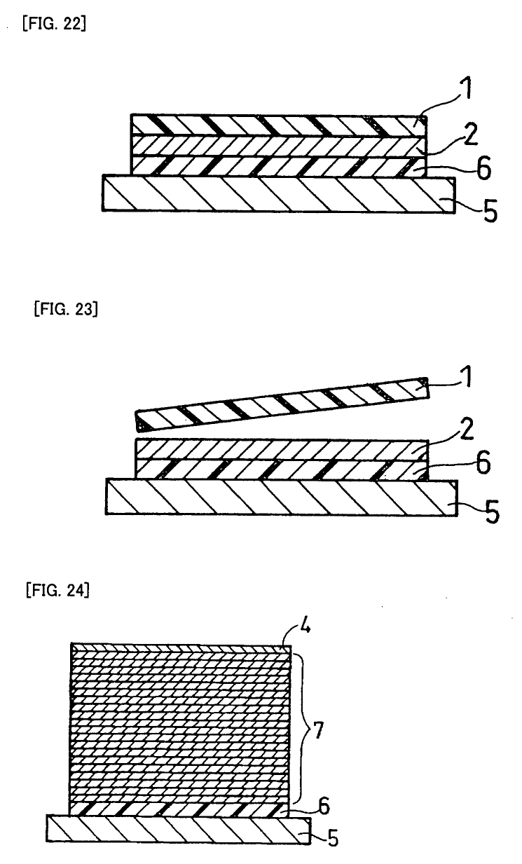

Thereafter, while applying a pressure of 80 kg/cm² and a heat of 70° C. to the carrier film 1 from above, the carrier film was removed from the carrier film 1 and the solid electrolyte green sheet 2, as illustrated in FIG. 23.

A solid electrolyte green sheet 2′, which was prepared on another carrier film 1′ in the same manner as the above, was placed on the solid electrolyte green sheet 2. Subsequently, by applying pressure and heat to the carrier film 1′ from above, the green sheets 2 and 2′ were bonded together and the carrier film 1′ was removed from the green sheet 2′.

By repeating this operation 20 times, a solid electrolyte green sheet group 7 (thickness: 500 μm) was fabricated.

Next, the positive electrode active material green sheet 4 formed on the carrier film 3 in the above manner was placed on the green sheet group 7 thus obtained. Subsequently, by applying a pressure of 80 kg/cm² and a heat of 70° C. to the carrier film 3 from above, the carrier film 3 was removed from the green sheet 4. In this way, as illustrated in FIG. 24, a laminate of the green sheet group 7 and the positive electrode active material green sheet 4 (thickness: approximately 500 μm) was produced. This laminate was removed from the polyester film 6 and cut to a size of 7 mm (width)×7 mm (length)×approximately 500 μm (thickness) to obtain a green chip 8.

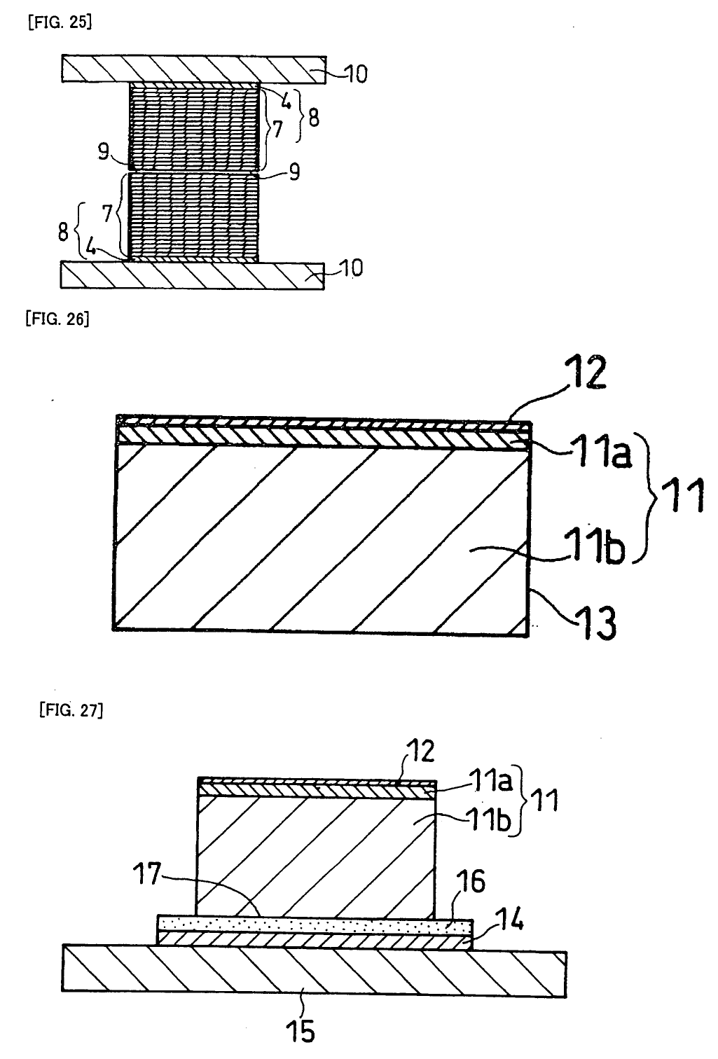

Next, as illustrated in FIG. 25, two green chips 8 thus obtained were combined together. At this time, solid electrolyte faces 9 of the green chips 8, which were positioned on the opposite side of the positive electrode active material green sheets 4, were in contact with each other, so that the active material green sheets 4 were positioned outward.

Next, two alumina ceramics plates 10 were prepared by baking them in a Li atmosphere to cause them to absorb Li sufficiently. The pair of green chips was sandwiched between the ceramics plates 10 such that they came into contact with the active material green sheets 4.

During sintering, Li may volatilize from the green chips since Li is volatile. By using such ceramics plates that have sufficiently absorbed Li, the volatilization of Li from the green chips is suppressed during sintering and the formation of an impurity layer is suppressed.

Subsequently, they were heated to 400° C. at a heating rate of 400° C./h in the air and maintained at 400° C. for 5 hours, so that the organic matter, such as the binder and the plasticizer, was sufficiently decomposed due to heat. Thereafter, they were heated to 900° C. at a heating rate of 400° C./h and promptly cooled to room temperature at a cooling rate of 400° C./h. In this way, the green chips were sintered.

The packing rate of the sintered green chip can be determined, for example, as follows.

First, the weight of the solid electrolyte contained in the solid electrolyte layer and the weight of the active material contained in the active material layer are obtained. Specifically, for example, the amount of Ti contained per unit area of the solid electrolyte layer green sheet of a predetermined thickness, or the amount of Co contained per unit area of the active material green sheet of a predetermined thickness are determined by ICP analysis. From the amounts of Ti and Co obtained, the weight of Li_{1.3}Al_{0.3}Ti_{1.7}(PO₄)₃ per unit area of the solid electrolyte green sheet and the weight of LiCoPO₄ of the active material green sheet can be determined.

Next, the volumes of the solid electrolyte layer and the active material layer of the sintered chip are obtained. Since the sintered chip is prismatic, for example, as in FIG. 24, the volume of each layer can be determined from the area of the bottom thereof and the thickness of each layer. The thickness of each layer can be obtained by measuring, for example, a plurality of cross-sections of the chip, for example, predetermined five cross-sections, with a scanning electron microscope (SEM) or the like, and obtaining an average value as the thickness of each layer.

From the weight of the active material contained in the active material layer and the volume of the active material layer thus obtained, the apparent density of the active material layer ((the weight of the active material contained in the active material layer)/(the volume of the sintered active material layer)) can be obtained. This also applies to the solid electrolyte layer.

As described above, in the case of the active material layer, the packing rate is the ratio of the apparent density of the active material layer to the true density of the active material which is expressed as a percentage. Thus, when the X-ray density of the active material is used as the true density of the active material, the packing rate can be obtained from the following formula:
{[(the weight of the active material contained in the active material layer)/(the volume of the sintered active material layer)]/(the X-ray density of the active material)}×100

Also, the packing rate of the solid electrolyte layer can be obtained in the same manner as the above.

Further, the following method may also be employed. An active material layer and a solid electrolyte layer are separately prepared by sintering an active material layer containing a predetermined amount of an active material and a solid electrolyte layer containing a predetermined amount of a solid electrolyte under the same sintering conditions as those in the production of a laminate. The packing rate of each layer thus obtained is determined from the above-mentioned formula, and the value obtained is used as the packing rate of each layer of the laminate.

In this example, since the active material layer is sufficiently thin compared with the solid electrolyte layer, its packing rate was determined on the assumption that the sintered chip was composed only of Li_{1.3}Al_{0.3}Ti_{1.7}(PO₄)₃. As a result, the packing rate was approximately 83%. The packing rate of the chip was determined as follows:
[{(chip weight)/(chip volume)}/(X-ray density of solid electrolyte)]×100

The packing rate of the active material layer can be assumed to be almost 100% from, for example, an SEM image.

Further, a polished cross-section of the sintered green chip was observed with an SEM to examine the positive electrode active material layer. The observation confirmed that the positive electrode active material layer had a thickness of approximately 1 μm and that the positive electrode active material layer was densely sintered with almost no pores.

It should be noted that although the pair of green chips was sintered, the two green chips were not bonded together by the sintering.

Next, the pair of green chips was divided in two. As illustrated in FIG. 26, a first laminate 11 is composed of a positive electrode active material layer 11a and a solid electrolyte layer 11b, and gold was sputtered onto the surface of the active material layer 11a to form a gold thin film 12 (thickness: several nm to several tens of nm) serving as a positive electrode current collector. The gold adhering to each side face 13 of the first laminate 11 was polished and removed with sandpaper.

Thereafter, a reduction-resistant electrolyte layer and a negative electrode active material layer were formed on the first laminate in a dry air with a dew point of −50° C. or less as follows.

First, a lithium metal foil 14 with a thickness of 150 μm was punched to a diameter of 10 mm and affixed to a central part of an SUS plate 15, which had been punched to a thickness of 0.5 mm and a diameter of 20 mm. The SUS plate serves as a negative electrode current collector.

Polyethylene oxide with a mean molecular weight of 1,000,000 (hereinafter also referred to as PEO) and LiN(SO₂CF₃)₂ (hereinafter also referred to as LiTFSI) were dissolved in dehydrated acetonitrile such that the oxygen atoms of PEO and the lithium of LiTFSI satisfied the relation: [O]/[Li]=20/1. This solution was adjusted so as to have a Li concentration of 0.1 M.

This solution was then spin-coated to the lithium metal at 2000 rpm and vacuum-dried, to form a PEO-LiTFSI layer 16 on the lithium metal foil 14. After the vacuum drying, the thickness of the PEO-LITFSI layer was checked with an SEM and it was approximately 50 μm.

This PEO-LiTFSI layer 16 was bonded to a solid electrolyte face 17 of the first laminate 11, which was on the opposite side of the positive electrode active material layer. In this way, an all solid lithium secondary battery as illustrated in FIG. 27 was produced. This battery was designated as a battery 1.

(Battery 2)

A battery 2 was produced in the same manner as the battery 1 except for the use of LiMnPO₄ in place of LiCoPO₄.

(Comparative Battery 1)

A comparative battery 1 was produced in the same manner as the battery 1 except for the use of LiCoO₂ in place of LiCoPO₄.

(Comparative Battery 2)

A comparative battery 2 was produced in the same manner as the battery 1 except for the use of LiMn₂O₄ in place of LiCoPO₄.

(Battery 3)

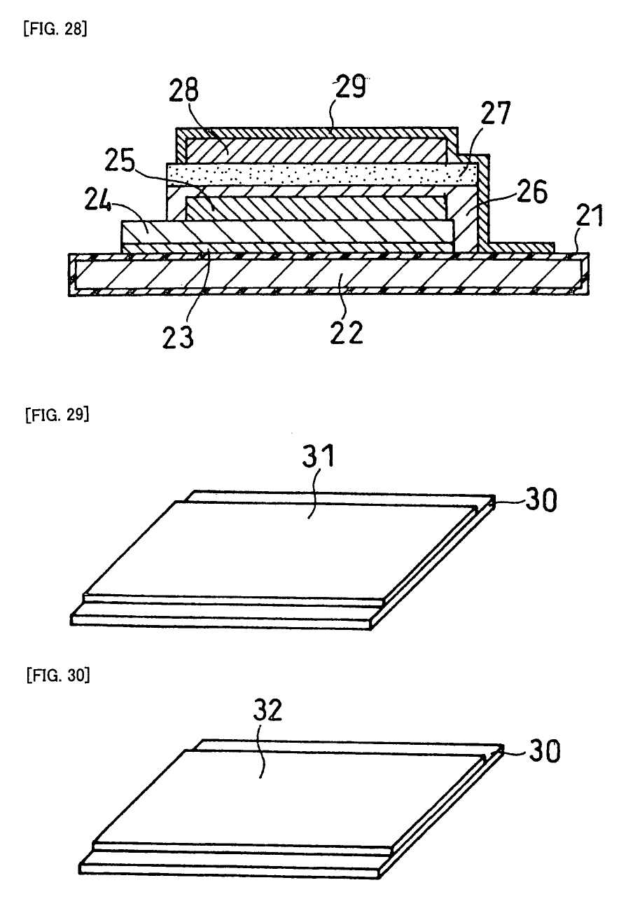

Referring to FIG. 28, an all solid lithium secondary battery produced by using sputtering is described.

A 0.05-μm-thick titanium thin film 23 was formed by RF magnetron sputtering on a monocrystalline silicon substrate 22 of 30 mm×30 mm, whose surface was covered with a silicon nitride layer 21. Further, a 0.5-μm-thick gold thin film 24 serving as a positive electrode current collector was formed on the titanium thin film 23. At this time, a metal mask with an opening of 20 mm×12 mm was used. The titanium thin film 23 has the function of bonding the silicon nitride layer 21 and the gold thin film 24 together.

Subsequently, a 0.5-μm-thick LiCoPO₄ thin film 25 was formed on the gold thin film 24 by RF magnetron sputtering using a LiCoPO₄ target. At this time, a metal mask with an opening of 10 mm×10 mm was used. Also, a sputtering gas composed of 25% oxygen and 75% argon was used.

Then, a metal mask with an opening of 15 mm×15 mm was arranged such that the LiCoPO₄ thin film 25 was positioned in the center of the opening. A 2-μm-thick LiTi₂(PO₄)₃ thin film 26 was formed so as to cover the LiCoPO₄ thin film 25 by RF magnetron sputtering using a LiTi₂(PO₄)₃ target. A sputtering gas composed of 25% oxygen and 75% argon was used.

The resulting laminate was annealed at 600° C. in the air for 2 hours to crystallize the LiCoPO₄ positive electrode active material and the LiTi₂(PO₄)₃ solid electrolyte. In this way, a first laminate was formed.

Thereafter, a reduction-resistant electrolyte layer and a lithium metal layer serving as a negative electrode were formed on the LiTi₂(PO₄)₃ thin film 26 serving as the solid electrolyte layer. They were formed in a dry air with a dew point of −50° C. or less.

Specifically, first, PEO (mean molecular weight 1,000,000) and LiTFSI were dissolved in dehydrated acetonitrile such that the oxygen atoms of PEO and the lithium of LiTFSI satisfied the relation: [O]/[Li]=20/1. This solution had a Li concentration of 0.05 M.

Then, this solution was spin-coated to the LiTi₂(PO₄)₃ thin film 26 at 2000 rpm and vacuum-dried to form a PEO-LITFSI layer 27 serving as the reduction-resistant electrolyte layer. After the vacuum drying, the thickness of the PEO-LiTFSI layer was measured with an SEM, and it was approximately 5 μm.

Subsequently, a 0.5-μm-thick lithium metal thin film 28 serving as the negative electrode was formed on the PEO-LiTFSI layer 27 by resistance heating deposition. At this time, a metal mask with an opening of 10 mm×10 mm was used.

Thereafter, a 0.5-μm-thick copper thin film 29 serving as a negative electrode current collector was formed by RF magnetron sputtering so as to completely cover the lithium metal thin film 28 while being not in contact with the gold thin film 24 serving as the positive electrode current collector. In this way, an all solid lithium secondary battery as illustrated in FIG. 28 was obtained. At this time, a metal mask with an opening of 20 mm×12 mm was used.

The all solid lithium secondary battery thus obtained was designated as a battery 3. The packing rate of each of the positive electrode layer and the solid electrolyte layer was approximately 100%.

(Battery 4)

A battery 4 was produced in the same manner as the battery 3 except for the use of LiMnPO₄ in place of LiCoPO₄.

(Comparative Battery 3)

A comparative battery 3 was produced in the same manner as the battery 3 except for the use of LiCoO₂ in place of LiCoPO₄.

(Comparative Battery 4)

A comparative battery 4 was produced in the same manner as the battery 3 except for the use of LiMn₂O₄ in place of LiCoPO₄.

Immediately after the production of the batteries 1 to 4 and the comparative batteries 1 to 4, they were charged and discharged once at a current value of 10 μA in an atmosphere at a dew point of −50° C. and an ambient temperature of 60° C. The discharge capacities obtained are shown as initial discharge capacities. Also, the upper cut-off voltages and the lower cut-off voltages are shown in Table 1.

TABLE 1

| | Initial | | |
|---|---|---|---|
| | discharge | | |
| | capacity | Upper cut-off | Lower cut-off |
| | (μAh) | voltage (V) | voltage (V) |
| Battery 1 | 10.3 | 5 | 3.5 |
| Battery 2 | 19.3 | 4.6 | 3.3 |
| Comp. battery 1 | 0 | 4.2 | 3.0 |
| Comp. battery 2 | 0 | 4.5 | 3.5 |
| Battery 3 | 13.7 | 5 | 3.5 |
| Battery 4 | 11.9 | 4.6 | 3.3 |
| Comp. battery 3 | 0 | 4.2 | 3.0 |
| Comp. battery 4 | 0 | 4.5 | 3.5 |

As shown in Table 1, the comparative batteries 1 to 4 could not discharge. This is probably because an impurity phase that was neither the active material nor the solid electrolyte was formed due to heat treatment at the interface between the positive electrode active material and the solid electrolyte and the interface became electrochemically inactive.

On the other hand, the batteries 1 to 4 were able to charge and discharge. This is probably because in the present invention, an impurity phase that does not contribute to the charge/discharge reaction is not formed at the interface between the positive electrode active material, which comprises a crystalline first phosphoric acid compound capable of absorbing and desorbing lithium ions, and the solid electrolyte, which comprises a crystalline second phosphoric acid compound with lithium ion conductivity, and the interface is electrochemically active.

As described above, it has been demonstrated that according to the present invention, since no impurity phase is formed at the interface between the positive electrode active material and the solid electrolyte, the interface is electrochemically active and charge/discharge is possible.

Next, the batteries 1 to 4 were subjected to repeated charge/discharge cycles at a current value of 10 μA in the range of 3.5 to 5.0 V in an atmosphere at a dew point of −50° C. and an ambient temperature of 60° C., in order to obtain the number of charge/discharge cycles at which the discharge capacity became 60% of the initial discharge capacity. Table 2 shows the results.

TABLE 2

| | Number of charge/discharge cycles at |
|---|---|
| | which discharge capacity becomes 60% of |
| | initial discharge capacity (cycles) |
| Battery 1 | 103 |
| Battery 2 | 97 |
| Battery 3 | 182 |
| Battery 4 | 179 |

The batteries 1 and 2 were capable of about 100 charge/discharge cycles, and the batteries 3 and 4 were capable of about 180 charge/discharge cycles.

Also, a conventional liquid-type battery was produced by using a positive electrode composed of 70 parts by weight of LiCoPO₄, 25 parts by weight of acetylene black, and 5 parts by weight of polytetrafluoroethylene, a negative electrode made of lithium metal, an electrolyte prepared by dissolving LiPF₄ at a concentration of 1M in a solvent mixture of ethylene carbonate (EC) and dimethyl carbonate (DMC) (EC:DMC=1:1 (volume ratio)). Its cycle life was measured in the same manner as the above, and it was about 10 cycles.

As described above, a comparison of the cycle life of the batteries of the present invention with the cycle life of the conventional liquid-type battery clearly indicates that the cycle life of the batteries of the present invention is significantly improved.

### Example 1-3

Next, the packing rate of the laminate was examined.

(Battery 5)

A battery 1 was produced in the same manner as the battery 1, except that sintering was performed by heating to 850° C. at a heating rate of 400° C./h.

(Reference Battery 6)

A reference battery 6 was produced in the same manner as the battery 1, except that sintering was performed by heating to 800° C. at a heating rate of 400° C./h.

The battery 1, the battery 5, and the reference battery 6 were examined for their impedance at 1 kHz.

Table 3 shows the packing rates of the laminates used in the battery 1, the battery 5, and the reference battery 6 and the impedances of these batteries. With respect to the packing rates, the packing rates as shown in Table 3 are obtained on the assumption that the laminate is composed only of Li_{1.3}Al_{0.3}Ti(PO₄)₃ in the same manner as in Example 1-2.

TABLE 3

| | Packing rate | |
|---|---|---|
| | (%) | Impedance (Ω) |
| Battery 1 | 83 | 3010 |
| Battery 5 | 72 | 3520 |
| Ref. battery 6 | 55 | 144000 |

As shown in Table 3, when the packing rate of the laminate was less than 70%, the impedance increased sharply. This is probably because insufficient sintering of the positive electrode active material powder and the solid electrolyte powder results in a reduction in the size of lithium-ion conductive paths.

Also, the battery with a large impedance is not preferable since it suffers from deterioration of high-rate charge/discharge performance.

The above results show that the packing rate of each of the positive electrode active material layer and the solid electrolyte layer, which form the laminate, and the negative electrode active material layer is preferably more than 70%.

### Example 1-4

A battery including a positive electrode active material layer, a solid electrolyte layer, and a negative electrode active material layer that were integrated together was produced.

(Battery 7)

First, a solid electrolyte powder represented by Li_{1.3}Al_{0.3}Ti_{1.7}(PO₄)₃, a positive electrode active material powder represented by LiCoPO₄, and a negative electrode active material powder represented by Li₃Fe₂(PO₄)₃ were prepared.

A slurry for forming a solid electrolyte layer was prepared by mixing the solid electrolyte powder with polyvinyl butyral resin serving as a binder, n-butyl acetate as a solvent, and dibutyl phthalate as a plasticizer, and mixing them together with zirconia balls in a ball mill for 24 hours.

A slurry for forming a positive electrode active material layer and a slurry for forming a negative electrode active material layer were also prepared in the same manner as the solid electrolyte layer slurry.

Subsequently, the solid electrolyte layer slurry was applied onto a carrier film 30 composed mainly of polyester resin with a doctor blade. The applied slurry was then dried to form a solid electrolyte green sheet 31 (thickness: 25 μm) as illustrated in FIG. 29. The surface of the carrier film 30 has a release agent layer composed mainly of Si.

As illustrated in FIG. 30, a positive electrode active material green sheet 32 (thickness: 4 μm) was formed on another carrier film 30 in the same manner as the solid electrolyte green sheet. Likewise, as illustrated in FIG. 31, a negative electrode active material green sheet 33 (thickness: 7 μm) was formed on another carrier film 30.

Next, a polyester film 35 with adhesive applied to both sides thereof was affixed to a support 34. Then, as illustrated in FIG. 32, the face of the negative electrode active material green sheet 33 not in contact with the carrier film 30 was placed on the polyester film 35.

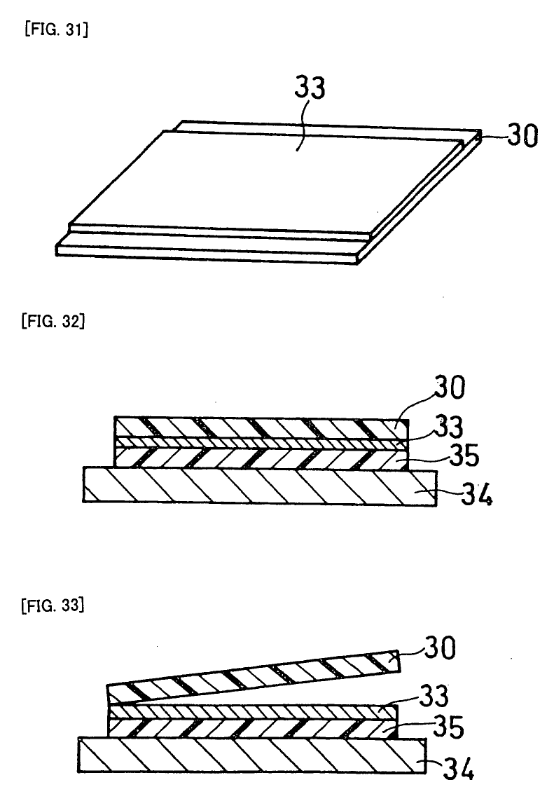

Subsequently, while applying a pressure of 80 kg/cm² and a heat of 70° C. to the carrier film 30 from above, the carrier film 30 was removed from the negative electrode active material green sheet 33 as illustrated in FIG. 33.

Then, the face of the solid electrolyte green sheet 31 not in contact with the carrier film was placed on the negative electrode active material green sheet 33. Under the same pressure and temperature conditions as those described above, the solid electrolyte green sheet was bonded to the negative electrode active material green sheet and the carrier film was removed from the solid electrolyte green sheet.

A solid electrolyte green sheet 31′, which was formed on another carrier film 30′ in the same manner as the above, was placed on the solid electrolyte green sheet 31. Subsequently, by applying pressure and heat to the carrier film 30′ from above, the green sheets 31 and 31′ were bonded together and the carrier film 30′ was removed from the green sheet 31′.

By repeating this operation 20 times, a solid electrolyte green sheet group 36 (thickness: 500 μm) was fabricated.

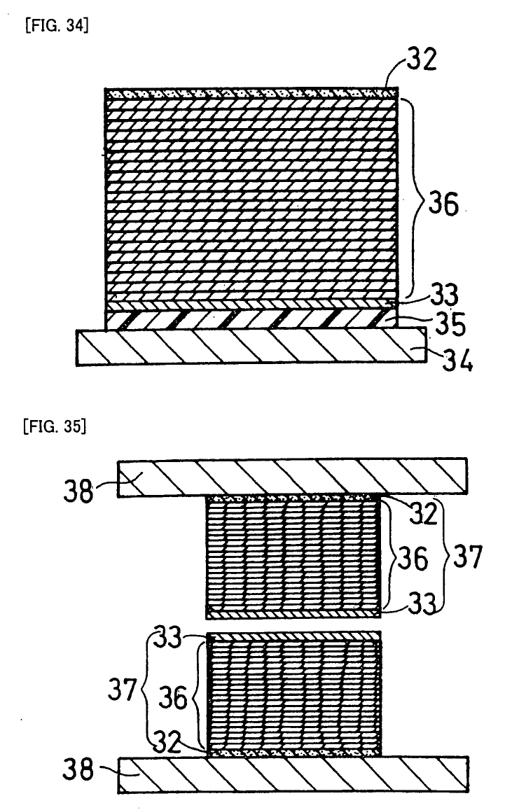

Next, the positive electrode active material green sheet 32 that was formed on the carrier film 30 in the above manner was placed on the solid electrolyte green sheet group 36 thus obtained. Subsequently, by applying a pressure of 80 kg/cm² and a heat of 70° C. to the carrier film 30 from above, the carrier film 30 was removed from the positive electrode active material green sheet 32. In this way, as illustrated in FIG. 34, a laminate of the negative electrode active material green sheet 33, the solid electrolyte green sheet group 36, and the positive electrode active material green sheet 32 (thickness: approximately 500 μm) was produced. This laminate was removed from the polyester film 35 and cut to a size of 7 mm (width)×7 mm (length)×approximately 500 μm (thickness) to obtain a green chip (first green sheet group) 37.

Next, as illustrated in FIG. 35, two green chips 37 thus obtained were combined together such that the negative electrode active material green sheets 33 of the green chips 37 were in contact with each other and the positive electrode active material green sheets 32 were positioned outward.

Next, two alumina ceramics plates 38 were prepared by baking them in a Li atmosphere to cause them to absorb Li sufficiently. The pair of green chips was sandwiched between the ceramics plates such that they came into contact with the positive electrode active material green sheets 32.

Subsequently, they were heated to 400° C. at a heating rate of 400° C./h in the air and maintained at 400° C. for 5 hours, so that the organic matter, such as the binder and the plasticizer, was sufficiently decomposed due to heat. Thereafter, they were heated to 90° C. at a heating rate of 400° C./h and promptly cooled to room temperature at a cooling rate of 400° C./h. In this way, the green chips were sintered.

The packing rate of the sintered green chips was obtained in the same manner as in Example 1-2. As a result, the packing rate of the sintered green chips was approximately 83%.

Also, a polished cross-section of the sintered green chip was observed with an SEM to examine the positive electrode active material layer and the negative electrode active material layer. The observation confirmed that the positive electrode active material layer had a thickness of approximately 1 μm, that the negative electrode active material layer had a thickness of approximately 2 μm, and that the positive electrode active material layer and the negative electrode active material layer were densely sintered with almost no pores.

It should be noted that although the pair of green chips was sintered, the two green chips were not bonded together by the sintering.

Next, the pair of green chips was divided into two, to obtain a second laminate 39 including a combination composed of a positive electrode active material layer 39a, a solid electrolyte layer 39b, and a negative electrode active material layer 39c, as illustrated in FIG. 36. Gold was sputtered onto the surface of the positive electrode active material layer 39a of the second laminate to form a gold thin film 40 (thickness: several nm to several tens of nm) serving as a positive electrode current collector. Likewise, a gold thin film 41 (thickness: several nm to several tens of nm) serving as a negative electrode current collector was formed on the surface of the negative electrode active material layer 39c of the laminate 39. Thereafter, the gold adhering to each side face 42 of the prismatic laminate 39 was polished and removed with sandpaper. In this way, an all solid lithium secondary battery was produced. This battery was designated as a battery 7.

(Battery 8)

A battery 8 was produced in the same manner as the battery 7, except for the use of LiMnPO₄ as the positive electrode active material in place of LiCoPO₄. The packing rate of the sintered green chip was 80% on the assumption that the green chip was composed only of Li_{1.3}Al_{0.3}Ti_{1.7}(PO₄)₃.

(Battery 9)

A battery 9 was produced in the same manner as the battery 7, except for the use of FePO₄ as the negative electrode active material in place of Li₃Fe₂(PO₄)₃. The packing rate of the sintered green chip was 85% on the assumption that the green chip was composed only of Li_{1.3}Al_{0.3}Ti_{1.7}(PO₄)₃.

(Battery 10)

A battery 10 was produced in the same manner as the battery 7, except for the use of LiFeP₂O₇ as the negative electrode active material in place of Li₃Fe₂(PO₄)₃. The packing rate of the sintered green chip was 75% on the assumption that the green chip was composed only of Li_{1.3}Al_{0.3}Ti_{1.7}(PO₄)₃.

(Comparative Battery 5)

A comparative battery 5 was produced in the same manner as the battery 7, except for the use of LiCoO₂ as the positive electrode active material in place of LiCoPO₄ and the use of Li₄Ti₅O₁₂ in place of Li₃Fe₂(PO₄)₃. The packing rate of the sintered green chip was 71% on the assumption that the green chip was composed only of Li_{1.3}Al_{0.3}Ti_{1.7}(PO₄)₃.

(Battery 11)

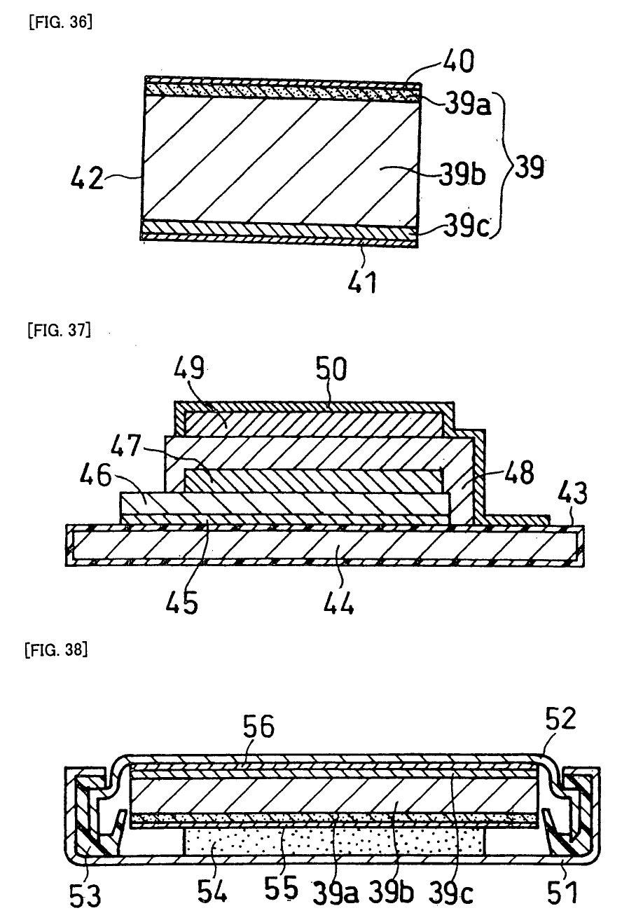

Using sputtering, an all solid lithium secondary battery as illustrated in FIG. 37 was produced as follows.

A 0.05-μm-thick titanium thin film 45 was formed by RF magnetron sputtering on a monocrystalline silicon substrate 44 of 30 mm×30 mm whose surface was covered with a silicon nitride layer 43. Further, a 0.5-μm-thick gold thin film 46 serving as a positive electrode current collector was formed on the titanium thin film 45. At this time, a metal mask with an opening of 20 mm×12 mm was used. The titanium thin film 45 has the function of bonding the silicon nitride layer 43 and the gold thin film 46 together.

Subsequently, a 0.5-μm-thick LiCoPO₄ thin film 47 was formed on the gold thin film 46 by RF magnetron sputtering using a LiCoPO₄ target. At this time, a metal mask with an opening of 10 mm×10 mm was used, and a sputtering gas composed of 25% oxygen and 75% argon was used.

Then, a metal mask with an opening of 15 mm×15 mm was arranged such that the LiCoPO₄ thin film 47 was positioned in the center of the opening. A 2-μm-thick LiTi₂(PO₄)₃ thin film 48 was formed so as to cover the LiCoPO₄ thin film 47 by RF magnetron sputtering using a LiTi₂(PO₄)₃ target. In the sputtering, a sputtering gas composed of 25% oxygen and 75% argon was used.

Subsequently, a 1-μm-thick Li₃Fe₂(PO₄)₃ thin film 49 was formed on the LiTi₂(PO₄)₃ thin film 48 by RF magnetron sputtering using a Li₃Fe₂(PO₄)₃ target. At this time, a metal mask with an opening of 10 mm×10 mm was used, and a sputtering gas composed of 25% oxygen and 75% argon was used.

The resulting laminate (first group) was annealed at 600° C. for 2 hours, so that the LiCoPO₄ positive electrode active material layer, the LiTi₂(PO₄)₃ solid electrolyte layer, and the Li₃Fe₂(PO₄)₃ negative electrode active material layer were integrated and crystallized.

Thereafter, a 0.5-μm-thick copper thin film 50 serving as a negative electrode current collector was formed by RF magnetron sputtering so as to completely cover the Li₃Fe₂(PO₄)₃ thin film 49 while being not in contact with the gold thin film 46 serving as a positive electrode current collector. In this way, an all solid lithium secondary battery as illustrated in FIG. 37 was obtained. At this time, a metal mask with an opening of 20 mm×12 mm was used.

The all solid lithium secondary battery thus obtained was designated as a battery 11. The packing rate of each of the positive electrode active material layer, the solid electrolyte layer, and the negative electrode active material layer was approximately 100%.

(Battery 12)

A battery 12 was produced in the same manner as the battery 11, except for the use of LiMnPO₄ as the positive electrode active material in place of LiCoPO₄.

(Battery 13)

A battery 13 was produced in the same manner as the battery 11, except for the use of FePO₄ as the negative electrode active material in place of Li₃Fe₂(PO₄)₃.

(Battery 14)

A battery 14 was produced in the same manner as the battery 11, except for the use of LiFeP₂O₇ as the negative electrode active material in place of Li₃Fe₂(PO₄)₃.

(Comparative Battery 6)

A comparative battery 6 was produced in the same manner as the battery 11, except for the use of LiCoO₂ as the positive electrode active material in place of LiCoPO₄ and the use of Li₄T is O₁₂ as the negative electrode active material in place of Li₃Fe₂(PO₄)₃.

(Comparative Battery 7)

In producing an all solid lithium secondary battery, the positive electrode active material layer, the solid electrolyte layer, and the negative electrode active material layer of the laminate formed by sputtering were not annealed/crystallized. Except for this, a comparative battery 7 was produced in the same manner as the battery 11.

The batteries 7 to 14 and the comparative batteries 5 to 7 were charged and discharged once at a current value of 10 μA in an atmosphere at a dew point of −50% and an ambient temperature of 25%. The discharge capacities obtained are shown as initial discharge capacities. Also, the upper cut-off voltages and the lower cut-off voltages are shown in Table 4.

TABLE 4

| | Initial | | |
|---|---|---|---|
| | discharge | | |
| | capacity | Upper cut-off | Lower cut-off |
| | (μAh) | voltage (V) | voltage (V) |
| Battery 7 | 10.1 | 2.2 | 1.0 |
| Battery 8 | 19.4 | 2.0 | 0.8 |
| Battery 9 | 8.4 | 2.0 | 0.8 |
| Battery 10 | 10.3 | 2.1 | 1.0 |
| Comp. battery 5 | 0 | 3 | 1.5 |
| Battery 11 | 13.4 | 2.2 | 1.0 |
| Battery 12 | 11.8 | 2.0 | 0.8 |
| Battery 13 | 10.4 | 2.0 | 0.8 |
| Battery 14 | 13.3 | 2.1 | 1.0 |
| Comp. battery 6 | 0 | 3 | 1.5 |
| Comp. battery 7 | 0 | 2.6 | 1.0 |

As shown in Table 4, the comparative batteries 5 to 7 could not discharge. However, the batteries 7 to 14 were able to charge and discharge.

In the comparative batteries 5 to 6, due to the heat treatment, an impurity phase that was neither the active material nor the solid electrolyte was formed at the interface between the positive electrode active material and the solid electrolyte and/or the interface between the negative electrode active material and the solid electrolyte. Probably for this reason, these interfaces became electrochemically inactive. In the comparative battery 7, the positive electrode active material, the negative electrode active material, and the solid electrolyte were not annealed for crystallization. Probably for this reason, the solid electrolyte did not exhibit lithium ion conductivity, and lithium-ion charge/discharge sites were not formed in the positive electrode active material and the negative electrode active material, so that charge/discharge was not possible.

As described above, it has been demonstrated that according to the present invention, the positive electrode active material and the solid electrolyte, and the negative electrode active material and the solid electrolyte are bonded together without producing an impurity phase at the interface thereof, that these interfaces are electrochemically active, and that the battery including the laminate is capable of charge/discharge.

Next, the batteries 7 to 14 were subjected to repeated charge/discharge cycles at a current value of 10 μA at the cut-off voltages as shown in Table 4 in an atmosphere at a dew point of −50° C. and an ambient temperature of 25° C., in order to obtain the number of charge/discharge cycles at which the discharge capacity became 60% of the initial discharge capacity. Table 5 shows the results.

TABLE 5

| | Number of charge/discharge cycles at |
|---|---|
| | which discharge capacity becomes 60% of |
| | initial discharge capacity (cycles) |
| Battery 7 | 297 |
| Battery 8 | 281 |
| Battery 9 | 316 |
| Battery 10 | 293 |
| Battery 11 | 507 |
| Battery 12 | 498 |
| Battery 13 | 521 |
| Battery 14 | 501 |

The batteries 7 to 10 were capable of about 300 charge/discharge cycles, and the batteries 11 to 14 were capable of about 500 charge/discharge cycles.

This clearly indicates that the present invention can provide all solid lithium secondary batteries with excellent cycle life characteristics.

### Example 1-5

Next, the sintering density of the second laminate was examined.

(Battery 15)

A battery 15 was produced in the same manner as the battery 7, except that sintering was performed by heating to 850% at a heating rate of 400° C./h.

(Reference Battery 16)

A reference battery 16 was produced in the same manner as the battery 7, except that sintering was performed by heating to 800° C. at a heating rate of 400° C./h.

The battery 15, the reference battery 16, and the battery 7 were examined for their impedance at 1 kHz.

Table 6 shows the packing rates of the second laminates used in the battery 7, the battery 15, and the reference battery 16 and the impedances of these batteries. With respect to the packing rates, the packing rates as shown in Table 6 are obtained on the assumption that the second laminates are composed only of Li_{1.3}Al_{0.3}Ti(PO₄)₃.

TABLE 6

| | Packing rate | Impedance |
|---|---|---|
| | (%) | (Ω) |
| Battery 7 | 83 | 3010 |
| Battery 15 | 72 | 3520 |
| Ref. battery 16 | 55 | 144000 |

As shown in Table 6, when the packing rate of the second laminate was less than 70%, the impedance increased sharply. This is probably because insufficient sintering of the positive electrode active material powder and the solid electrolyte powder and/or the negative electrode active material powder and the solid electrolyte powder results in a reduction in the size of lithium-ion conductive paths.

Also, the battery with a large impedance is not preferable since it suffers from deterioration of high-rate charge/discharge performance.

Hence, in the second laminate composed of the positive electrode active material layer, the solid electrolyte layer, and the negative electrode active material layer that are integrated together, the packing rate of each layer is preferably more than 70%.

### Example 1-6

Next, the effects of moisture on batteries were examined.

(Battery 17)

A battery 17 was produced in the same manner as the battery 7, except that a current collector made of a silver thin film was formed on each of the surface of the positive electrode active material layer and the surface of the negative electrode active material layer in the laminate by sputtering.

(Battery 18)

As illustrated in FIG. 38, the battery 17 was placed in a metal case 51 to which a nylon gasket 53 was fitted. The opening of the metal case 51 was crimped onto a metal sealing plate 52 with the gasket 53 interposed therebetween, to obtain a button-type sealed battery with a diameter of 9 mm and a height of 2.1 mm. The battery thus obtained was designated as a battery 18. At this time, the battery 17 was placed in the metal case such that the metal case 51 served as a positive electrode terminal and the metal sealing plate 52 served as a negative electrode terminal. Also, a nickel spongy metal strip 54 was inserted between the metal case 51 and the battery 17, so that the battery 17, the metal case, and the metal sealing plate were in close contact with one another.

In FIG. 38, the battery 17 includes a silver thin film 55, a positive electrode active material layer 39a, a solid electrolyte layer 39b, a negative electrode active material layer 39c, and a silver thin film 56.

(Battery 19)

A 0.5-mm-diameter copper lead 57 was connected to each of the silver thin film on the positive electrode active material layer side of the battery 17 and the silver thin film on the negative electrode active material side with solder 58, so that a positive electrode terminal and a negative electrode terminal were provided. As illustrated in FIG. 39, an epoxy resin 59 was applied for resin molding so as to seal the battery 17 including the silver thin film, the positive electrode active material layer, the solid electrolyte layer, the negative electrode active material layer, and the silver thin film. This battery was designated as a battery 19.

(Battery 20)

A battery 20 was produced in the same manner as the battery 19, except that the battery 17 with the copper leads as the positive electrode terminal and the negative electrode terminal was immersed in a dispersion of a fluorocarbon resin water-repellent material in n-heptane in order to make the surface of the battery 17 water-repellent.

The batteries 17 to 20 thus obtained were examined for their discharge capacities before storage and after storage in the following manner.

The batteries 17 to 20 were charged and discharged at a current value of 10 μA in the range of 1.0 to 2.6 V in an atmosphere at a dew point of −50° C. and an ambient temperature of 25° C. to obtain their initial discharge capacities. Thereafter, these batteries were charged to 2.6 V and then stored in an atmosphere at a temperature of 60° C. and a relative humidity of 90% for 30 days. Subsequently, these batteries were discharged at a current value of 10 μA in an atmosphere at a dew point of −50° C. and an ambient temperature of 25C. Table 7 shows the initial discharge capacities of these batteries and the discharge capacities after the 30-day storage.

TABLE 7

| | Initial | Discharge capacity |
|---|---|---|
| | discharge | after 30-day |
| | capacity (μAh) | storage (μAh) |
| Battery 17 | 10.3 | 0 |
| Battery 18 | 10.2 | 10.1 |
| Battery 19 | 10.4 | 4.2 |
| Battery 20 | 10.3 | 9.8 |

The initial discharge capacities of the batteries 17 to 20 were approximately 20 μAh and almost equivalent. After the 30-day storage in the highly humid condition, the battery 17 could not discharge, and the battery 19 exhibited a capacity drop. The discharge capacities of the battery 18 and the battery 20 after the storage were equivalent to the initial discharge capacities thereof.

In the case of the battery 17, when it is exposed to a humid atmosphere during storage, a liquid film of water is formed on the battery surface (i.e., laminate surface). Probably due to the formation of the liquid film of water, the current collector Ag was ionized, and the Ag ions migrated to cause a short-circuit, thereby resulting in the inability to discharge after the 30-day storage.

In the case of the battery 19, a capacity drop occurred as described above, although it was not as large as in the battery 17. Since the mere resin molding provides poor gas tightness, humid air enters the resin. Probably for this reason, the current collector Ag was ionized and the Ag ions migrated to cause a micro short-circuit, thereby resulting in the capacity drop.

On the other hand, in the case of the battery 18 and the battery 20, even after they were stored in the humid condition for 30 days, their discharge capacities were maintained. Thus, the result of the battery 18 confirms that the use of a container with good gas tightness permits interception of humid air, and the result of the battery 20 confirms that applying a water repellent material to the battery (laminate) surface prevents the formation of a liquid film on the battery surface.

As described above, when the battery (laminate) is housed in a container with high gas tightness or when the battery (laminate) surface is treated with a water-repellent material, the handling of the battery is improved and the effects of the humidity of the ambient air can be reduced.

### Example 1-7

In this example, an all solid lithium secondary battery having a second laminate that included two or more combinations each comprising a positive electrode active material layer, a solid electrolyte layer, and a negative electrode active material layer was produced.

(Battery 21)

First, a solid electrolyte powder represented by Li_{1.3}Al_{0.3}Ti_{1.7}(PO₄)₃, a positive electrode active material powder represented by LiCo_{0.5}Ni_{0.5}PO₄, and a negative electrode active material powder represented by Li₃Fe₂(PO₄)₃ were prepared.

The solid electrolyte powder was mixed with polyvinyl butyral resin serving as a binder, n-butyl acetate as a solvent, and dibutyl phthalate as a plasticizer, and the mixture was mixed together with zirconia balls in a ball mill for 24 hours, to prepare a slurry for forming a solid electrolyte layer.

A slurry for forming a positive electrode active material layer and a slurry for forming a negative electrode active material layer were also prepared in the same manner as the solid electrolyte layer slurry.

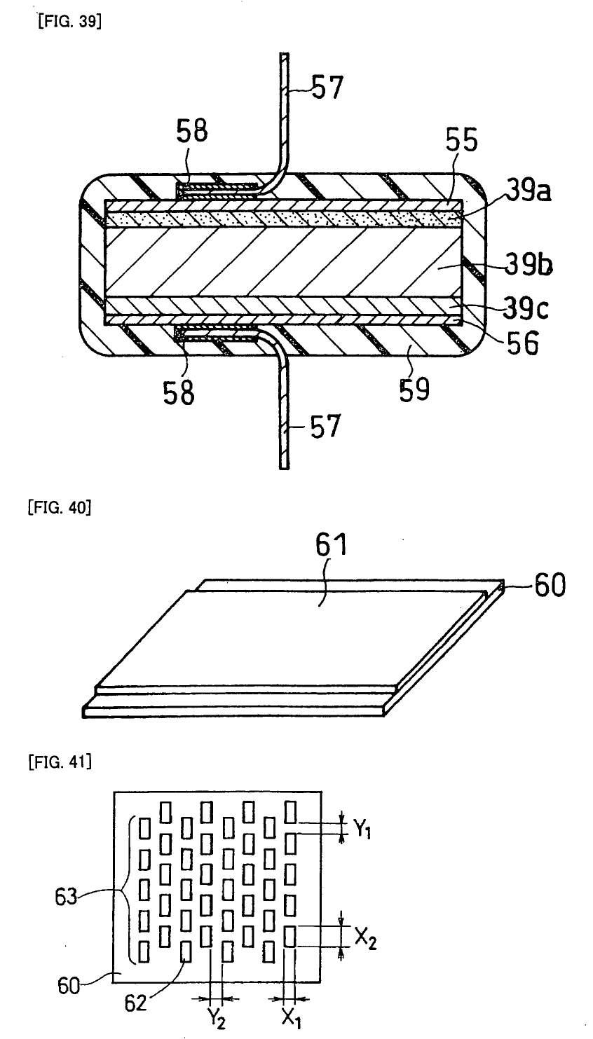

Subsequently, the solid electrolyte layer slurry was applied onto a carrier film 60 composed mainly of polyester resin by using a doctor blade. The applied slurry was then dried to obtain a solid electrolyte green sheet 61 (thickness: 10 μm) as illustrated in FIG. 40. It should be noted that the surface of the carrier film 60 has a release agent layer composed mainly of Si.

The positive electrode active material layer slurry was applied by screen printing on another carrier film 60 in a pattern as illustrated in FIG. 41, in which straight lines 63 of five positive electrode active material green sheets 62 were aligned in a zigzag pattern. The slurry was dried to obtain a plurality of positive electrode green sheets of predetermined pattern. The thickness of the positive electrode active material green sheets was 3 μm. The width X₁ of the positive electrode active material green sheets was 1.5 mm, and the length X₂ of the positive electrode active material green sheets was 6.8 mm. The interval Y₁ between the positive electrode active material green sheets in each line was 0.4 mm, and the interval Y₂ between the lines was 0.3 mm.

Subsequently, a gold paste containing commercially available polyvinyl butyral resin as a binder was prepared. As illustrated in FIG. 42, this gold paste was applied by screen printing onto another carrier film 60 in the same pattern as that in the preparation of the positive electrode active material green sheets. The paste was dried to obtain positive electrode current collector green sheets 64 (thickness: 1 μm).

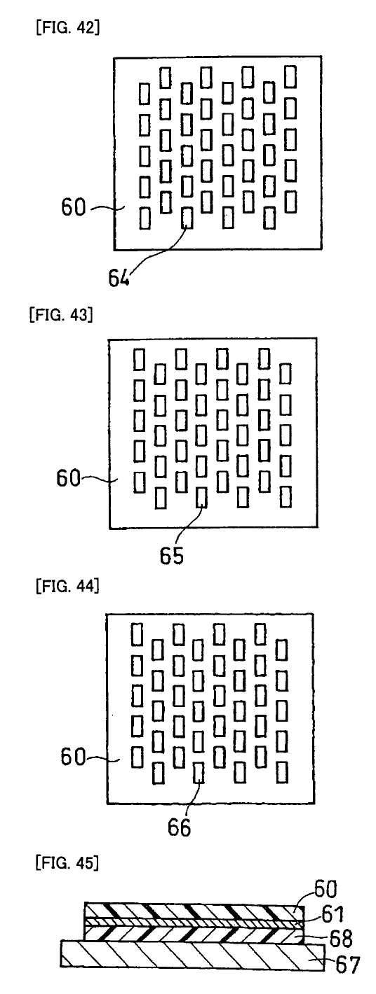

The negative electrode active material layer slurry was applied by screen printing onto another carrier film 60 in a pattern as illustrated in FIG. 43, in which straight lines of five negative electrode active material green sheets 65 were aligned in the opposite zigzag pattern to that of the positive electrode active material green sheets. The thickness of the negative electrode active material green sheets was 5 μm. Also, the width X₁ of the negative electrode active material green sheets, the length X₂ of the negative electrode active material green sheets, the interval Y₁ between the negative electrode active material green sheets in each line, and the interval Y₂ between the lines were the same as those of the positive electrode active material green sheets.

Subsequently, as illustrated in FIG. 44, the above-mentioned gold paste was applied by screen printing onto another carrier film 60 in the same pattern as that in the preparation of the negative electrode active material green sheets. The paste was dried to obtain negative electrode current collector green sheets 66 (thickness: 1 μm).

Next, a polyester film 68 with adhesive applied to both sides thereof was affixed to a support 67. As illustrated in FIG. 45, the face of the solid electrolyte green sheet 61 not in contact with the carrier film 60 was placed on the polyester film 68.

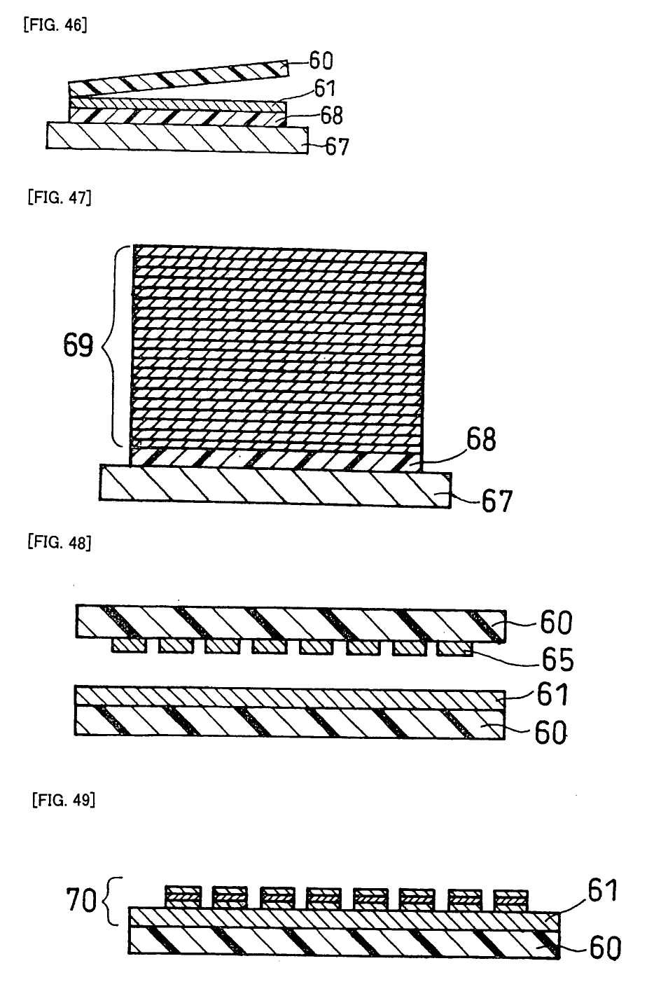

Thereafter, by applying a pressure of 80 kg/cm² and a heat of 70° C. to the carrier film 60 from above, the carrier film 60 was removed from the solid electrolyte green sheet 61, as illustrated in FIG. 46.

Then, a solid electrolyte green sheet 61′, which was formed on another carrier film 60′ in the same manner as the above, was placed on the solid electrolyte green sheet 61. Subsequently, by applying pressure and heat to the carrier film 60′ from above, the green sheets 61 and 61′ were bonded together and the carrier film 60′ was removed from the green sheet 61′.

By repeating this operation 20 times, a solid electrolyte green sheet group 69 (thickness: approximately 200 μm) as illustrated in FIG. 47 was fabricated.

Thereafter, as illustrated in FIG. 48, the plurality of negative electrode active material green sheets 65 formed on the carrier film 60 in the above manner were placed on the solid electrolyte green sheet 61 formed on the carrier sheet 60, in such a manner that the negative electrode active material green sheets 65 were in contact with the solid electrolyte green sheet 61. Then, by applying a pressure of 80 kg/cm² and a heat of 70° C. to the carrier film 60 carrying the plurality of negative electrode active material green sheets from above, the carrier film 60 was removed from the negative electrode active material green sheets 65.

Subsequently, the plurality of negative electrode current collector green sheets 66 carried on the carrier sheet 60 were laminated on the negative electrode active material green sheets, in such a manner that they were aligned with the negative electrode active material green sheets 65. By applying a pressure of 80 kg/cm² and a heat of 70° C. to the carrier film 60 carrying the plurality of negative electrode current collector green sheets 66 from above, the carrier film 60 was removed from the negative electrode current collector green sheets 66. Further, the negative electrode active material green sheets 65 were laminated on the negative electrode current collector green sheets 66 in the same manner, to obtain a laminate as illustrated in FIG. 49. The resulting laminate including: the solid electrolyte green sheet 61; and a plurality of sub-laminates carried thereon, each sub-laminate being composed of two negative electrode active material green sheets and one negative electrode current collector green sheet sandwiched between the two green sheets, was designated as a negative electrode laminate 70.

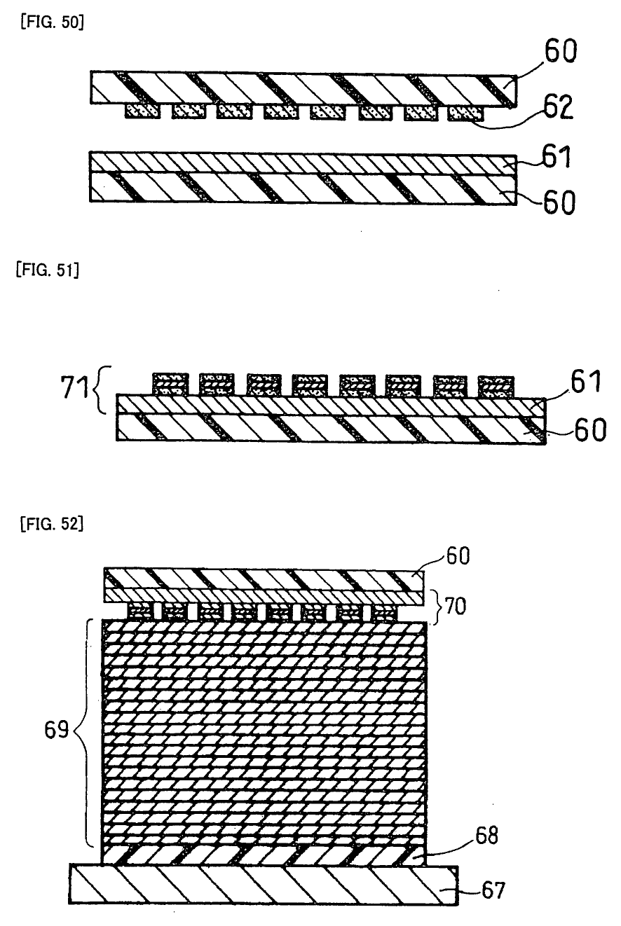

Thereafter, as illustrated in FIG. 50, the plurality of positive electrode active material green sheets 62 formed on the carrier film 60 in the above manner were placed on the solid electrolyte green sheet 61 formed on the carrier sheet 60, in such a manner that the positive electrode active material green sheets 62 were in contact with the solid electrolyte green sheet 61. Then, by applying a pressure of 80 kg/cm² and a heat of 70° C. to the carrier film 60 carrying the plurality of positive electrode active material green sheets from above, the carrier film 60 was removed from the positive electrode active material green sheets 62.

Subsequently, the plurality of positive electrode current collector green sheets 64 carried on the carrier sheet 60 were laminated on the positive electrode active material green sheets 62, in such a manner that they were aligned with the positive electrode active material green sheets. By C2 applying a pressure of 80 kg/cm² and a heat of 70° C. to the carrier film 60 carrying the plurality of positive electrode current collector green sheets 64 from above, the carrier film 60 was removed from the positive electrode current collector green sheets 64. Further, the positive electrode active material green sheets 62 were laminated on the positive electrode current collector green sheets 64 in the same manner, to obtain a laminate as illustrated in FIG. 51. The resulting laminate including: the solid electrolyte green sheet 61; and a plurality of sub-laminates carried thereon, each sub-laminate being composed of two positive electrode active material green sheets and one positive electrode current collector green sheet sandwiched between the two green sheets, was designated as a positive electrode laminate 71.

Next, as illustrated in FIG. 52, the negative electrode laminate 70 was placed on the solid electrolyte green sheet group 69 on the support 67. By applying a pressure of 80 kg/cm² and a heat of 70° C. to the carrier film 60 from above, the carrier film 60 was removed from the negative electrode laminate 70. In this way, the negative electrode laminate 70 was laminated on the solid electrolyte green sheet group 69 such that the negative electrode active material green sheets were in contact therewith.

Likewise, the positive electrode laminate 71 was placed on the negative electrode laminate 70 such that the positive electrode active material green sheets of the positive electrode laminate 71 were in contact with the solid electrolyte green sheet of the negative electrode laminate 70. By applying a pressure of 80 kg/cm² and a heat of 70° C. to the carrier film 60 from above, the carrier film 60 was removed from the positive electrode laminate 71. In this way, the positive electrode laminate 71 was laminated on the negative electrode laminate 70. When the negative electrode laminate and the positive electrode laminate were laminated, the zigzag pattern of the straight lines of the negative electrode active material green sheets was opposite to that of the straight lines of the positive electrode active material green sheets.

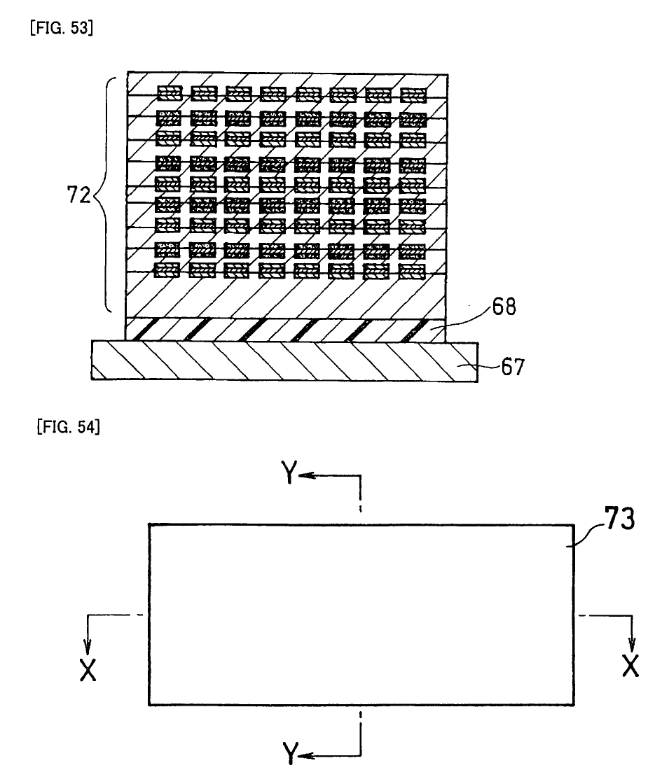

By repeating the above operation, a laminate 72 composed of the solid electrolyte green sheet group, five negative electrode laminates, and four positive electrode laminates was obtained as illustrated in FIG. 53. At the end of the laminate 72 opposite to the solid electrolyte green sheet group in the laminating direction was the negative electrode laminate.

Lastly, 20 solid electrolyte green sheets were laminated on the negative electrode laminate at the end of the laminate 72 opposite to the solid electrolyte green sheet group, to obtain a laminate sheet. This laminate sheet was removed from the support 67 with the polyester film 68.

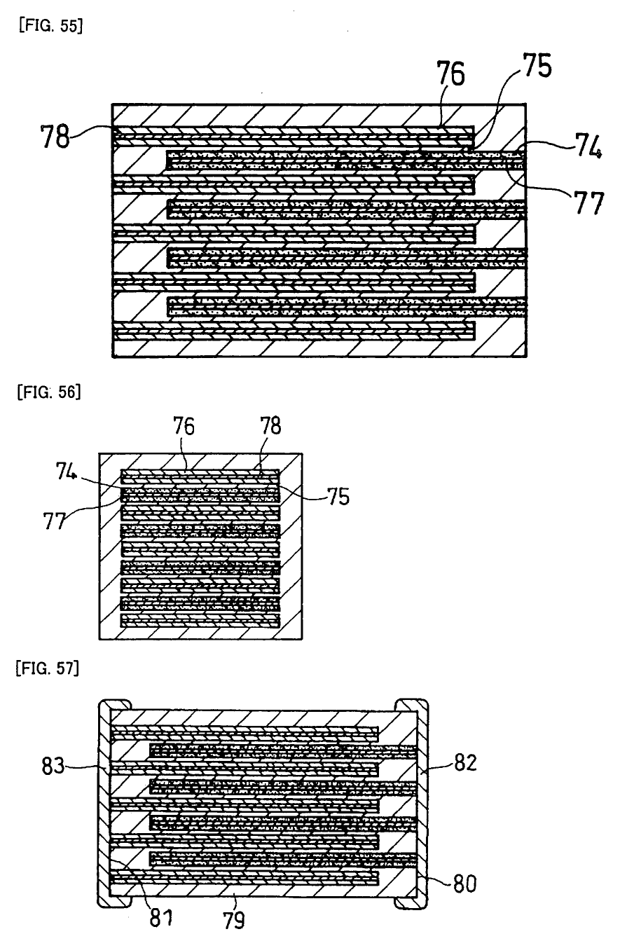

The laminate sheet was cut to obtain a green chip 73. FIGS. 54 to 56 illustrate the green chip. FIG. 54 is a top view of the green chip 73. FIG. 55 is a longitudinal sectional view taken along the line X-X. FIG. 56 is a longitudinal sectional view taken along the line Y-Y.

As shown in FIG. 56, the green chip 73 is structured such that a plurality of combinations, each including a positive electrode active material green sheet 74, a solid electrolyte green sheet 75, and a negative electrode active material green sheet 76, are laminated. By sintering such a green chip, it is possible to obtain a laminate including at least one integrated combination of a positive electrode active material layer, a solid electrolyte layer, and a negative electrode active material layer. The number of integrated combinations can be adjusted by changing the number of the positive electrode laminates, solid electrolyte green sheets, and negative electrode laminates.

Also, the green chip obtained in this example has the shape of a hexahedron, and as shown in FIG. 55, one end of the negative electrode active material green sheets 76 and negative electrode current collector green sheets 78 is exposed at one face of the hexahedron. At the opposite face, one end of the positive electrode active material green sheets 74 and positive electrode current collector green sheets 77 is exposed. That is, by using the above-described production method, the positive electrode current collectors and the negative electrode current collectors can be exposed at different surface regions of the laminate. Also, the positive electrode current collectors and the negative electrode current collectors may be exposed at different surface regions of the laminate by using other methods than the above-mentioned one.

In this example, the other faces than these two are covered with the solid electrolyte layer.

Next, the green chip thus obtained was heated to 400° C. at a heating rate of 400° C./h in the air and maintained at 400° C. for 5 hours, so that the organic matter, such as the binder and the plasticizer, was sufficiently decomposed due to heat. Thereafter, it was heated to 900° C. at a heating rate of 400° C./h and promptly cooled to room temperature at a cooling rate of 400° C./h. In this way, the green chip was sintered to obtain a sintered body (second laminate). The sintered body had a width of approximately 3.2 mm, a depth of approximately 1.6 mm, and a height of approximately 0.45 mm.

The packing rate of the sintered body was determined in the same manner as in Example 1-2 on the assumption that the sintered body was composed only of Li_{1.3}Al_{0.3}Ti_{1.7}(PO₄)₃. As a result, the packing rate of the sintered body was approximately 83%.

Also, a polished cross-section of the sintered body was observed with an SEM. As a result, the positive electrode current collector and the negative electrode current collector had a thickness of approximately 0.3 μm. Also, the positive electrode active material layer on one side of the positive electrode current collector had a thickness of approximately 1 μm, and the negative electrode active material layer on one side of the negative electrode current collector had a thickness of approximately 2 μm. Also, it was confirmed that the sintered body was densely sintered with almost no pores.

An external current collector paste containing copper and glass frit was applied to a face 80 of a sintered body 79 at which the positive electrode current collectors were exposed and a face 81 thereof at which the negative electrode current collectors were exposed. The sintered body with the external current collector paste applied thereto was then heat-treated at 600° C. in a nitrogen atmosphere for 1 hour. As a result, a positive electrode external current collector 82 and a negative electrode external current collector 83 were formed as illustrated in FIG. 57. In this way, an all solid lithium secondary battery was produced. This battery was designated as a battery 21.

(Battery 22)

A battery 22 was produced in the same manner as the battery 21, except for the use of LiMnPO₄ in place of LiCo_{0.5}Ni_{0.5}PO₄.

(Battery 23)

A battery 23 was produced in the same manner as the battery 21, except for the use of FePO₄ in place of Li₃Fe₂(PO₄)₃.

(Battery 24)

A battery 24 was produced in the same manner as the battery 21, except for the use of LiFeP₂O₇ in place of Li₃Fe₂(PO₄)₃.

(Comparative Battery 8)

A comparative battery 8 was produced in the same manner as the battery 21, except for the use of LiCoO₂ in place of LiCo_{0.5}Ni_{0.5}PO₄ and the use of Li₄Ti₅O₁₂ in place of Li₃Fe₂(PO₄)₃.

(Battery 25)

A battery 25 was produced in the same manner as the battery 21, except for the use of Li_{1.3}Al_{0.3}Ti_{1.7}(PO₄)₃ in place of Li₃Fe₂(PO₄)₃.

(Battery 26)

A solid electrolyte powder represented by Li_{1.3}Al_{0.3}Ti_{0.7}(PO₄)₃, a positive electrode active material powder represented by LiCo_{0.5}Ni_{0.5}PO₄, and a negative electrode active material powder represented by Li₃Fe₂(PO₄)₃ were prepared.

The solid electrolyte powder was mixed with polyvinyl butyral resin serving as a binder, n-butyl acetate as a solvent, and dibutyl phthalate as a plasticizer, and the mixture was mixed together with zirconia balls in a ball mill for 24 hours, to prepare a slurry for forming a solid electrolyte layer.

The positive electrode active material powder was mixed with polyvinyl butyral resin, n-butyl acetate, dibutyl phthalate, and further, palladium powder, and the mixture was mixed together with zirconia balls in a ball mill for 24 hours, to prepare a slurry for forming a positive electrode active material layer. In the resulting positive electrode active material layer, the palladium powder functions as a current collector in the form of a three-dimensional network.

Using the above-mentioned negative electrode active material, a slurry for forming a negative electrode active material layer was prepared in the same manner as the positive electrode active material layer slurry.

Using the solid electrolyte layer slurry, a solid electrolyte green sheet (thickness: 10 μm) was formed on a carrier film in the same manner as in the battery 21.

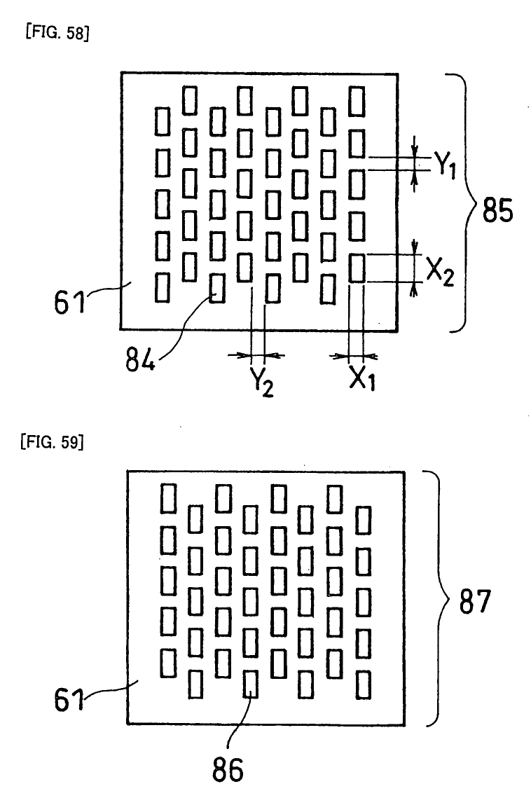

Using the positive electrode active material layer slurry, a plurality of positive electrode active material green sheets 84 containing the current collector were formed on the solid electrolyte green sheet 61 on the carrier film 60 in a pattern as illustrated in FIG. 58, in the same manner as in the battery 21. In this way, a positive electrode sheet 85 including the solid electrolyte green sheet and the positive electrode active material green sheets was prepared. The thickness of each positive electrode active material green sheet was 4 μm.

Using the negative electrode active material layer slurry, a plurality of negative electrode active material green sheets 86 containing the current collector were formed on the solid electrolyte green sheet 61 on the carrier film 60 in a pattern as illustrated in FIG. 59, in the same manner as in the battery 21. In this way, a negative electrode sheet 87 including the solid electrolyte green sheet and the negative electrode active material green sheets was prepared. The thickness of each negative electrode active material green sheet was 7 μm.

The width X₁ of the positive electrode active material green sheets, the length X₂ of the positive electrode active material green sheets, the interval Y₁ between the positive electrode active material green sheets in each line, and the interval Y₂ between the lines were the same as those in the battery 21. This also applies to the negative electrode active material green sheets.

Next, 20 solid electrolyte green sheets were laminated on a support having a polyester film with adhesive applied to both sides thereof in the same manner as in the battery 21, to form a solid electrolyte green sheet group (thickness: approximately 200 μm).

Subsequently, as illustrated in FIG. 60, the sheet 87 was placed on a solid electrolyte green sheet group 69 in the same manner as in the battery 21. By applying a pressure of 80 kg/cm² and a heat of 70° C. to the carrier film 60 from above, the carrier film 60 was removed from the solid electrolyte green sheet 61. In this way, the negative electrode sheet 87 was laminated on the solid electrolyte green sheet group. Likewise, the positive electrode sheet 85 was laminated on the solid electrolyte green sheet of the negative electrode sheet 87 such that the positive electrode active material green sheets of the positive electrode sheet 85 were in contact therewith. Thereafter, the carrier film was removed from the solid electrolyte green sheet in the same manner as the above.

By repeating these operations, a laminate 88 including five negative electrode sheets 87 and four positive electrode sheets 85 was formed as illustrated in FIG. 61. Then, 20 solid electrolyte green sheets were laminated on the negative electrode sheet 87 at the end of the laminate 88 opposite to the solid electrolyte green sheet group, to obtain a laminate sheet.

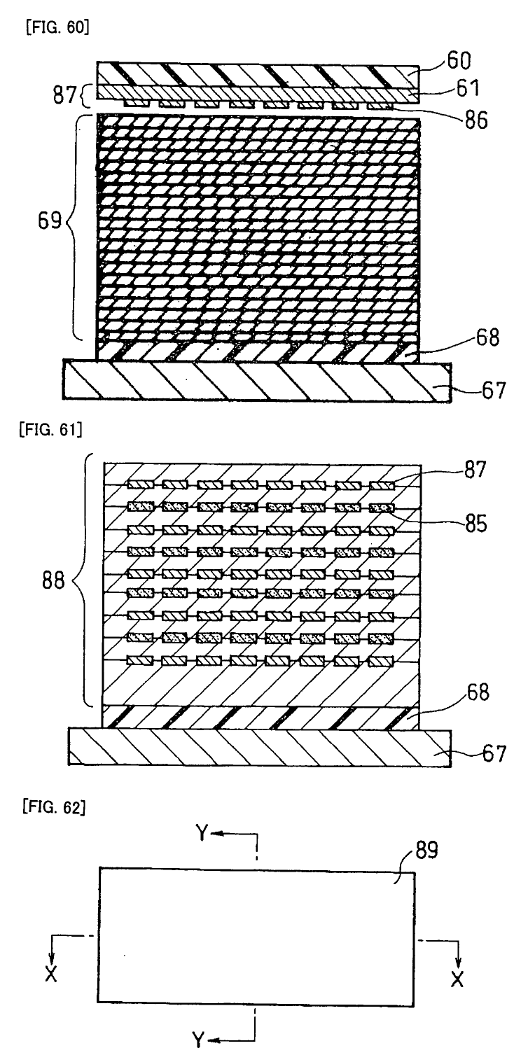

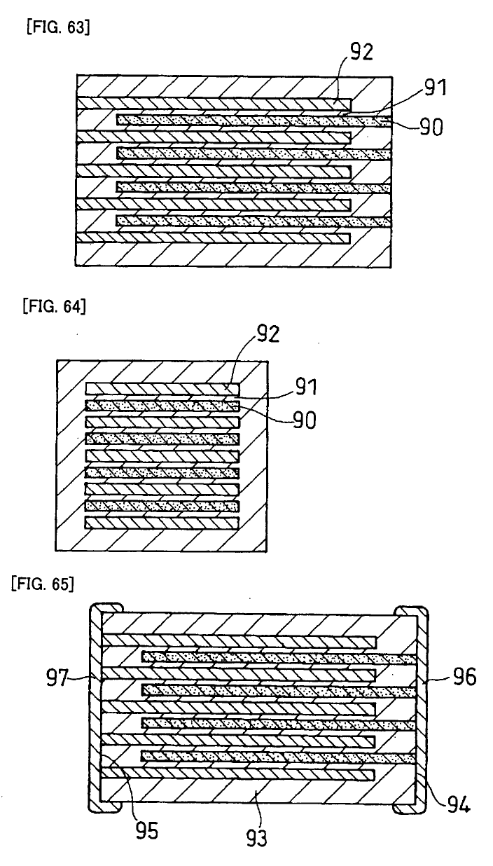

The laminate sheet was cut to obtain a green chip. FIGS. 62 to 64 illustrate the green chip. FIG. 62 is a top view of a green chip 89. FIG. 63 is a longitudinal sectional view of the green chip 89 of FIG. 62 taken along the line X-X. FIG. 64 is a longitudinal sectional view of the green chip 89 of FIG. 62 taken along the line Y-Y.

The green chip 89 is almost the same as the green chip 73 produced for the battery 21 (FIG. 54 to 56), except that the current collector is provided in the active material green sheet in the form of a three-dimensional network. That is, the green chip 89 is structured such that a plurality of combinations, each including a positive electrode active material green sheet 90, a solid electrolyte green sheet 91 and a negative electrode active material green sheet 92, were laminated. Also, one end of the positive electrode active material green sheets and one end of the negative electrode active material green sheets are exposed at different surface regions of the green chip.

Subsequently, the green chip thus obtained was heated to 400° C. at a heating rate of 400° C./h in the air and maintained at 400° C. for 5 hours, so that the organic matter, such as the binder and the plasticizer, was sufficiently decomposed due to heat. Thereafter, it was heated to 900° C. at a heating rate of 400° C./h and promptly cooled to room temperature at a cooling rate of 400° C./h. In this way, the green chip was sintered. The sintered body thus obtained had a width of approximately 3.2 mm, a depth of approximately 1.6 mm, and a height of approximately 0.45 mm.

The packing rate of the sintered body was determined in the same manner as in Example 1-2 on the assumption that the sintered body was composed only of Li_{1.3}Al_{0.3}Ti_{1.7}(PO₄)₃. As a result, the packing rate of the sintered body was approximately 83%.

Also, an observation of a polished cross-section of the sintered body with an SEM showed that the positive electrode active material layer had a thickness of approximately 0.2 μm and that the negative electrode active material layer had a thickness of approximately 4 μm. Also, it was confirmed that the sintered body was densely sintered with almost no pores.

An external current collector paste containing copper and glass frit was applied to a face 94 of the obtained sintered body 93 at which the positive electrode current collectors were exposed and a face 95 thereof at which the negative electrode current collectors were exposed. The sintered body with the external current collector paste applied thereto was then heat-treated at 600° C. in a nitrogen atmosphere for 1 hour. As a result, a positive electrode external current collector 96 and a negative electrode external current collector 97 were formed as illustrated in FIG. 65. In this way, an all solid lithium secondary battery was produced. This battery was designated as a battery 26.

The batteries 21 to 26 and the comparative battery 8 were charged and discharged once at a current value of 10 μA in an atmosphere at a dew point of −50° C. and an ambient temperature of 25%. The discharge capacities obtained are shown as initial discharge capacities in Table 8. Also, the upper cut-off voltages and the lower cut-off voltages are shown in Table 8.

TABLE 8

| | Initial | | |
|---|---|---|---|
| | discharge | | |
| | capacity | Upper cut-off | Lower cut-off |
| | (μAh) | voltage (V) | voltage (V) |
| Battery 21 | 4.9 | 2.2 | 1.0 |
| Battery 22 | 6.5 | 1.8 | 0.5 |
| Battery 23 | 4.8 | 2.0 | 0.8 |
| Battery 24 | 4.5 | 2.1 | 0.9 |
| Battery 25 | 4.2 | 2.5 | 1.3 |
| Battery 26 | 4.9 | 2.2 | 1.0 |
| Comp. battery 8 | 0 | 3.0 | 1.4 |

The batteries 21 to 26 were able to discharge. However, the comparative battery 8 could neither charge nor discharge. The above results indicate that the present invention can provide all solid lithium secondary batteries capable of charge/discharge. Also, by increasing the number of the positive electrode active material layers, solid electrolyte layers, and negative electrode active material layers, the battery capacity can be increased. Hence, by increasing the number of layers laminated, the battery capacity can be increased.

Next, surface-treated batteries were evaluated.

(Battery 27)

A water-repellency treatment was applied to the parts of the battery 21 excluding the positive electrode external current collector 82 and the negative electrode external current collector 83 by applying an n-heptane dispersion of a fluorocarbon resin water-repellent material thereto. This battery was designated as a battery 27.

(Battery 28)

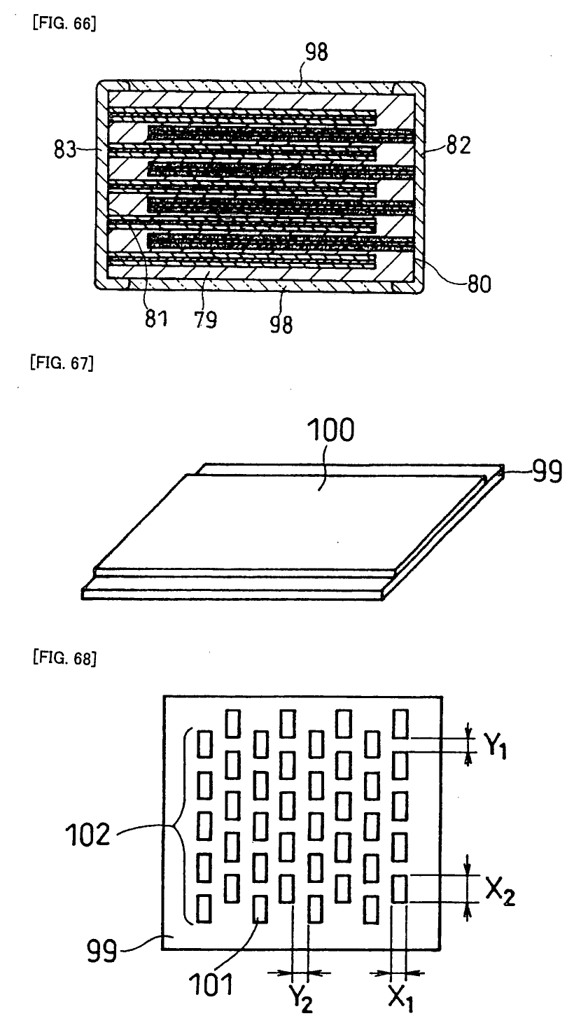

A slurry containing 72 wt % SiO₂-1 wt % Al₂O₃-20 wt % Na₂O-3 wt % MgO-4 wt % CaO (softening point 750° C.) was applied to the parts of the battery 21 excluding the positive electrode external current collector 82 and the negative electrode external current collector 83. The applied slurry was dried and then heat-treated at 700° C. As a result, as illustrated in FIG. 66, the parts of the battery 21 excluding the positive electrode external current collector 82 and the negative electrode external current collector 83 were coated with a glass layer 98. This battery was designated as a battery 28.

(Battery 29)

A transparent glaze slurry with a softening point of 750° C., represented by (0.3Na₂O-0.7CaO)0.5Al₂O₃·4.5SiO₂ was applied onto the parts of the battery 21 excluding the positive electrode external current collector and the negative electrode external current collector. The applied slurry was dried and heat-treated at 700° C. As a result, the parts of the battery 21 excluding the positive electrode external current collector and the negative electrode external current collector were coated with a glaze. This battery was designated as a battery 29.

The battery 21 and the batteries 27 to 29 were stored at a constant voltage of 2.2 V in a hot and humid container at an atmospheric temperature of 60° C. and a relative humidity of 90% for 30 days. Thereafter, these batteries were taken out from the container and discharged at a constant current of 10 μA to obtain the discharge capacity. Table 9 shows the results.

TABLE 9

| | Discharge |
|---|---|
| | capacity |
| | (μAh) |
| Battery 21 | 0.3 |
| Battery 27 | 3.5 |
| Battery 28 | 4.8 |
| Battery 29 | 4.9 |

After the hot and humid storage, the battery 21 could hardly discharge. On the other hand, the batteries 27 to 29 exhibited relatively good discharge capacities.

In the battery 21, the outermost solid electrolyte of the battery may be porous due to insufficient sintering. When such a battery in which the outermost solid electrolyte layer is porous is stored in a humid atmosphere, moisture enters the battery, so that the gold positive electrode current collector is ionized. The ionized gold moves through the solid electrolyte layer to the negative electrode active material layer, where it is reduced and gold is deposited. The deposited gold causes a short-circuit between the positive electrode active material layer and the negative electrode active material layer. This is probably the reason why the battery 21 could hardly discharge.

In the case of the battery 27 with the surface water-repellency treatment, the battery 28 with the baked low-melting-point glass, and the battery 29 with the baked glaze, these batteries are protected from moisture entering from the outside. This is probably the reason why good discharge capacities were obtained without causing an internal short-circuit.

As described above, this example indicates that it is possible to provide a highly reliable all solid lithium secondary battery even after storage in a hot and humid atmosphere.

### Example 1-8

(Battery 30)

First, a solid electrolyte powder represented by Li_{1.3}Al_{0.3}Ti_{1.7}(PO₄)₃ and a positive electrode active material powder represented by LiFePO₄ were prepared.

The solid electrolyte powder was mixed with polyvinyl butyral resin serving as a binder, n-butyl acetate as a solvent, and dibutyl phthalate as a plasticizer, and the mixture was mixed together with zirconia ball in a ball mill for 24 hours, to form a slurry for forming a solid electrolyte layer.

Likewise, a slurry for forming a positive electrode active material layer was prepared in the same manner as the solid electrolyte layer slurry.

Next, the solid electrolyte layer slurry was applied onto a carrier film 99 composed mainly of polyester resin by using a doctor blade. The applied slurry was then dried to form a solid electrolyte green sheet 100 (thickness: 10 μm) as illustrated in FIG. 67. The surface of the carrier film 99 has a release agent layer composed mainly of Si.

The positive electrode active material layer slurry was applied by screen printing on another carrier film 99 in a pattern as illustrated in FIG. 68, in which straight lines 102 of five positive electrode active material green sheets 101 were aligned in a zigzag pattern. The slurry was dried to obtain a plurality of positive electrode green sheets 101 of predetermined pattern. The thickness of the positive electrode active material green sheets was 3 μm. The width X₁ of the positive electrode active material green sheets was 1.5 mm, and the length X₂ of the positive electrode active material green sheets was 6.8 mm. The interval Y₁ between the positive electrode active material green sheets in each line was 0.4 mm, and the Y₂ between the lines was 0.3 mm.

Subsequently, a copper paste containing commercially available polyvinyl butyral resin as a binder was prepared. As illustrated in FIG. 69, this copper paste was applied by screen printing onto another carrier film 99 in the same pattern as that in the preparation of the positive electrode active material green sheets. The paste was dried to obtain a plurality of positive electrode current collector green sheets 103 (thickness: 1 μm).

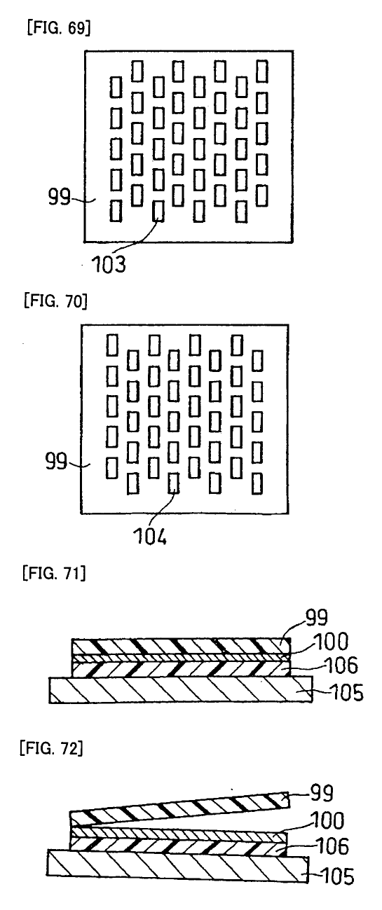

Next, the above-mentioned copper paste was applied by screen printing onto another carrier film 99 in the opposite zigzag pattern to that of the positive electrode active material green sheets, as illustrated in FIG. 70. The paste was dried to obtain a plurality of negative electrode current collector green sheets 104 (thickness: 1 μm). At this time, the width X₁ of the negative electrode current collector green sheets, the length X₂ of the negative electrode current collector green sheets, the interval Y₁ between the negative electrode current collector green sheets in each line, and the interval Y₂ between the lines were the same as those of the positive electrode active material green sheets.

Next, a polyester film 106 with adhesive applied to both sides thereof was affixed to a support 105. As illustrated in FIG. 71, the face of the solid electrolyte green sheet 100 not in contact with the carrier film 99 was placed on the polyester film 106.

Thereafter, by applying a pressure of 80 kg/cm² and a heat of 70° C. to the carrier film 99 from above, the carrier film 99 was removed from the solid electrolyte green sheet 100, as illustrated in FIG. 72.

Then, a solid electrolyte green sheet 100′, which was formed on another carrier film 99′ in the same manner as the above, was placed on the solid electrolyte green sheet 100. Subsequently, by applying pressure and heat to the carrier film 99′ from above, the green sheets 100 and 100′ were bonded together and the carrier film 99′ was removed from the green sheet 100′.

By repeating this operation 20 times, a solid electrolyte green sheet group 107 (thickness: approximately 200 μm) as illustrated in FIG. 73 was fabricated.

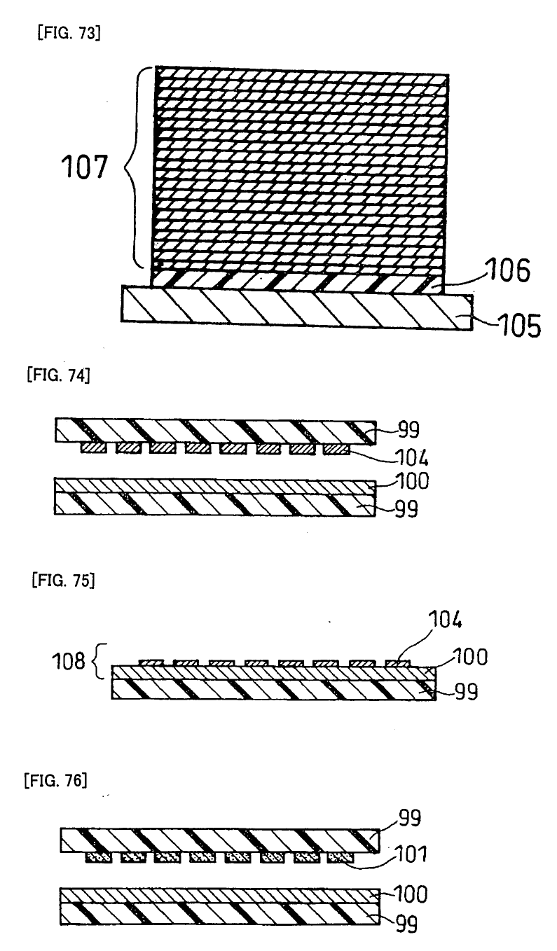

Thereafter, as illustrated in FIG. 74, the plurality of negative electrode current collector green sheets 104 formed on the carrier film 99 in the above manner were placed on the solid electrolyte green sheet 100 formed on the carrier sheet 99, in such a manner that the negative electrode current collector green sheets 104 were in contact with the solid electrolyte green sheet 100. Then, by applying a pressure of 80 kg/cm² and a heat of 70° C. to the carrier film 99 carrying the plurality of negative electrode current collector green sheets from above, the carrier film 99 was removed from the negative electrode current collector green sheets 104. In this way, as illustrated in FIG. 75, a negative electrode-solid electrolyte sheet 108, including the solid electrolyte green sheet 100 and the negative electrode current collector green sheets 104 carried thereon, was obtained.

Thereafter, as illustrated in FIG. 76, the plurality of positive electrode active material green sheets 101 formed on the carrier film 99 in the above manner were placed on the solid electrolyte green sheet 100 formed on the carrier sheet 99, in such a manner that the positive electrode active material green sheets were in contact with the solid electrolyte green sheet. Then, by applying a pressure of 80 kg/cm² and a heat of 70° C. to the carrier film 99 carrying the plurality of positive electrode active material green sheets from above, the carrier film 99 was removed from the positive electrode active material green sheets 101.

Subsequently, the plurality of positive electrode current collector green sheets 103 carried on the carrier sheet 99 were laminated on the positive electrode active material green sheets 101, in such a manner that they were aligned with the positive electrode active material green sheets 101. By applying a pressure of 80 kg/cm² and a heat of 70° C. to the carrier film 99 carrying the plurality of positive electrode current collector green sheets 103 from above, the carrier film 99 was removed from the positive electrode current collector green sheets 103. Further, the positive electrode active material green sheets 101 were laminated on the positive electrode current collector green sheets 103 in the same manner, to obtain a laminate as illustrated in FIG. 77. The resulting laminate including: the solid electrolyte green sheet 100; and a plurality of sub-laminates carried thereon, each sub-laminate being composed of two positive electrode active material green sheets and one positive electrode current collector green sheet sandwiched between the two green sheets, was designated as a positive electrode laminate 109.

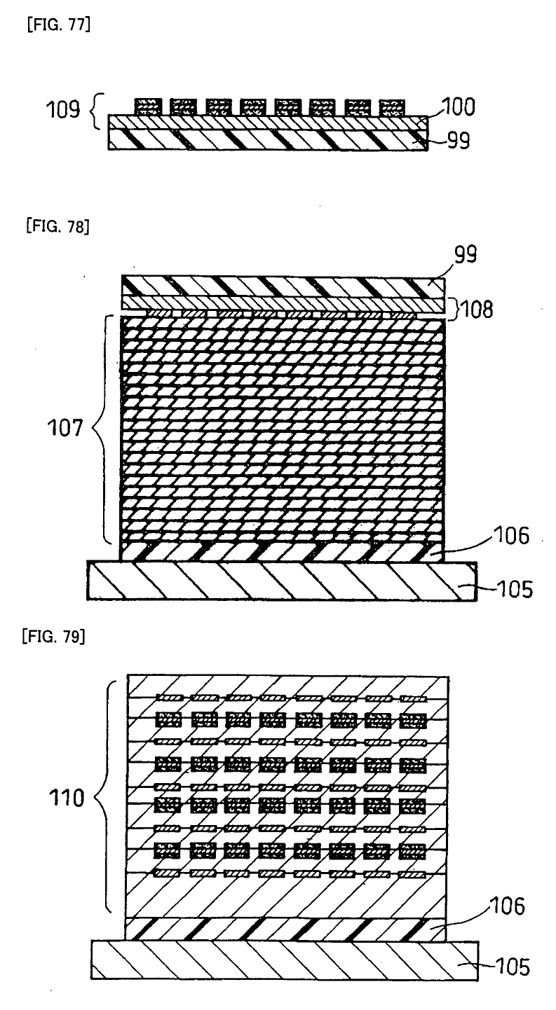

Next, as illustrated in FIG. 78, the negative electrode-solid electrolyte sheet 108 was placed on the solid electrolyte green sheet group 107 on the support 105. By applying a pressure of 80 kg/cm² and a heat of 70° C. to the carrier film 99 from above, the carrier film 99 was removed from the negative electrode-solid electrolyte sheet 108. In this way, the negative electrode-solid electrolyte sheet 108 was laminated on the solid electrolyte green sheet group 107 such that the negative electrode current collector green sheets 104 were in contact with the solid electrolyte green sheet group.

Likewise, the positive electrode laminate 109 was placed on the negative electrode-solid electrolyte sheet 108 such that the positive electrode active material green sheets of the positive electrode laminate 109 were in contact with the solid electrolyte green sheet of the negative electrode-solid electrolyte sheet 108. By applying a pressure of 80 kg/cm² and a heat of 70° C. to the carrier film 99 from above, the carrier film 99 was removed from the positive electrode laminate 109. In this way, the positive electrode laminate 109 was laminated on the negative electrode-solid electrolyte sheet 108. When the negative electrode-solid electrolyte sheet and the positive electrode laminate were laminated, the zigzag pattern of the straight lines of the negative electrode current collector green sheets was opposite to that of the straight lines of the positive electrode active material green sheets.

By repeating the above operation, a laminate 110 composed of the solid electrolyte green sheet laminate, five negative electrode-solid electrolyte sheets, and four positive electrode laminates was obtained as illustrated in FIG. 79. At the end of the laminate 110 opposite to the solid electrolyte green sheet group in the laminating direction was the negative electrode-solid electrolyte sheet 108.

Lastly, 20 solid electrolyte green sheets were laminated on the negative electrode-solid electrolyte layer at the end of the laminate 110 opposite to the solid electrolyte green sheet group, to obtain a laminate sheet. This laminate sheet was removed from the support 105 with the polyester film 106.

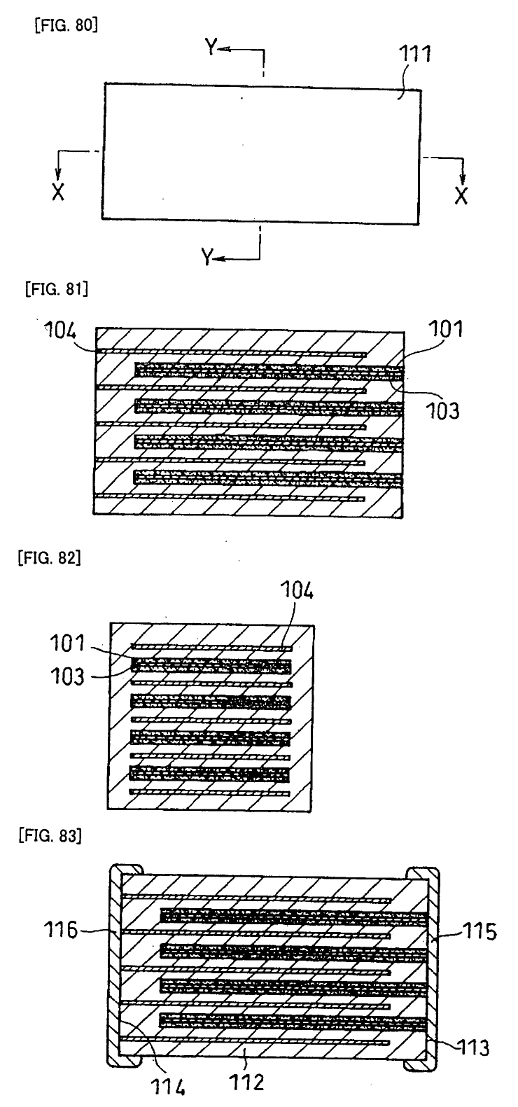

The laminate sheet was cut to obtain a green chip 111. FIGS. 80 to 82 illustrate the green chip. FIG. 80 is a top view of the green chip 111. FIG. 81 is a longitudinal sectional view taken along the line X-X. FIG. 82 is a longitudinal sectional view taken along the line Y-Y.

As shown in FIG. 82, the green chip 111 is structured such that a plurality of the positive electrode active material laminates each including the positive electrode active material green sheet 101 and the positive electrode current collector green sheet 103 and a plurality of the negative electrode-solid electrolyte sheets each including the negative electrode current collector sheet 104 are laminated. By sintering such a green chip, it is possible to obtain a laminate including at least one integrated combination of a positive electrode active material layer and a negative electrode-solid electrolyte layer. The number of integrated combinations can be adjusted by changing the number of the positive electrode laminates and the negative electrode-solid electrolyte layers.

Also, the green chip obtained in this example has the shape of a hexahedron, and as shown in FIG. 81, one end of the negative electrode current collector green sheets 104 is exposed at one face of the hexahedron. At the opposite face, one end of the positive electrode active material green sheets 101 and the positive electrode current collector green sheets 103 is exposed. That is, by using the above-described production method, the positive electrode current collectors and the negative electrode current collectors can be exposed at different surface regions of the laminate. It is also possible to use other methods than the above-mentioned one in order to expose the positive electrode current collectors and the negative electrode current collectors at different surface regions of the laminate.

In this example, the other faces than these two are covered with the solid electrolyte layer.

The green chip was heat-treated in an atmospheric gas composed of a first atmospheric gas and steam in a sintering furnace. The first atmospheric gas used was a gas having a low oxygen partial pressure and a composition of CO₂/H₂/N₂=4.99/0.01/95. The volume of the steam contained in the atmospheric gas was 5%. The flow rate of the atmospheric gas supplied to the furnace was 12 L/min at a temperature of 700° C. and 1 atmosphere. The supply of the atmospheric gas to the furnace was started when the temperature of the furnace reached 200° C.

The green chip was heated to 700° C. at a heating rate of 100° C./h and maintained at 700° C. for 5 hours. Thereafter, it was heated to 900° C. at a heating rate of 400° C./h and promptly cooled to room temperature at a cooling rate of 400° C./h. The supply of the gas was stopped when the temperature in the furnace became 200%. In this way, the green chip was sintered to obtain a sintered body. The sintered body had a width of approximately 3.2 mm, a depth of approximately 1.6 mm, and a height of approximately 0.45 mm.

Also, a polished cross-section of the sintered body was observed with an SEM. As a result, the positive electrode current collector and the negative electrode current collector had a thickness of approximately 0.3 μm. Also, the positive electrode active material layer on one side of the positive electrode current collector had a thickness of approximately 1 μm. Further, it was confirmed that the sintered body was densely sintered with almost no pores.

An external current collector paste containing copper and glass frit was applied to a face 113 of a sintered body 112 at which the positive electrode current collectors were exposed and a face 114 thereof at which the negative electrode current collectors were exposed. The sintered body with the external current collector paste applied thereto was then heat-treated at 600° C. in a nitrogen atmosphere for 1 hour. As a result, a positive electrode external current collector 115 and a negative electrode external current collector 116 were formed as illustrated in FIG. 83. In this way, an all solid lithium secondary battery was produced. This battery was designated as a battery 30.

In such a low oxygen-partial-pressure gas with the composition of CO₂/H₂/N₂=4.99/0.01/95, the following equilibrium reactions represented by the formula (2) and the formula (3) occur:
CO₂→CO+1/2O₂ (2)
H₂+1/2O₂→H₂O (3)
Oxygen is produced in the reaction of the formula (2), while oxygen is consumed in the reaction of the formula (3). Thus, the atmospheric gas contains oxygen having an almost constant partial pressure.
(Batteries 31 to 34)

Batteries 31 to 34 were produced in the same manner as the battery 30, except that the amount of the steam contained in the mixed gas was changed to 20% by volume, 30% by volume, 50% by volume, and 90% by volume, respectively.

(Reference Battery 35)

A reference battery 35 was produced in the same manner as the battery 30, except that a gas with a composition of CO₂/H₂/N₂=4.99/0.01/95 was used as the low oxygen-partial-pressure gas and that no steam was added.

(Reference Battery 36)

A reference battery 36 was produced in the same manner as the battery 30, except that air was used in place of the low oxygen-partial-pressure gas with the composition of CO₂/H₂/N₂=4.99/0.01/95 and that the amount of the steam contained in the atmospheric gas was changed to 30% by volume.

(Reference Battery 37)

A reference battery 37 was produced in the same manner as the battery 30, except that a high purity argon gas with a purity of 4N was used in place of the low oxygen-partial-pressure gas with the composition of CO₂/H₂/N₂=4.99/0.01/95 and that the amount of the steam contained in the atmospheric gas was changed to 30% by volume.

(Reference Battery 38)

A reference battery 38 was produced in the same manner as the battery 30, except that a high purity CO₂ gas with a purity of 4N was used in place of the low oxygen-partial-pressure gas with the composition of CO₂/H₂/N₂=4.99/0.01/95 and that the amount of the steam contained in the atmospheric gas was changed to 30% by volume.

(Reference battery 39)

A reference battery 39 was produced in the same manner as the battery 30, except that a high purity H₂ gas with a purity of 4N was used in place of the low oxygen-partial-pressure gas with the composition of CO₂/H₂/N₂=4.99/0.01/95 and that the amount of the steam contained in the atmospheric gas was changed to 30% by volume.

(Battery 40)

A battery 40 was produced in the same manner as the battery 32, except that LiCoPO₄ was used as the positive electrode active material.

With respect to the batteries 30 to 34 and the battery 40, and the reference batteries 35 to 39, the packing rate of each sintered body was determined in the same manner as in Example 1-2 on the assumption that the sintered body was composed only of Li_{1.3}Al_{0.3}Ti_{1.7}(PO₄)₃. Table 10 shows the results. Also, Table 10 shows the kinds of the first atmosphere, the amounts of the steam added, and the values of −log₁₀PO₂.

TABLE 10

| | | Amount of | | |
|---|---|---|---|---|
| | | steam | | |
| | | contained in | Packing | |
| | | atmospheric | rate | −log₁₀PO₂ |
| | First atmosphere | gas (vol %) | (%) | (700° C.) |
| Battery 30 | CO₂/H₂/N₂ = 99/0.01/95 | 5 | 78 | 15 |
| Battery 31 | CO₂/H₂/N₂ = 99/0.01/95 | 20 | 80 | 14 |
| Battery 32 | CO₂/H₂/N₂ = 99/0.01/95 | 30 | 82 | 13 |
| Battery 33 | CO₂/H₂/N₂ = 99/0.01/95 | 50 | 83 | 13 |
| Battery 34 | CO₂/H₂/N₂ = 99/0.01/95 | 90 | 83 | 12 |
| Ref. | CO₂/H₂/N₂ = 99/0.01/95 | 0 | 51 | 16 |
| battery 35 | | | | |
| Ref. | Air | 30 | 73 | 0.7 |
| battery 36 | | | | |
| Ref. | Ar | 30 | 75 | 7 |
| battery 37 | | | | |
| Ref. | CO₂ | 30 | 76 | 7 |
| battery 38 | | | | |
| Ref. | H₂ | 30 | 59 | 22 |
| battery 39 | | | | |
| Battery 40 | CO₂/H₂/N₂ = 99/0.01/95 | 30 | 85 | 13 |

The batteries 30 to 34 exhibited relatively good packing rates of about 80% regardless of the amount of steam. The battery 40 also exhibited a relatively good packing rate of 85%.

On the other hand, the reference battery 35 and the reference battery 39 exhibited packing rates of less than 60%, which indicates that sintering hardly proceeded. The sintered bodies of these reference batteries were black. This suggests that in these reference batteries, the binder and the plasticizer were carbonized due to thermal decomposition and therefore that the sintering of the green chip was impeded.

In the case of the reference battery 39, the produced carbon remained probably because the equilibrium partial pressure of oxygen in the atmospheric gas of H₂/H₂O=7/3 at 700° C. is approximately 10-22 atmospheres, which is extremely low.

Also, these reference batteries 35 and 39 were brittle and thus broke during the handling when the external current collector was applied.

In the batteries 30 to 34 and the battery 40, their sintered bodies were almost white. The equilibrium oxygen partial pressure at 700° C. in the atmospheric gases as shown in Table 10 was estimated at approximately 10⁻¹⁶ atmospheres. In this case, probably due to reduction in molecular weight by the steam, the binder and the plasticizer were promptly discharged from the system and the by-product carbon was removed by the very small amount of oxygen, so that sintering proceeded.

Also, in the reference batteries 36 to 38, their sintered bodies were almost white, although their packing rates were slightly inferior to those of the batteries 30 to 34 and the battery 40.

Next, the batteries 30 to 34 and the battery 40 and the reference batteries 36 to 38 were charged and discharged once at a current value of 10 μA in an atmosphere with a dew point of −50° C. and an ambient temperature of 25° C. Therein, the upper cut-off voltage was set to 2.0 V and the lower cut-off voltage was set to 0 V. Also, the battery 40 was charged and discharged in the same manner except that the upper cut-off voltage was set to 5.0 V and that the lower cut-off voltage was set to 0 V. The discharge capacities obtained in the above manner are shown in Table 11 as the initial discharge capacities.

TABLE 11

| | | Amount of steam | Initial |
|---|---|---|---|
| | | contained in | discharge |
| | | atmospheric gas | capacity |
| | First atmospheric gas | (vol %) | (μAh) |
| Battery 30 | CO₂/H₂/N₂ = 99/0.01/95 | 5 | 6.3 |
| Battery 31 | CO₂/H₂/N₂ = 99/0.01/95 | 20 | 6.5 |
| Battery 32 | CO₂/H₂/N₂ = 99/0.01/95 | 30 | 6.6 |
| Battery 33 | CO₂/H₂/N₂ = 99/0.01/95 | 50 | 6.8 |
| Battery 34 | CO₂/H₂/N₂ = 99/0.01/95 | 90 | 6.7 |
| Ref. battery 36 | Air | 30 | 0 |
| Ref. battery 37 | Air | 30 | 0.5 |
| Ref. battery 38 | CO₂ | 30 | 0.3 |
| Battery 40 | CO₂/H₂/N₂ = 99/0.01/95 | 30 | 2.8 |

The batteries 30 to 34 exhibited initial discharge capacities of more than 6 μAh. Also, the battery 40 exhibited an initial discharge capacity of 2.8 μAh. On the other hand, charge/discharge of the reference batteries 36 to 38 was almost impossible. In the reference battery 36, in particular, since the baking was performed in an air atmosphere, LiFePO₄ changed into an Fe(III) compound such as Li₃Fe₂(PO₄)₃ and the current collector material Cu was oxidized and did not function as the current collector. Probably for this reason, charge/discharge was impossible.

On the other hand, in the atmospheric gases used for the production of the reference batteries 37 to 38, the equilibrium oxygen partial pressure at 700° C. is estimated at approximately 10⁻⁷ atmospheres. Thus, LiFePO₄ changed into an Fe(III) compound such as Li₃Fe₂(PO₄)₃, and probably for this reason, discharge was almost impossible.

The equilibrium oxygen partial pressure at 700° C. calculated from the above-mentioned formula (1) is from 10^{-17.1} atmospheres to 10^{-11.8} atmospheres. It can be seen that in the batteries 30 to 34 having an equilibrium oxygen partial pressure within this range, the oxidation of the current collector and the oxidation of the active material Fe(II) to Fe(III) are suppressed and that the carbon produced by the thermal decomposition of the binder and plasticizer is removed by oxygen. Thus, it is believed that by adjusting the oxygen partial pressure properly, an all solid lithium secondary battery with good charge/discharge capacity can be produced.

Also, in order for the partial pressure of oxygen contained in the low oxygen-partial-pressure gas atmosphere to be maintained constant, it is preferable that the low oxygen-partial-pressure gas contain a mixture of a gas capable of releasing oxygen, such as CO₂, and a gas that reacts with oxygen, such as H₂.

### Example 2-1

Next, the following batteries and comparative batteries were produced, and charged and discharged under predetermined conditions to obtain the discharge capacity.

(Battery 2-1)

A battery 2-1 was produced in the same manner as the battery 7, except that the solid electrolyte layer slurry was mixed with an amorphous oxide powder having a softening point of 750° C. and represented by 72 wt % SiO₂-1 wt % Al₂O₃-20 wt % Na₂O-3 wt % MgO-4 wt % CaO such that the weight ratio between the solid electrolyte powder and the amorphous oxide powder was 97:3, and that the highest sintering temperature of the green chip was changed from 900° C. to 700° C.

It should be noted that the positive electrode active material is easiest to sinter and the solid electrolyte layer is most difficult to sinter, but that there is not much difference in the degree of ease of sintering between the positive electrode active material and the negative electrode active material. Thus, the amorphous oxide was added only to the solid electrolyte layer in this example.

In the same manner as in the foregoing Example 1-2, the packing rate of the sintered green chip was determined on the assumption that the sintered chip was composed only of Li_{1.3}Al_{0.3}Ti_{1.7}(PO₄)₃, since the positive electrode active material layer and the negative electrode active material layer were sufficiently thin compared with the solid electrolyte layer. As a result, the packing rate was approximately 73%. The packing rate of the chip was calculated from [{(chip weight)/(chip volume)}/(X-ray density of solid electrolyte)]×100.

Further, a polished cross-section of the sintered green chip was observed with an SEM to examine the positive electrode active material layer and the negative electrode active material layer. The observation confirmed that the positive electrode active material layer and the negative electrode active material layer had a thickness of approximately 1 μm and that the positive electrode active material layer and the negative electrode active material layer were densely sintered with almost no pores.

(Battery 2-2)

An all solid battery was produced in the same manner as the battery 2-1, except that the sintering was performed by raising the temperature to 800° C. at a heating temperature of 400° C./h instead of raising the temperature to 700° C. at a heating rate of 400° C./h. This battery was designated as a battery 2-2. The packing rate of the sintered green chip was 93% on the assumption that the green chip was composed only of Li_{1.3}Al_{0.3}Ti_{1.7}(PO₄)₃.

(Battery 2-3)

An all solid battery was produced in the same manner as the battery 2-1, except that the sintering was performed by raising the temperature to 900° C. at a heating temperature of 400° C./h instead of raising the temperature to 700° C. at a heating rate of 400° C./h. This battery was designated as a battery 2-3. The packing rate of the sintered green chip was 95% on the assumption that the green chip was composed only of Li_{1.3}Al_{0.3}Ti_{1.7}(PO₄)₃.

(Battery 2-4)

An all solid battery was produced in the same manner as the battery 2-1, except that the sintering was performed by raising the temperature to 1000° C. at a heating temperature of 400° C./h instead of raising the temperature to 700° C. at a heating rate of 400° C./h. This battery was designated as a battery 2-4. The packing rate of the sintered green chip was 95% on the assumption that the green chip was composed only of Li_{1.3}Al_{0.3}Ti_{1.7}(PO₄)₃.

(Battery 2-5)

A battery 2-5 was produced in the same manner as the battery 2-1, except that the solid electrolyte layer slurry was prepared by adding Li₄P₂O₇ as the amorphous oxide, and that the sintering was performed by raising the temperature to 800% at a heating temperature of 400° C./h instead of raising the temperature to 700° C. at a heating rate of 400° C./h. The packing rate of the sintered green chip was 93% on the assumption that the green chip was composed only of Li_{1.3}Al_{0.3}Ti_{1.7}(PO₄)₃.

(Comparative Battery 2-1)

A comparative battery 2-1 was produced in the same manner as the battery 2-1, except that the sintering was performed by raising the temperature to 600° C. at a heating temperature of 400° C./h instead of raising the temperature to 700° C. at a heating temperature of 400° C./h. The packing rate of the sintered green chip was 57% on the assumption that the green chip was composed only of Li_{1.3}Al_{0.3}Ti_{1.7}(PO₄)₃.

(Comparative Battery 2-2)

A comparative battery 2-2 was produced in the same manner as the battery 2-1, except that the sintering was performed by raising the temperature to 1100° C. at a heating temperature of 400° C./h instead of raising the temperature to 700° C. at a heating temperature of 400° C./h. The packing rate of the sintered green chip was 93% on the assumption that the green chip was composed only of Li_{1.3}Al_{0.3}Ti_{1.7}(PO₄)₃.

(Comparative Battery 2-3)

A comparative battery 2-3 was produced in the same manner as the battery 2-1, except that the amorphous oxide was not added in preparing the solid electrolyte layer slurry and that the sintering was performed by raising the temperature to 800° C. at a heating temperature of 400° C./h instead of raising the temperature to 700° C. at a heating temperature of 400° C./h. The packing rate of the sintered green chip was 55% on the assumption that the green chip was composed only of Li_{1.3}Al_{0.3}Ti_{1.7} (PO₄)₃.

(Battery 2-6)

A battery 2-6 was produced in the same manner as the comparative battery 2-3, except that the sintering was performed by raising the temperature to 900° C. at a heating temperature of 400° C./h instead of raising the temperature to 800° C. at a heating temperature of 400° C./h. The packing rate of the sintered green chip was 83% on the assumption that the green chip was composed only of Li_{1.3}Al_{0.3}Ti_{1.7}(PO₄)₃.

(Battery 2-7)

A battery 2-7 was produced in the same manner as the comparative battery 2-3, except that the sintering was performed by raising the temperature to 1000° C. at a heating temperature of 400° C./h instead of raising the temperature to 800° C. at a heating temperature of 400° C./h. The packing rate of the sintered green chip was 87% on the assumption that the green chip was composed only of Li_{1.3}Al_{0.3}Ti_{1.7}(PO₄)₃.

The batteries 2-1 to 2-7 and the comparative batteries 2-1 to 2-3 were charged and discharged once at a current value of 10 μA in the range of 2.3 V to 1.0 V in an atmosphere with a dew point of −500° C. and a temperature of 250° C. Table 12 shows the discharge capacities obtained. Also, after the charge/discharge of the batteries, their impedances at 1 kHz were measured. Table 12 shows the results.

TABLE 12

| | Amount of | | | | |
|---|---|---|---|---|---|
| | amorphous | Highest | | | |
| | oxide | sintering | Packing | Discharge | |
| | added | temperature | rate | capacity | |
| | (wt %) | (° C.) | (%) | (μAh) | Impedance (Ω) |
| Battery 2-1 | 3 | 700 | 73 | 9.2 | 2010 |
| Battery 2-2 | 3 | 800 | 93 | 10.2 | 389 |
| Battery 2-3 | 3 | 900 | 95 | 9.7 | 403 |
| Battery 2-4 | 3 | 1000 | 95 | 8.6 | 1900 |
| Battery 2-5 | 3 | 800 | 93 | 10.3 | 363 |
| Comp. battery 2-1 | 3 | 600 | 57 | 0 | 90300 |
| Comp. battery 2-2 | 3 | 1100 | 93 | 0 | Not detectable |
| Comp. battery 2-3 | Not added | 800 | 55 | 0 | 103000 |
| Battery 2-6 | Not added | 900 | 83 | 10.1 | 3010 |
| Battery 2-7 | Not added | 1000 | 87 | 8.6 | 2700 |

In the comparative batteries 2-1 to 2-3, their discharge capacities were 0. Also, in the comparative batteries 2-1 to 2-3, their impedances were significantly high. This is probably because the sintering of the solid electrolyte did not proceed and the lithium ion conductivity was therefore significantly small. In the case of the comparative battery 2-2, in particular, the impedance after the charge/discharge was out of the measurement range (not less than 10⁷Ω). This is probably because the solid electrolyte could not withstand the high temperature and became denatured, so that the lithium ion conductivity was lost.

On the other hand, the batteries 2-1 to 2-5 of the present invention exhibited relatively good discharge capacities and low impedances.

Also, a comparison between the batteries 2-1 to 2-4 and the comparative batteries 2-1 to 2-2 clearly shows that charge/discharge was possible when the sintering temperature was 700° C. or more and 1000° C. or less and that this temperature range is desirable.

Further, a comparison between the batteries 2-1 to 2-4, and the comparative batteries 2-3 and the batteries 2-6 to 2-7 clearly indicates that the addition of the sintering aid results in lower impedances and better batteries.

### Example 2-2

Next, the amount of the sintering aid added was examined.

(Battery 2-8)

A battery 2-8 was produced in the same manner as the battery 2-2 (sintering temperature: 800° C.), except that the solid electrolyte layer slurry was prepared by mixing the solid electrolyte Li_{1.3}Al_{0.3}Ti_{1.7}(PO₄)₃ with the amorphous oxide 72 wt % SiO₂-1 wt % Al₂O₃-20 wt % Na₂O-3 wt % MgO-4 wt % CaO in a weight ratio of 99.9:0.1. The packing rate of the sintered green chip was 72% on the assumption that the green chip was composed only of Li_{1.3}Al_{0.3}Ti_{1.7}(PO₄)₃.

(Battery 2-9)

A battery 2-9 was produced in the same manner as the battery 2-2 (sintering temperature: 800° C.), except that the solid electrolyte layer slurry was prepared by mixing the solid electrolyte Li_{1.3}Al_{0.3}Ti_{1.7}(PO₄)₃ with the amorphous oxide 72 wt % SiO₂-1 wt % Al₂O₃-20 wt % Na₂O-3 wt % MgO-4 wt % CaO in a weight ratio of 99:1. The packing rate of the sintered green chip was 89% on the assumption that the green chip was composed only of Li_{1.3}Al_{0.3}Ti_{1.7}(PO₄)₃.

(Battery 2-10)

A battery 2-10 was produced in the same manner as the battery 2-2 (sintering temperature: 800° C.), except that the solid electrolyte layer slurry was prepared by mixing the solid electrolyte Li_{1.3}Al_{0.3}Ti_{1.7}(PO₄)₃ with the amorphous oxide 72 wt % SiO₂-1 wt % Al₂O₃-20 wt % Na₂O-3 wt % MgO-4 wt % CaO in a weight ratio of 95:5. The packing rate of the sintered green chip was 94% on the assumption that the green chip was composed only of Li_{1.3}Al_{0.3}Ti_{1.7} (PO₄)₃.

(Battery 2-11)

A battery 2-11 was produced in the same manner as the battery 2-2 (sintering temperature: 800° C.), except that the solid electrolyte layer slurry was prepared by mixing the solid electrolyte Li_{1.3}Al_{0.3}Ti_{1.7}(PO₄)₃ with the amorphous oxide 72 wt % SiO₂-1 wt % Al₂O₃-20 wt % Na₂O-3 wt % MgO-4 wt % CaO in a weight ratio of 90:10. The packing rate of the sintered green chip was 94% on the assumption that the green chip was composed only of Li_{1.3}Al_{0.3}Ti_{1.7}(PO₄)₃.

(Comparative Battery 2-4)

A comparative battery 2-4 was produced in the same manner as the battery 2-2 (sintering temperature: 800%), except that the solid electrolyte layer slurry was prepared by mixing the solid electrolyte Li_{1.3}Al_{0.3}Ti_{1.7}(PO₄)₃ with the amorphous oxide 72 wt % SiO₂-1 wt % Al₂O₃-20 wt % Na₂O-3 wt % MgO-4 wt % CaO in a weight ratio of 99.95:0.05. The packing rate of the sintered green chip was 57% on the assumption that the green chip was composed only of Li_{1.3}Al_{0.3}Ti_{1.7}(PO₄)₃.

(Battery 2-12)

A battery 2-12 was produced in the same manner as the battery 2-2 (sintering temperature: 800° C.), except that the solid electrolyte layer slurry was prepared by mixing the solid electrolyte Li_{1.3}Al_{0.3}Ti_{1.7}(PO₄)₃ with the amorphous oxide 72 wt % SiO₂-1 wt % Al₂O₃-20 wt % Na₂O-3 wt % MgO-4 wt % CaO in a weight ratio of 85:15. The packing rate of the sintered green chip was 93% on the assumption that the green chip was composed only of Li_{1.3}Al_{0.3}Ti_{1.7}(PO₄)₃.

Using the batteries 2-8 to 2-12 and the comparative batteries 2-4 thus produced, their discharge capacities and impedances at 1 kHz were measured in the same manner as the foregoing Example 2-1. Table 13 shows the results. For reference, it also shows the results of the battery 2-2 and the comparative battery 2-3.

TABLE 13

| | Amount of | | | | |
|---|---|---|---|---|---|
| | amorphous | | | | |
| | oxide | Highest | | Discharge | |
| | added | sintering | Packing | capacity | Impedance |
| | (wt %) | temperature(° C.) | rate (%) | (μAh) | (Ω) |
| Battery 2-2 | 3 | 800 | 93 | 10.2 | 389 |
| Battery 2-8 | 0.1 | 800 | 72 | 4.8 | 9300 |
| Battery 2-9 | 1 | 800 | 89 | 8.9 | 583 |
| Battery 2-10 | 5 | 800 | 94 | 9.3 | 440 |
| Battery 2-11 | 10 | 800 | 94 | 6.0 | 6200 |
| Comp. battery 2-3 | Not added | 800 | 55 | 0 | 103000 |
| Comp. battery 2-4 | 0.05 | 800 | 57 | 0 | 71000 |
| Battery 2-12 | 15 | 800 | 93 | 2.7 | 10100 |

The discharge capacity of the comparative battery 2-4 was 0. The comparative battery 2-4 exhibited a large impedance probably because the amount of the sintering aid was too small for the sintering to proceed. On the other hand, the battery 2-12 exhibited a large impedance probably because an excessive amount was added and thus the ionic conductivity of the solid electrolyte layer lowered.

The above results indicate that the sintering aid preferably accounts for 0.1 to 10% by weight of the layer to which it is added.

### Example 2-3

Next, the kind of the sintering aid added to the solid electrolyte layer and the softening point of the sintering aid were examined.

(Battery 2-13)

A battery 2-10 was produced in the same manner as the battery 2-2, except that an amorphous oxide represented by 80 wt % SiO₂-14 wt % B₂O₃-2 wt % Al₂O₃-3.6 wt % Na₂O-0.4 wt % K₂O was used in place of 72 wt % SiO₂-1 wt % Al₂O₃-20 wt % Na₂O-3 wt % MgO-4 wt % CaO. The packing rate of the sintered green chip was 91% on the assumption that the green chip was composed only of Li_{1.3}Al_{0.3}Ti_{1.7}(PO₄)₃.

(Comparative Battery 2-5)

A comparative battery 2-5 was produced in the same manner as the battery 2-2, except for the use of Al₂O₃ powder instead of 72 wt % SiO₂-1 wt % Al₂O₃-20 wt % Na₂O-3 wt % MgO-4 wt % CaO. The packing rate of the sintered green chip was 55% on the assumption that the green chip was composed only of Li_{1.3}Al_{0.3}Ti_{1.7} (PO₄)₃.

(Comparative Battery 2-6)

A comparative battery 2-6 was produced in the same manner as the battery 2-2, except for the use of 72 wt % SiO₂-lwt % Al₂O₃-14 wt % Na₂O-3 wt % MgO-10 wt % CaO powder with a softening point of 600° C. instead of 72 wt % SiO₂-1 wt % Al₂O₃-20 wt % Na₂O-3 wt % MgO-4 wt % CaO. The packing rate of the sintered green chip was 97% on the assumption that the green chip was composed only of Li_{1.3}Al_{0.3}Ti_{1.7}(PO₄)₃.

(Comparative Battery 2-7)

A comparative battery 2-7 was produced in the same manner as the battery 2-2, except for the use of 62 wt % SiO₂-wt % Al₂O₃-8 wt % CaO-15 wt % BaO powder with a softening point of 1020° C. instead of 72 wt % SiO₂-1 wt % Al₂O₃-20 wt % Na₂O-3 wt % MgO-4 wt % CaO. The packing rate of the sintered green chip was 58% on the assumption that the green chip was composed only of Li_{1.3}Al_{0.3}Ti_{1.7} (PO₄)₃.

Using the batteries 2-13 and the comparative batteries 2-5 to 2-7 thus produced, their discharge capacities and impedances at 1 kHz were measured in the same manner as Example 2-1. Table 14 shows the results. For reference, it also shows the results of the battery 2-2.

TABLE 14

| | Amount of | Softening | | | | |
|---|---|---|---|---|---|---|
| | amorphous | point of | Highest | | Initial | |
| | oxide | amorphous | sintering | Packing | discharge | |
| | added | oxide | temperature | rate | capacity | Impedance |
| | (wt %) | (° C.) | (° C.) | (%) | (μAh) | (Ω) |
| Battery | 3 | 750 | 800 | 93 | 10.3 | 389 |
| 2-2 | | | | | | |
| Battery | 3 | 915 | 800 | 91 | 10.0 | 403 |
| 2-10 | | | | | | |
| Comp. | 3 | 660 | 800 | 55 | 0 | Not |
| battery 2-5 | | | | | | detectable |
| Comp. | 3 | 600 | 800 | 97 | 0 | Not |
| battery 2-6 | | | | | | detectable |
| Comp. | 3 | 1020 | 800 | 58 | 0 | 98000 |
| battery 2-7 | | | | | | |

The discharge capacity and impedance of the battery 2-13 were equivalent to the discharge capacity and impedance of the battery 2-2.

On the other hand, in the case of the comparative battery 2-5 using Al₂O₃, which is a common sintering aid, the discharge capacity was 0. This is probably because the sintering of the laminate did not proceed upon the sintering. That is, it is believed that in the system using Al₂O₃, the Al₂O₃ reacted with the solid electrolyte Li_{1.3}Al_{0.3}Ti_{1.7}(PO₄)₃ to produce an impurity phase in the solid electrolyte layer, thereby resulting in poor sintering.

Also, in the case of the comparative battery 2-6 to which the amorphous oxide with a softening point of 600° C. was added, the discharge capacity was also 0. This is probably because the diffusion of the active material and the solid electrolyte proceeded together with the sintering reaction and hence charge/discharge was not possible.

In the case of the comparative battery 2-7 to which the amorphous oxide with a softening point of 1020° C. was added, the discharge capacity was also 0. This is probably because the softening point of the additive is too high to promote sintering.

The above results demonstrate that by adding an amorphous oxide with a softening point of 700° C. or more and 950° C. or less to at least one of the positive electrode active material layer, the solid electrolyte layer, and the negative electrode active material layer, it is possible to produce an all solid battery with good charge/discharge performance.

### Example 2-4

Laminates comprising a positive electrode active material layer and a solid electrolyte layer were produced in the same manner as in the production methods of the comparative battery 2-3, comparative battery 2-4, battery 2-8, battery 2-9, battery 2-2, battery 2-10, battery 2-11, and battery 2-12, except that the negative electrode active material layer was not provided and that the highest sintering temperature was changed to 800° C. These laminates were designated as a comparative laminate 2-3, a comparative laminate 2-4, a laminate 2-8, a laminate 2-9, a laminate 2-2, a laminate 2-10, a laminate 2-11, and a laminate 2-12, respectively. Warpage of these laminates was measured. As used herein, warpage refers to the vertical distance of a laminate that is placed on a predetermined flat plate with its positive electrode active material layer positioned upward, specifically, the vertical distance from the upper face of the positive electrode active material layer of the laminate to the flat plate. It should be noted that the green chips of these laminates before the sintering had a thickness of approximately 500 μm and a size of 7 mm×7 mm.

Also, Table 15 shows the amounts of the amorphous oxide added to the green sheets for forming the solid electrolyte layers and the highest sintering temperatures.

TABLE 15

| | Amount of | | |
|---|---|---|---|
| | amorphous | Highest | |
| | oxide added | sintering | Warpage |
| | (wt %) | temperature(° C.) | (mm) |
| Comparative laminate 2-3 | Not added | 800 | 2.2 |
| Comparative laminate 2-4 | 0.05 | 800 | 2.0 |
| Laminate 2-8 | 0.1 | 800 | 1.3 |
| Laminate 2-9 | 1 | 800 | 0.8 |
| Laminate 2-2 | 3 | 800 | 0.6 |
| Laminate 2-10 | 5 | 800 | 0.6 |
| Laminate 2-11 | 10 | 800 | 0.6 |
| Laminate 2-12 | 15 | 800 | 0.6 |

Table 15 indicates that the warpage of the laminate decreases as the amount of the amorphous oxide increases. Thus, in order to suppress warpage, it is preferable that the amount of the amorphous oxide added be 0.1% by weight or more.

### Example 3-1

(Battery 3-1)

A battery 3-1 was produced in the same manner as the battery 21, except that a palladium paste was used in the production of positive electrode current collector green sheets and negative electrode current collector green sheets instead of the gold paste, that the amount of palladium was changed to 25% by weight of this paste, that the thickness of the positive electrode current collector green sheets and the negative electrode current collector green sheets was changed to 10 μm, and that the highest temperature in the sintering of the green chip was changed from 900° C. to 950° C.

The sintered body, obtained by sintering the green chip, had a width of approximately 3.2 mm, a depth of approximately 1.6 mm, and a height of approximately 0.45 mm. In the same manner as in the foregoing Example 1-2, the packing rate of the sintered body was determined on the assumption that the sintered body was composed only of Li_{1.3}Al_{0.3}Ti_{1.7}(PO₄)₃. As a result, the packing rate was approximately 85%.

A polished cross-section of the sintered body was observed with an SEM. As a result, the positive electrode active material layer and the negative electrode active material layer had a thickness of approximately 1 μm and a thickness of approximately 2 μm, respectively. The positive electrode current collector layer disposed in the positive electrode active material layer and the negative electrode current collector disposed in the negative electrode active material layer had a thickness of approximately 4 μm.

The porosity of the positive electrode current collector layer and the negative electrode current collector layer was determined, for example, as follows.

The weight of palladium per unit area of a positive electrode current collector green sheet or negative electrode current collector green sheet is obtained. When sintered, the current collector green sheet shrinks. The weight of palladium per unit area after the shrinkage is calculated from the weight of palladium per unit area of the green sheet. Subsequently, the apparent thickness of the sintered current collector layer is observed with an SEM. In this way, the volume of the current collector layer and the amount of palladium contained therein can be determined. Using these values, the porosity of the current collector layer can be determined. In the following Examples, the porosity was determined in this manner.

As a result, the porosity of each of the positive electrode current collector layer and the negative electrode current collector layer was 50%.

(Battery 3-2)

A battery 3-2 was produced in the same manner as the battery 3-1, except that the amount of palladium in the palladium paste was changed to 65% by weight. After the sintering, the positive electrode current collector layer and the negative electrode current collector layer had a porosity of 20%.

(Battery 3-3)

A battery 3-3 was produced in the same manner as the battery 3-1, except that the amount of palladium in the palladium paste was changed to 20% by weight. After the sintering, the positive electrode current collector layer and the negative electrode current collector layer had a porosity of 60%.

(Battery 3-4)

A comparative battery 3-1 was produced in the same manner as the battery 3-1, except that the amount of palladium in the palladium paste was changed to 70% by weight. After the sintering, the positive electrode current collector layer and the negative electrode current collector layer had a porosity of 15%.

(Battery 3-5)

A comparative battery 3-2 was produced in the same manner as the battery 3-1, except that the amount of palladium in the palladium paste was changed to 10% by weight. After the sintering, the positive electrode current collector layer and the negative electrode current collector layer had a porosity of 70%.

With respect to each of the batteries 3-1 to 3-5, 10 cells were charged and discharged once at a constant current of 10 μA in an atmosphere with a dew point of −50° C. and a temperature of 25%. The upper cut-off voltage was 2.2 V and the lower cut-off voltage was 1.0 V.

Table 16 shows the initial discharge capacities of cells of the respective batteries which were able to charge and discharge without becoming broken and the number of cells which had structural defect(s).

TABLE 16

| | Porosity of | Discharge | |
|---|---|---|---|
| | current collector | capacity | Number of cells with |
| | (%) | (μAh) | structural defect |
| Battery 3-1 | 50 | 5.4 | 1 |
| Battery 3-2 | 20 | 5.7 | 1 |
| Battery 3-3 | 60 | 5.1 | 0 |
| Battery 3-4 | 15 | 5.6 | 4 |
| Battery 3-5 | 70 | 3.5 | 0 |

The batteries 3-1 to 3-3 were able to charge and discharge. The batteries 3-4 and 3-5 were also able to charge and discharge. The initial discharge capacity of the battery 3-5 was less than those of other batteries. It should be noted that the battery capacity can be heightened by increasing the number of layers laminated.

In the battery 3-4, four cells exhibited cracks or delamination. These cells could not provide sufficient discharge capacities.

In the batteries 3-1 to 3-3, the current collector porosity is 20 to 60%, and such porosity is believed to have the function of absorbing the change in the volume of the active material due to charge/discharge. In contrast, in the battery 3-4 in which the current collector porosity is 15%, the number of broken batteries increased probably because the change in the volume of the active material due to absorption and release of lithium ions cannot be absorbed.

Also, in the battery 3-5 in which the current collector porosity is 70%, no battery breakage occurred, but the capacity declined to approximately 60 to 70%. Such capacity decline is probably due to the degradation in the current-collecting characteristics of the current collector. Hence, the porosity of the positive electrode current collector layer and the negative electrode current collector layer is preferably 20 to 60%.

The above results indicate that when the current collector layer porosity is set to 20 to 60%, it is possible to suppress delamination resulting from the expansion and contraction of the active material during charge/discharge and cracking of the layered-type all solid battery, and therefore to produce a layered-type all solid lithium secondary battery with high reliability.

### Example 3-2

In this example, in the case of using other active materials, the effect the current collector porosity has on discharge capacity and structural defects was examined.

(Battery 3-6)

A battery 3-6 was produced in the same manner as the battery 3-1 except for the use of LiMnPO₄ as the positive electrode active material in place of LiCoPO₄.

(Battery 3-7)

A battery 3-7 was produced in the same manner as the battery 3-1, except that LiFePO₄ was used as the positive electrode active material in place of LiCoPO₄, that the green chip was baked in an atmospheric gas containing CO₂ and H₂ and having a predetermined oxygen partial pressure, that the green chip was maintained at 600° C. for 5 hours to decompose the binder contained in the green chip, and that the mixing ratio between CO₂ and H₂ in the atmospheric gas was 10³:1.

(Battery 3-8)

A battery 3-8 was produced in the same manner as the battery 3-1, except that LiMn_{0.7}Fe_{0.3}PO₄ was used as the positive electrode active material in place of LiCoPO₄, that the green chip was baked in an atmospheric gas containing CO₂ and H₂ and having a predetermined oxygen partial pressure, that the green chip was maintained at 600° C. for 5 hours to decompose the binder contained in the green chip, and that the mixing ratio between CO₂ and H₂ in the atmospheric gas was 10³:1.

(Battery 3-9)

A battery 3-9 was produced in the same manner as the battery 3-1, except that FePO₄ was used as the negative electrode active material in place of Li₃Fe₂(PO₄)₃.

(Battery 3-10)

A battery 3-10 was produced in the same manner as the battery 3-1, except that LiFeP₂O₇ was used as the negative electrode active material in place of Li₃Fe₂(PO₄)₃.

(Battery 3-11)

A battery 3-11 was produced in the same manner as the battery 3-1, except that Li_{1.3}Al_{0.3}Ti_{1.7}(PO₄)₃ was used in place of Li₃Fe₂(PO₄)₃.

(Battery 3-12)

A battery 3-12 was produced in the same manner as the battery 3-6, except that the amount of palladium in the palladium paste was changed to 75% by weight. After the baking, the positive electrode current collector layer and the negative electrode current collector layer had a porosity of 10%.

(Battery 3-13)

A battery 3-13 was produced in the same manner as the battery 3-7, except that the amount of palladium in the palladium paste was changed to 75% by weight. After the baking, the positive electrode current collector layer and the negative electrode current collector layer had a porosity of 10%.

(Battery 3-14)

A battery 3-14 was produced in the same manner as the battery 3-8, except that the amount of palladium in the palladium paste was changed to 75% by weight. After the baking, the positive electrode current collector layer and the negative electrode current collector layer had a porosity of 10%.

(Battery 3-15)

A battery 3-15 was produced in the same manner as the battery 3-9, except that the amount of palladium in the palladium paste was changed to 75% by weight. After the baking, the positive electrode current collector layer and the negative electrode current collector layer had a porosity of 10%.

(Battery 3-16)

A battery 3-16 was produced in the same manner as the battery 3-10, except that the amount of palladium in the palladium paste was changed to 75% by weight. After the baking, the positive electrode current collector layer and the negative electrode current collector layer had a porosity of 10%.

(Battery 3-17)

A battery 3-17 was produced in the same manner as the battery 3-11, except that the amount of palladium in the palladium paste was changed to 75% by weight. After the baking, the positive electrode current collector layer and the negative electrode current collector layer had a porosity of 10%.

With respect to each of the batteries 3-6 to 3-17, cells were charged and discharged once at a constant current of 10 μA in an atmosphere with a dew point of −50° C. and a temperature of 25° C. Table 17 shows the upper cut-off voltages and lower cut-off voltages of the batteries. Table 17 also shows the initial discharge capacities of cells of the respective batteries which were able to charge and discharge without becoming broken. Also, Table 18 shows the number of cells that had structural defect(s).

TABLE 17

| | Initial | | |
|---|---|---|---|
| | discharge | Upper cut-off | Lower cut-off |
| | capacity | voltage | voltage |
| | (μAh) | (V) | (V) |
| Battery 3-6 | 6.5 | 2.0 | 0.5 |
| Battery 3-7 | 6.6 | 1.0 | 0.3 |
| Battery 3-8 | 7.1 | 2.0 | 0.3 |
| Battery 3-9 | 5.6 | 2.0 | 0.6 |
| Battery 3-10 | 5.6 | 2.1 | 0.9 |
| Battery 3-11 | 5.9 | 2.5 | 1.0 |
| Battery 3-12 | 6.5 | 2.0 | 0.5 |
| Battery 3-13 | 6.6 | 1.0 | 0.3 |
| Battery 3-14 | 7.1 | 2.0 | 0.3 |
| Battery 3-15 | 5.6 | 2.0 | 0.6 |
| Battery 3-16 | 5.6 | 2.1 | 0.9 |
| Battery 3-17 | 5.9 | 2.5 | 1.0 |

TABLE 18

| | Number of cells |
|---|---|
| | with structural |
| | defect |
| Battery 3-6 | 0 |
| Battery 3-7 | 0 |
| Battery 3-8 | 0 |
| Battery 3-9 | 0 |
| Battery 3-10 | 0 |
| Battery 3-11 | 1 |
| Battery 3-12 | 1 |
| Battery 3-13 | 3 |
| Battery 3-14 | 3 |
| Battery 3-15 | 2 |
| Battery 3-16 | 2 |
| Battery 3-17 | 3 |

The batteries 3-6 to 3-11 were able to charge and discharge. The batteries 3-12 to 3-17 were also able to charge and discharge, and their initial discharge capacities were almost the same as those of the batteries 3-6 to 3-11.

However, some cells of the batteries 3-12 to 3-17 exhibited cracks or delamination. These cells could not provide sufficient discharge capacities.

On the other hand, in the case of the batteries 3-6 to 3-11, the number of cells with structural defects was small in comparison with the batteries 3-12 to 3-17. This suggests that when the porosity of the current collector layer is set to 20 to 60%, the current collector layer serves as a buffer layer, so that the current collector layer was fully able to absorb the change in the volume of the active material due to charge/discharge.

### Example 3-3

In this example, current collectors comprising base metal materials were used.

(Battery 3-18)

LiCoPO₄ was used as the positive electrode active material, and Li_{1.3}Al_{0.3}Ti_{1.7}(PO₄)₃ was used as the solid electrolyte. This solid electrolyte layer serves as the negative electrode active material.

Copper was used as the metal material contained in the positive electrode current collector layer and the negative electrode current collector layer. The amount of copper in the current collector material paste was 30% by weight of the paste.

The green chip was sintered in an atmospheric gas containing CO₂ and H₂ and having a predetermined low oxygen partial pressure. In the atmospheric gas, the volume ratio between CO₂ and H₂ was 103:1.

Also, in sintering the green chip, the binder was decomposed at a temperature of 600° C.

Except for these, a battery 3-18 was produced in the same manner as the battery 3-1. After the baking, the positive electrode current collector layer and the negative electrode current collector layer had a porosity of 50%.

(Battery 3-19)

A battery 3-19 was produced in the same manner as the battery 3-18, except that cobalt was used as the metal material contained in the positive electrode current collector layer and the negative electrode current collector layer, that the volume ratio between CO₂ and H₂ in the atmospheric gas used to bake the green chip was changed to 10:1, and that the binder contained in the green chip was decomposed by heating at 600° C. for 72 hours. After the baking, the positive electrode current collector layer and the negative electrode current collector layer had a porosity of 50%.

(Battery 3-20)

A battery 3-20 was produced in the same manner as the battery 3-18, except that nickel was used as the metal material contained in the positive electrode current collector layer and the negative electrode current collector layer, that the volume ratio between CO₂ and H₂ in the atmospheric gas used to bake the green chip was changed to 40:1, and that the binder contained in the green chip was decomposed by heating at 600° C. for 48 hours. After the baking, the positive electrode current collector layer and the negative electrode current collector layer had a porosity of 50%.

(Battery 3-21)

A battery 3-21 was produced in the same manner as the battery 3-18, except that stainless steel was used as the metal material contained in the positive electrode current collector layer and the negative electrode current collector layer, and that the highest temperature to bake the green chip was changed to 100° C. After the baking, the positive electrode current collector layer and the negative electrode current collector layer had a porosity of 50%.

(Comparative Battery 3-1)

A comparative battery 3-1 was produced in the same manner as the battery 3-18, except that titanium was used as the metal material contained in the positive electrode current collector layer and the negative electrode current collector layer, and that the highest temperature to bake the green chip was changed to 900° C. After the baking, the positive electrode current collector layer and the negative electrode current collector layer had a porosity of 50%.

With respect to each of the batteries 3-18 to 3-21 and comparative battery 3-1, 10 cells were charged and discharged at a constant current under the same conditions as those of the batteries 3-11 (upper cut-off voltage 2.5 V, lower cut-off voltage 1.0 V). Table 19 shows the initial discharge capacities of cells of the respective batteries which were able to charge and discharge without causing a defect and the number of cells that had structural defect(s).

TABLE 19

| | Initial | |
|---|---|---|
| | discharge | Number of cells |
| | capacity | with structural |
| | (μAh) | defect |
| Battery 3-18 | 5.4 | 1 |
| Battery 3-19 | 5.5 | 0 |
| Battery 3-20 | 5.2 | 1 |
| Battery 3-21 | 4.8 | 0 |
| Comp. battery 3-1 | 0 | 0 |

The results of the batteries 3-18 to 3-21 indicate that even when base metal is used as the current collector material, the oxidation of the current collector material can be prevented by baking the green chip while controlling the oxygen partial pressure of the atmospheric gas for the baking. Thus, a solid battery using base metal as the current collector material is capable of charge/discharge.

In the comparative battery 3-1, no cell exhibited cracking and/or delamination. However, the comparative battery 3-1 was not capable of charge/discharge itself. This is probably because the titanium constituting the current collector layer itself was oxidized and thus the current collector layer could not maintain its ability to collect current. The green chip may be baked in an atmosphere in which titanium is not oxidized, but when such an atmosphere is used, the decomposition of the binder becomes impossible.

The above results show that by controlling the oxygen partial pressure of the atmospheric gas, a metal material that is resistant to oxidation to some degree can be used as the current collector material.

### Example 3-5

In this example, the porosity of the positive electrode current collector layer and the negative electrode current collector layer was set to 10%.

(Battery 3-22)

A battery 3-22 was produced in the same manner as the battery 3-18, except that the amount of copper in the copper paste for forming the positive electrode current collector layer and the negative electrode current collector layer was changed to 70% by weight of the paste. The positive electrode current collector layer and the negative electrode current collector layer had a porosity of 10%.

(Battery 3-23)

A battery 3-23 was produced in the same manner as the battery 3-19, except that the amount of cobalt in the cobalt paste for forming the positive electrode current collector layer and the negative electrode current collector layer was changed to 70% by weight of the paste. The positive electrode current collector layer and the negative electrode current collector layer had a porosity of 10%.

(Battery 3-24)

A battery 3-24 was produced in the same manner as the battery 3-20, except that the amount of nickel in the nickel paste for forming the positive electrode current collector layer and the negative electrode current collector layer was changed to 70% by weight of the paste. The positive electrode current collector layer and the negative electrode current collector layer had a porosity of 10%.

(Battery 3-25)

A battery 3-25 was produced in the same manner as the battery 3-21, except that the amount of stainless steel in the stainless steel paste for forming the positive electrode current collector layer and the negative electrode current collector layer was changed to 70% by weight of the paste. The positive electrode current collector layer and the negative electrode current collector layer had a porosity of 10%.

With respect to each of the batteries 3-22 to 3-25, 10 cells were charged and discharged at a constant current under the same conditions as those of battery 3-18 (upper cut-off voltage 2.5 V, lower cut-off voltage 1.0 V). Table 20 shows the initial discharge capacities of cells of the respective batteries which were able to charge and discharge without causing a defect and the number of cells that had structural defect(s).

TABLE 20

| | Initial | |
|---|---|---|
| | discharge | Number of cells |
| | capacity | with structural |
| | (μAh) | defect |
| Battery 3-22 | 5.4 | 3 |
| Battery 3-23 | 5.5 | 5 |
| Battery 3-24 | 5.2 | 4 |
| Battery 3-25 | 4.8 | 5 |

The initial discharge capacities of the batteries 3-22 to 2-25 were equivalent to the initial discharge capacities of the batteries 3-18 to 3-21. In the batteries 3-22 to 3-25, since the porosity of the positive electrode current collector layer and the negative electrode current collector layer is 10%, it is difficult for such current collector layers to absorb the change in volume of the active material during charge/discharge. This is probably the reason why the number of cells with structural defect(s) increased in the batteries 3-22 to 3-25.

As described above, it is possible to use a current collector layer comprising base metal that is resistant to oxidation to some extent, in addition to noble metal. Also, by adjusting the porosity to 20 to 60%, it is possible to suppress delamination and/or cracking resulting from the change in the volume of the active material during charge/discharge. It is therefore possible to provide a highly reliable all solid lithium secondary battery.

### INDUSTRIAL APPLICABILITY

The laminate of the present invention has a solid electrolyte layer and an active material layer that are densified and crystallized due to heat treatment, an electrochemically active interface between the active material and the solid electrolyte, and a low internal resistance. The use of such a laminate makes it possible to provide, for example, an all solid lithium secondary battery having high capacity and excellent high-rate characteristics.

1. A laminate for an all solid lithium secondary battery, said laminate comprising an active material layer and a solid electrolyte layer bonded to said active material layer by sintering,
wherein said active material layer comprises a crystalline first substance capable of absorbing and desorbing lithium ions,
said solid electrolyte layer comprises a crystalline second substance with lithium ion conductivity, and
an X-ray diffraction analysis of said laminate shows that there is no component other than constituent components of said active material layer and constituent components of said solid electrolyte layer.

2. The laminate for an all solid lithium secondary battery in accordance with claim 1, wherein said first substance comprises a crystalline first phosphoric acid compound capable of absorbing and desorbing lithium ions, and said second substance comprises a crystalline second phosphoric acid compound with lithium ion conductivity.

3. The laminate for an all solid lithium secondary battery in accordance with claim 1, wherein at least said solid electrolyte layer has a packing rate of more than 70%.

4. The laminate for an all solid lithium secondary battery in accordance with claim 1, wherein at least one of said active material layer and said solid electrolyte layer contains an amorphous oxide.

5. The laminate for an all solid lithium secondary battery in accordance with claim 4, wherein at least one of said active material layer and said solid electrolyte layer contains 0.1 to 10% by weight of said amorphous oxide.

6. The laminate for an all solid lithium secondary battery in accordance with claim 4, wherein said amorphous oxide has a softening point of 700° C. or more and 950° C. or less.

7. The laminate for an all solid lithium secondary battery in accordance with claim 2, wherein said first phosphoric acid compound is represented by the following general formula:
LiMPO₄
where M is at least one selected from the group consisting of Mn, Fe, Co, and Ni.

8. The laminate for an all solid lithium secondary battery in accordance with claim 2, wherein said second phosphoric acid compound is represented by the following general formula:
Li_{1+X}M^{III}_{X}Ti^{IV}_{2-X}(PO₄)₃
where M^{III} is at least one metal ion selected from the group consisting of Al, Y, Ga, In, and La and 0≦X≦0.6.

9. An all solid lithium secondary battery comprising a laminate, said laminate including at least one combination that comprises a positive electrode active material layer and a solid electrolyte layer bonded to said positive electrode active material layer by sintering,
wherein said positive electrode active material layer comprises a crystalline first substance capable of absorbing and desorbing lithium ions,
said solid electrolyte layer comprises a crystalline second substance with lithium ion conductivity, and
an X-ray diffraction analysis of said laminate shows that there is no component other than constituent components of said active material layer and constituent components of said solid electrolyte layer.

10. The all solid lithium secondary battery in accordance with claim 9, wherein said first substance is a crystalline first phosphoric acid compound capable of absorbing and desorbing lithium ions, and said second substance is a crystalline second phosphoric acid compound with lithium ion conductivity.

11. The all solid lithium secondary battery in accordance with claim 9, wherein said at least one combination has a negative electrode active material layer that faces said positive electrode active material layer with said solid electrolyte layer interposed therebetween, said solid electrolyte layer is bonded to said negative electrode active material layer, and said negative electrode active material layer comprises a crystalline third phosphoric acid compound capable of absorbing and desorbing lithium ions or a Ti-containing oxide.

12. The all solid lithium secondary battery in accordance with claim 9, wherein said solid electrolyte layer has a packing rate of more than 70%.

13. The all solid lithium secondary battery in accordance with claim 10, wherein said first phosphoric acid compound is represented by the following general formula:
LiMPO₄
where M is at least one selected from the group consisting of Mn, Fe, Co, and Ni.

14. The all solid lithium secondary battery in accordance with claim 10, wherein said second phosphoric acid compound is represented by the following general formula:
Li_{1+X}M^{III}_{X}Ti^{IV}_{2-X}(PO₄)₃
where M^{III} is at least one metal ion selected from the group consisting of Al, Y, Ga, In, and La, and 0≦X≦0.6.

15. The all solid lithium secondary battery in accordance with claim 11, wherein said third phosphoric acid compound is at least one selected from the group consisting of FePO₄, Li₃Fe₂(PO₄)₃, and LiFeP₂O₇.

16. The all solid lithium secondary battery in accordance with claim 10, wherein said second phosphoric acid compound comprises Li_{1+X}M^{III}_{X}Ti^{IV}_{2-X}(PO₄)₃ where M^{III} is at least one metal ion selected from the group consisting of Al, Y, Ga, In, and La and 0≦X≦0.6, and said solid electrolyte layer serves as a negative electrode active material layer.

17. The all solid lithium secondary battery in accordance with claim 9, wherein at least one of said positive electrode active material layer and said solid electrolyte layer contains an amorphous oxide.

18. The all solid lithium secondary battery in accordance with claim 17, wherein said amorphous oxide constitutes 0.1 to 10% by weight of the layer in which it is contained.

19. The all solid lithium secondary battery in accordance with claim 17, wherein said amorphous oxide has a softening point of 700° C. or more and 950° C. or less.

20. The all solid lithium secondary battery in accordance with claim 9, wherein at least one of said positive electrode active material layer and said solid electrolyte layer contains Li₄P₂O₇, and said solid electrolyte layer has a packing rate of more than 70%.

21. The all solid lithium secondary battery in accordance with claim 20, wherein Li₄P₂O₇ constitutes 0.1 to 10% by weight of the layer in which it is contained.

22. The all solid lithium secondary battery in accordance with claim 9, wherein the face of said solid electrolyte layer not bonded to said positive electrode active material layer is bonded to lithium metal or a current collector, with a reduction-resistant electrolyte layer interposed therebetween.

23. The all solid lithium secondary battery in accordance with claim 9, wherein said at least one combination is sandwiched between a positive electrode current collector and a negative electrode current collector.

24. The all solid lithium secondary battery in accordance with claim 11, wherein said positive electrode active material layer has a positive electrode current collector, and said negative electrode active material layer has a negative electrode current collector.

25. The all solid lithium secondary battery in accordance with claim 24, wherein a thin-film current collector is provided in at least one of the positive electrode active material layer and the negative electrode active material layer.

26. The all solid lithium secondary battery in accordance with claim 25, wherein at least one of said positive electrode current collector and said negative electrode current collector has a porosity of 20% or more and 60% or less.

27. The all solid lithium secondary battery in accordance with claim 25, wherein at least one of said thin-film positive electrode current collector and said thin-film negative electrode current collector is provided in the active material layer in a central part of the thickness direction thereof.

28. The all solid lithium secondary battery in accordance with claim 24, wherein the current collector is provided in the form of a three-dimensional network throughout at least one of said positive electrode active material layer and said negative electrode active material layer.

29. The all solid lithium secondary battery in accordance with claim 24, wherein the current collector is provided on at least one of the face of said positive electrode active material layer opposite to the face in contact with the solid electrolyte layer and the face of said negative electrode active material layer opposite to the face in contact with the solid electrolyte layer.

30. The all solid lithium secondary battery in accordance with claim 24, wherein said at least one combination comprises two or more combinations, and said positive electrode current collectors and said negative electrode current collectors are connected in parallel by a positive electrode external current collector and a negative electrode external current collector, respectively.

31. The all solid lithium secondary battery in accordance with claim 24, wherein said positive electrode current collector and said negative electrode current collector comprise a conductive material.

32. The all solid lithium secondary battery in accordance with claim 31, wherein said conductive material comprises at least one selected from the group consisting of stainless steel, silver, copper, nickel, cobalt, palladium, gold, and platinum.

33. The all solid lithium secondary battery in accordance with claim 30, wherein said positive electrode external current collector and said negative electrode external current collector comprise a mixture of metal and glass frit.

34. A method for producing a laminate comprising an active material layer and a solid electrolyte layer, said method comprising the steps of:
dispersing an active material in a solvent containing a binder and a plasticizer to form a slurry 1 for forming the active material layer;
dispersing a solid electrolyte in a solvent containing a binder and a plasticizer to form a slurry 2 for forming the solid electrolyte layer;
making an active material green sheet by using said slurry 1;
making a solid electrolyte green sheet by using said slurry 2; and
laminating said active material green sheet and said solid electrolyte green sheet and applying a heat treatment to form a laminate,
wherein said active material comprises a first phosphoric acid compound capable of absorbing and desorbing lithium ions, and said solid electrolyte comprises a second phosphoric acid compound with lithium ion conductivity.

35. The method for producing a laminate in accordance with claim 34, wherein at least one of said slurry 1 and said slurry 2 contains an amorphous oxide, and said heat treatment is performed at 700° C. or more and 1000° C. or less.

36. The method for producing a laminate in accordance with claim 35, wherein said at least one slurry is such that the ratio of said amorphous oxide to the total of said amorphous oxide and said active material or said solid electrolyte is 0.1% by weight to 10% by weight.

37. The method for producing a laminate in accordance with claim 35, wherein said amorphous oxide has a softening point of 700° C. or more and 950° C. or less.

38. A method for producing a laminate comprising an active material layer and a solid electrolyte layer, said method comprising the steps of:
depositing an active material on a substrate to form the active material layer;
depositing a solid electrolyte on said active material layer to form the solid electrolyte layer; and
applying a heat treatment to said active material layer and said solid electrolyte layer for crystallization,
wherein said active material comprises a crystalline first phosphoric acid compound capable of absorbing and desorbing lithium ions, and
said solid electrolyte comprises a crystalline second phosphoric acid compound with lithium ion conductivity.

39. The method for producing a laminate in accordance with claim 38, wherein said active material and said solid electrolyte are deposited on said substrate by sputtering.

40. A method for producing an all solid lithium secondary battery, comprising the steps of:
(a) dispersing a positive electrode active material in a solvent containing a binder and a plasticizer to form a slurry 1 for forming a positive electrode active material layer;
(b) dispersing a solid electrolyte in a solvent containing a binder and a plasticizer to form a slurry 2 for forming a solid electrolyte layer;
(c) dispersing a negative electrode active material in a solvent containing a binder and a plasticizer to form a slurry 3 for forming a negative electrode active material layer;
(d) making a positive electrode active material green sheet by using said slurry 1;
(e) making a solid electrolyte green sheet by using said slurry 2;
(f) making a negative electrode active material green sheet by using said slurry 3;
(g) forming a first green sheet group that includes at least one combination including: said solid electrolyte sheet; and said positive electrode active material green sheet and said negative electrode active material green sheet sandwiching said solid electrolyte sheet; and
(h) applying a heat treatment to said first green sheet group to form a laminate including at least one integrated combination of the positive electrode active material layer, the solid electrolyte layer, and the negative electrode active material layer,
wherein said positive electrode active material comprises a crystalline first phosphoric acid compound capable of absorbing and desorbing lithium ions,
said solid electrolyte comprises a second phosphoric acid compound with lithium ion conductivity, and
said negative electrode active material comprises a third phosphoric acid compound capable of absorbing and desorbing lithium ions or a Ti-containing oxide.

41. The method for producing an all solid lithium secondary battery in accordance with claim 40, wherein at least one selected from the group consisting of said slurry 1, said slurry 2, and said slurry 3 contains an amorphous oxide.

42. The method for producing an all solid lithium secondary battery in accordance with claim 41, wherein in said step (h), said heat treatment is performed at 700° C. or more and 1000° C. or less.

43. The method for producing an all solid lithium secondary battery in accordance with claim 40,
wherein Li₄P₂O₇ is added to at least one selected from the group consisting of said slurry 1, said slurry 2, and said slurry 3, and
in said step (h), said heat treatment is performed at 700° C. or more and 1000° C. or less.

44. The method for producing an all solid lithium secondary battery in accordance with claim 40,
wherein in said step (g), said combination comprises at least two positive electrode active material green sheets prepared in the above manner, at least two negative electrode active material green sheets prepared in the above manner, and the solid electrolyte green sheet,
a positive electrode current collector is interposed between said at least two positive electrode active material green sheets while a negative electrode current collector is interposed between said at least two negative electrode active material green sheets, and
one end of said positive electrode current collector and one end of said negative electrode current collector are exposed at different surface regions of said laminate.

45. The method for producing an all solid lithium secondary battery in accordance with claim 40,
wherein in said step (a) and said step (c), a positive electrode current collector material and a negative electrode current collector material are further mixed into said slurry 1 and said slurry 3, respectively, and
one end of said positive electrode active material layer and one end of said negative electrode active material layer are exposed at different surface regions of said laminate.

46. A method for producing an all solid lithium secondary battery, comprising the steps of:
(A) forming a first group that includes a combination comprising a positive electrode active material layer, a negative electrode active material layer, and a solid electrolyte layer interposed between said positive electrode active material layer and said negative electrode active material layer; and
(B) heat-treating said first group at a predetermined temperature to integrate and crystallize said positive electrode active material layer, said solid electrolyte layer, and said negative electrode active material layer,
said step (A) comprising the steps of:
(i) depositing a positive electrode active material or a negative electrode active material on a predetermined substrate to form a first active material layer;
(ii) depositing a solid electrolyte on said first active material layer to form a solid electrolyte layer; and
(iii) depositing a second active material layer, which is different from said first active material layer, on said solid electrolyte layer to form a laminate including a combination comprising said first active material layer, said solid electrolyte layer, and said second active material layer,
wherein said positive electrode active material comprises a crystalline first phosphoric acid compound capable of absorbing and desorbing lithium ions,
said solid electrolyte comprises a second phosphoric acid compound with lithium ion conductivity, and
said negative electrode active material comprises a third phosphoric acid compound capable of absorbing and desorbing lithium ions or a titanium-containing oxide.

47. The method for producing an all solid lithium secondary battery in accordance with claim 46, wherein said step (iii) further comprises, prior to said step (B), the step of laminating at least two combinations prepared in the above manner with a solid electrolyte layer interposed therebetween to form the first group.

48. The method for producing an all solid lithium secondary battery in accordance with claim 46, wherein said active material and said solid electrolyte are deposited on said substrate by sputtering or heat vapor deposition.

49. The method for producing an all solid lithium secondary battery in accordance with claim 44,
wherein said second phosphoric acid compound and said third phosphoric acid compound comprise
Li_{1+X}M^{III}_{X}Ti^{IV}_{2-X}(PO₄)₃ where M^{III} is at least one metal ion selected from the group consisting of Al, Y, Ga, In, and La and 0≦X≦0.6,
said heat treatment is performed in an atmospheric gas comprising steam and a gas with a low oxygen partial pressure,
said steam constitutes 5 to 90% by volume of said atmospheric gas, and
the highest temperature of said heat treatment is 700° C. or more and 1000° C. or less.

50. The method for producing an all solid lithium secondary battery in accordance with claim 40,
wherein said first phosphoric acid compound is represented by the following general formula:
LiMPO₄
where M is at least one selected from the group consisting of Mn, Fe, Co, and Ni,
said first phosphoric acid compound contains Fe,
said heat treatment is performed in an atmospheric gas comprising steam and a gas with a low oxygen partial pressure,
said steam constitutes 5 to 90% by volume of said atmospheric gas, and
the highest temperature of said heat treatment is 700° C. or more and 1000° C. or less.

51. The method for producing an all solid lithium secondary battery in accordance with claim 49, wherein when said heat treatment is maintained at a constant temperature of T° C., the equilibrium oxygen partial pressure PO₂ (atmospheres) of said atmospheric gas satisfies the following formula:
0.0310T+33.5≦−log₁₀PO₂≦−0.0300T+38.1.

52. The method for producing an all solid lithium secondary battery in accordance with claim 50, wherein when said heat treatment is maintained at a constant temperature of T° C., the equilibrium oxygen partial pressure PO₂ (atmospheres) of said atmospheric gas satisfies the following formula:
−0.0310T+33.5≦−log₁₀PO₂≦−0.0300T+38.1.

53. The method for producing a laminate in accordance with claim 34,
wherein said first phosphoric acid compound is represented by the following general formula:
LiMPO₄
where M is at least one selected from the group consisting of Mn, Fe, Co, and Ni,
said first phosphoric acid compound contains Fe,
said heat treatment is performed in an atmospheric gas comprising steam and a gas with a low oxygen partial pressure,
said steam constitutes 5 to 90% by volume of said atmospheric gas, and
the highest temperature of said heat treatment is 700° C. or more and 1000° C. or less.

54. The method for producing a laminate in accordance with claim 53, wherein when said heat treatment is maintained at a constant temperature of T° C., the equilibrium oxygen partial pressure PO₂ (atmospheres) of said atmospheric gas satisfies the following formula:
−0.0310T+33.5≦−log₁₀PO₂≦−0.0300T+38.1.

55. The method for producing a laminate in accordance with claim 53, wherein said gas with a low oxygen partial pressure comprises a mixture of a gas capable of releasing oxygen and a gas that reacts with oxygen.

56. The method for producing an all solid lithium secondary battery in accordance with claim 44,
wherein at least one of said positive electrode current collector and said negative electrode current collector comprises one selected from the group consisting of silver, copper, and nickel,
said heat treatment is performed in an atmospheric gas having a lower oxygen partial pressure than an oxidation-reduction equilibrium oxygen partial pressure of the electrode, and
the highest temperature of said heat treatment is 700° C. or more and 1000° C. or less.

57. The method for producing an all solid lithium secondary battery in accordance with claim 56,
wherein said atmospheric gas contains not more than 3 vol % of carbon dioxide gas and hydrogen gas, and the oxygen partial pressure of said atmospheric gas is adjusted by changing the mixing ratio between said carbon dioxide gas and said hydrogen gas.

58. The method for producing an all solid lithium secondary battery in accordance with claim 44,
wherein at least one of said positive electrode current collector and said negative electrode current collector comprises at least one material selected from the group consisting of silver, copper, and nickel,
said heat treatment is performed in an atmospheric gas comprising steam and a gas with a low oxygen partial pressure,
said steam constitutes 5 to 90% by volume of said atmospheric gas, and
the highest temperature of said heat treatment is 700° C. or more and 1000° C. or less.

59. The method for producing an all solid lithium secondary battery in accordance with claim 45,
wherein at least one of said positive electrode current collector and said negative electrode current collector comprises at least one material selected from the group consisting of silver, copper, and nickel,
said heat treatment is performed in an atmospheric gas comprising steam and a gas with a low oxygen partial pressure,
said steam constitutes 5 to 90% by volume of said atmospheric gas, and
the highest temperature of said heat treatment is 700° C. or more and 1000° C. or less.

60. The method for producing an all solid lithium secondary battery in accordance with claim 58, wherein when said heat treatment is maintained at a constant temperature of T° C., the equilibrium oxygen partial pressure PO₂ (atmospheres) of said atmospheric gas satisfies the following formula:
−0.0310T+33.5≦−log₁₀PO₂≦0.0300T+38.1.

61. The method for producing an all solid lithium secondary battery in accordance with claim 59, wherein when said heat treatment is maintained at a constant temperature of T° C., the equilibrium oxygen partial pressure PO₂ (atmospheres) of said atmospheric gas satisfies the following formula:
−0.0310T+33.5≦−log₁₀PO₂≦−0.0300T+38.1.

62. The method for producing an all solid lithium secondary battery in accordance with claim 49, wherein said gas with a low oxygen partial pressure comprises a mixture of a gas capable of releasing oxygen and a gas that reacts with oxygen.

63. A method for producing an all solid lithium secondary battery, comprising the steps of:
(a) dispersing a positive electrode active material in a solvent containing a binder and a plasticizer to form a slurry 1 for forming a positive electrode active material layer;
(b) dispersing a solid electrolyte in a solvent containing a binder and a plasticizer to form a slurry 2 for forming a solid electrolyte layer;
(c) making a positive electrode active material green sheet by using said slurry 1;
(d) making a solid electrolyte green sheet by using said slurry 2;
(e) forming a second green sheet group that includes at least one combination comprising said positive electrode active material green sheet and said solid electrolyte green sheet; and
(f) applying a heat treatment to said second green sheet group to form a laminate including at least one integrated combination of the positive electrode active material layer and the solid electrolyte layer,
wherein in said step (e), said combination includes at least two positive electrode active material green sheets prepared in the above manner and at least two solid electrolyte green sheets prepared in the above manner,
a positive electrode current collector is interposed between said at least two positive electrode active material green sheets while a negative electrode current collector is interposed between said at least two solid electrolyte green sheets,
said positive electrode active material comprises a first phosphoric acid compound capable of absorbing and desorbing lithium ions,
said solid electrolyte comprises a second phosphoric acid compound with lithium ion conductivity, said solid electrolyte serving as a negative electrode active material,
at least one of said positive electrode current collector and said negative electrode current collector is selected from the group consisting of silver, copper, and nickel, and
said heat treatment is performed in an atmospheric gas comprising steam and a gas with a low oxygen partial pressure.
